(19) United States
(12) Patent Application Publication
(10) Pub. No.: US 2011/0093361 A1
(43) Pub. Date: Apr. 21, 2011

(54) Method and System for Online Shopping and Searching For Groups Of Items

(76) Inventor: Lisa Morales, Wheaton, MD (US)

(21) Appl. No.: 12/907,617

(22) Filed: Oct. 19, 2010

Related U.S. Application Data
(60) Provisional application No. 61/253,506, filed on Oct. 20, 2009.
(60) Provisional application No. 61/312,836, filed on Mar. 11, 2010.

(51) Int. Cl. G06Q 30/00

(52) U.S. Cl. 705/26.62

(57) ABSTRACT

An online shopping system and system for searching groups of items is provided which allows the simultaneous purchase of multiple items from multiple shopping websites in one checkout step, allows the tagging of inventory to create searchable, dynamic and remixable, simultaneous multivariately grouped items, allows the aggregation and processing of user browsing behavior to allow the system to make targeted, user-specific recommendations, allows the interfacing of online shopping with social networking and social media. The system also allows users create online “Social Shops” delivering incentivized peer-to-peer shopping and recommendations.

### RELATED APPLICATIONS

Benefit is claimed from U.S. Provisional Patent Application Ser. No. 61/253,506 filed Oct. 20, 2009, entitled “Method and System for Online Shopping” and U.S. Provisional Patent Application Ser. No. 61/312,836 filed Mar. 11, 2010, entitled “Method and System for Online Shopping.”

### FIELD OF THE INVENTION

This generally relates to online shopping and product sales and searching for groups of items.

### BACKGROUND

Since the advent of the internet, online shopping has continually grown in popularity, and there are currently an untold number of websites providing or wholly dedicated to online shopping, including online clothes shopping, which is particularly popular. Many conventional search engines or shopping websites allow users to shop for clothes and/or accessories from multiple “retailers,” brands, designers, and other clothing sellers, on a single site, including www.amazon.com (“Amazon”), www.shopstyle.com (“ShopStyle”), and www.shopsense.com (“ShopSense”), while many other sites, including some associated with individual “brick and mortar,” or physical, clothing stores, allow users to shop only for that store's branded clothes and accessories, such as the store websites of American Eagle, J. Crew and Boden.

Traditionally, users have been forced to visit multiple shops to purchase multiple items that make up a single head-to-toe “look,” a combination of items, such as garments, shoes, and/or accessories that make up a full set of clothes or outfit. When engaged in conventional online shopping, users have been forced to endure similar tedium, visiting multiple shopping websites to choose the various items for their look and then “checking out,” or paying for the items in their online shopping cart, separately for each individual shopping website. This tedium results because conventional search and shopping websites do not allow a user to pay for multiple items for sale from multiple different shopping websites in a single transaction, rather than checking out in separate transactions for each shopping website the user wishes to purchase an item from.

For example, ShopStyle collects various clothing and accessories that are for sale on shopping websites across the internet on one website, allowing users to create looks from the various items displayed on the site. However, ShopStyle users cannot place the items they view on ShopStyle into a “universal shopping cart,” a single online shopping cart which allows selection and purchase of various items from various shopping websites, and purchase all of the items in one transaction. Instead, the user must navigate away from ShopStyle, separately to each individual retailer website that sells an item they wish to purchase, select the item, and checkout separately through each individual retailer's shopping cart.

While the non-existence of a universal shopping cart has traditionally posed a hindrance to online shoppers, the limited attempts to create online shopping carts able to facilitate purchases from multiple retailers have proven an equal hindrance to those retailers.

Amazon offers “Amazon Fulfillment,” allowing retailers to store their inventory at an Amazon fulfillment center and have orders processed via either the Amazon shopping cart on Amazon, or the retailer's own website. To participate in Amazon Fulfillment, Affiliates are forced to: 1) sell entirely via www.amazon.com, through “Amazon Fulfillment,” 2) build their own website using the “Amazon WebStore,” which also uses the embedded Amazon shopping cart, or 3) add the “Amazon Payments” button to their site, which routes orders through the Amazon shopping cart. Of these 3 options, only the first option allows a user to buy from multiple vendors using one website and one online shopping cart, but this option requires major changes in fulfillment processes and inventory management or even using the Amazon cart, by the retailer, which can prove to be costly or even prohibitive. Additionally, Amazon Fulfillment is not offered to retailers in the “Clothing/Fashion” category. On Amazon, fulfillment is performed by Amazon or potentially by a seller that does not have an ecommerce site that is linked or referenced to the Amazon site.

Another example of the limited nature of conventional multi-retailer online shopping carts is seen at www.etsy.com (“Etsy”). Etsy allows purchases from multiple retailers using the Etsy storefront and Etsy online shopping cart, but it only accommodates Etsy affiliates that set up storefronts as their primary storefront, rather than linking to inventory on an existing e-commerce site. Etsy affiliates are all small retailers because Etsy requires them to maintain available inventory manually. This model is therefore highly limiting or prohibitive for medium and large retailers.

Social media and/or networking such as that occurring on websites such as www.twitter.com (“Twitter”), www.facebook.com (“Facebook”), and www.myspace.com (“MySpace”), has evolved to develop an affiliated practice of social commerce. The current state of social commerce is a series of disconnected recommendations within individual social media or networking sites and/or shopping sites. Additionally, retailers expend a great deal of resources creating brand specific widgets or applications (“apps”) designed to embed advertising and/or other references to their products within the various social media or networking sites. Alternately, companies spend large amounts of money trying to understand the return on investment (“ROI”) of social “chatter” or “buzz,” which is difficult for the majority of retailers to quantify.

On ShopStyle, users can browse through the different retailers or, alternately, browse via filters, based on input parameters for individual items or generic, high-level look categories that may return results of only one tag based on whatever is the most popular tag of the day, and that allow for no further filtering or dynamic remix. More targeted searches of looks such as those desired by savvy online shoppers are not possible on ShopStyle.

ShopSense allows developers to build custom apps and widgets using their application programming interface (“API”) and subsequently earn affiliate dollars for products viewed and/or purchased through the apps and widgets. ShopSense also offers developers access to analytics. However, developers typically must be knowledgeable to take advantage of these provisions by ShopSense. ShopSense too does not have a shopping cart that works with multiple retailers.

In addition to ShopStyle and ShopSense, there are other look styling, browsing, and shopping websites, such as www.polyvore.com (“Polyvore”), www.wetseal.com (“Wet Seal”), www.charlotterusse.com (“Charlotte Russe”), www.ae.com (“American Eagle Outfitters”), www.lesnouvelles.com (“LesNouvelles”), and others, which allow users to select items, build looks, and then purchase these looks, but all of the methods employed by these websites involve drawbacks for the user. Shopping for looks on some of these websites, such as ShopStyle, is time intensive for the user, who must navigate to multiple websites to purchase the various items selected for their look. Navigating to multiple websites and checking out through multiple online shopping carts is time intensive and discourages the user from making the effort to buy a complete look that mixes items from various retailers, which must be purchased on various different shopping websites.

Shopping for looks on others of these websites limits users' choices, either because the shopping website only sells items made by one (or a few) retailer(s), such as the American Eagle Outfitters website, or because the shopping website only sells items over a limited range of price points, such as LesNouvelles. Users who wish to build a look that includes items from both inside and outside the choices of retailers or the price range offered on these sites must endure the aforementioned process of navigating to various shopping websites and performing multiple checkout transactions.

Additionally, shopping websites catering to limited price points do not provide an egalitarian system that allows for companies or individuals to create their own “shops,” carefully curated selections of items targeted to specific demographics, made up of a broad and eclectic mix of price points and brands allowing customers to mix and match cost effective items with higher price point pieces from a broad mix of stores. This feature is especially sought after by savvy shoppers, who in many instances, purchase relatively inexpensive staple/basic items, but are willing to spend much larger amounts on unique, special, or meaningful designer items.

Further, many conventional “personalized” shopping and/or recommendation websites allow personalization in only one dimension. For example, www.stylefeeder.com (“StyleFeeder”) allows a user to enter basic profile information, including age, sex and location, and requires a user to rate products so that the system may provide more targeted recommendations, while www.covet.com (“Covet”) allows a user to complete a basic profile and a visual question and answer session to allow the website's “personal shopper” to provide targeted recommendations. Some conventional “personalized” shopping and/or recommendation websites also have lengthy setup requirements. For example, www.myshape.com (“MyShape”) requires a user to enter their preferences in style and in the way their clothes fit, then enter 11 different body measurements before the system will create the user's “personal shop.” MyShape is a single retailer offering only their inventory/brands. It uses a customer's measurements that have been entered to set up an account, to create the customer's “personal shop” of individual items the website recommends based on the customer's measurements. Users of MyShape can manually create looks or browse other users' looks but the looks are not tagged in a way that permits filtering, searching of groups of items, or modifying returned group search results. Furthermore, MyShape's users are categorized primarily by body type and measurements, rather than allowing for more variables to map them to similar users for smarter recommendations.

Some conventional shopping websites allow a user to create looks and save them to the system for others to view, but the looks are not searchable and cannot be filtered. This makes the looks static; they cannot be dynamically rearranged by users applying filters, wishing to swap individual items or multiple items in or out of the look quickly and easily. For example, www.looklet.com (“Looklet”) or www.couturious.com (“Couturious”) allows users to create looks on realistic appearing models and manually rearrange them, select an item to replace, browse the system's limited inventory for an item they wish to substitute into the look, and drag that item into the look. This does not create useful searching or manipulation group search results.

Conventional shopping websites only allow users to perform multivariate searches that yield individual item results. For example, on www.zappos.com (“Zappos”), a user may select an item category, for example “women's shoes,” “sandals,” “size 8.5,” or any other category, and the system will return a results page listing all individual items matching the chosen item category. However, conventional shopping websites offer no option to perform multivariate simultaneous group searches that yield groups of contextually and subjectively related goods as results, such as a search where a user chooses any number of items (e.g., by way of search filters) to search for which dynamically generate new looks, or groups.

Conventional systems do not return search results as groups of items based on searching of an item tag. For example, when a user searches for a grey dress, they are not returned multiple groups of items, e.g., looks, that include a grey dress. Also, conventional systems do not permit users to search for a group tag or description in conjunction with an item tag. For example, when a user searches for a “nighttime” look with a grey dress, they are not returned multiple groups of items having these aspects.

Accordingly, there is a desire for an online shopping system which avoids these and other problems.

### SUMMARY

In accordance with the methods and systems consistent with the present invention, a method is provided in a data processing system for searching for groups of items, comprising receiving a request for a search, and searching for the groups of items representing one or more of (1) products and (2) services, based on the request. The method further comprises returning the groups of items based on group tags associated with the groups of items and item tags associated with the items.

In accordance with one implementation, a method is provided in a data processing system for searching for groups of items, comprising receiving a request for a search, and searching for the groups of items representing one or more of (1) products and (2) services, based on the request. The method further comprises returning the groups of items based on item tags associated with the items.

In accordance with another implementation, a method is provided in a data processing system for searching for groups of items comprising receiving a user profile indicating information associated with a user, and searching for the groups of items representing one or more of (1) products and (2) services. The method further comprises returning the groups of items based on the user profile.

In accordance with yet another implementation, a method is provided in a data processing system for searching for groups of items comprising receiving, from retailers, tags associated with the groups of items representing one or more of (1) products and (2) services, wherein the received tags are included in a single set of tags stored in a data source shared by the retailers, and searching for the groups of items. The method further comprises returning the groups of items based on group tags associated with groups of items and item tags associated with the items.

In accordance with methods and systems consistent with the present invention, a method is provided in a data processing system for searching for groups of items, comprising receiving a request for a search, searching for groups of items representing one or more of (1) products and (2) services, and returning the groups of items based on the request. The method further comprises receiving a change in search criteria regarding the returned group of items, changing the returned groups of items based on group tags associated with the groups of items and item tags associated with the items, and displaying the changed returned groups of items.

Furthermore, a method is provided in a data processing system for searching for groups of items based on information related to a user, comprising receiving a user profile associated with the user comprising (1) profile information regarding the user, (2) information regarding the user's previous shopping actions, and (3) information regarding one or more other users related to the user. The method further comprises searching for the groups of items representing one or more of (1) products and (2) services, and returning the groups of items based on the user profile.

In another implementation, a method is provided in a data processing system for creating a user profile of information related to a user for shopping, comprising sending questions to a user about the user, receiving user information from a user in response to questions about the user, and sending questions to the user about the user's preferences. The method further comprises receiving user preference information from the user in response to the user preference questions, displaying products to the user and sending questions to the user regarding the displayed products, and receiving responses from the user regarding the displayed products in response to the questions regarding the displayed products. The method also comprises creating a user profile associated with the user comprising the user information, the user preference information, and the responses regarding the displayed products, searching for groups of items representing one or more of (1) products and (2) services, and returning the groups of items based on the user profile.

In yet another implementation, a method is provided in a data processing system for social promotion of products for online shopping, comprising receiving indication, from a user, of a group of items representing products, wherein the user is not an owner of the represented products, and displaying the group of items to one or more other users. The method further comprises receiving actions performed by the one or more other users comprising one or more of: (1) viewing the group of items, (2) buying an item of the group of items, and (3) saving an item of the group of products, and sending points to the user based on the received actions performed by the one or more other users.

In accordance with another implementation, a method is provided in a data processing system for tagging groups of items with a standard set of tags, comprising receiving, from users, indications of groups of items representing products, and providing, to the users, a single set of tags to be associated with groups of items. The method further comprises receiving, from the users, indications of tags associated with groups of items, wherein the tags are comprised in the provided single set of tags.

A data processing system is provided comprising a memory configured to store instructions to cause a processor to perform the steps of the method above and a processor configured to execute the stored instructions.

### BRIEF DESCRIPTION OF THE DRAWINGS

FIG. 1 illustrates a computer system consistent with methods and systems in accordance with the present invention.

FIG. 2 illustrates a computer network consistent with methods and systems in accordance with the present invention.

FIG. 3 illustrates steps in a method for retailers to use the system in accordance with the present invention.

FIG. 4 illustrates steps in a method for consumers to use the system in accordance with the present invention.

FIG. 5 illustrates steps in a further method for consumers to use the system in accordance with the present invention.

FIG. 6 illustrates steps in a method for using the system in accordance with the present invention.

FIG. 7 illustrates an exemplary user account homepage view consistent with methods and systems in accordance with the present invention.

FIG. 8 illustrates a method of integration and media distribution consistent with methods and systems in accordance with the present invention.

FIG. 9 illustrates a method of order processing consistent with methods and systems consistent with the present invention.

FIG. 10 illustrates a method of categorizing system inventory consistent with methods and systems in accordance with the present invention.

FIG. 11 illustrates examples of inventory category schema consistent with methods and systems in accordance with the present invention.

FIG. 12 illustrates an exemplary page view consistent with methods and systems in accordance with the present invention.

FIG. 12(a) illustrates an exemplary diagram of shopping profile system functionality consistent with methods and systems in accordance with the present invention.

FIG. 13 illustrates steps in a further method for retailers to use the system in accordance with the present invention.

FIG. 13(a) illustrates a method of system searching consistent with methods and systems in accordance with the present invention.

FIG. 14 illustrates a further method of system searching consistent with methods and systems in accordance with the present invention.

FIG. 15 illustrates steps in a further method for consumers to use the system in accordance with the present invention.

FIGS. 16, 16(a)-(e) illustrate exemplary system website views consistent with methods and systems in accordance with the present invention.

FIG. 17, 17(a)-(h) illustrate exemplary system website views consistent with methods and systems in accordance with the present invention.

FIG. 18 represents exemplary objects in within the system and the weighted rank influencers that used when processing queries via the targeted recommendation engine

### DETAILED DESCRIPTION

Methods and systems in accordance with the present invention provide, in one implementation, a one-stop shopping system that allows the use of a universal shopping cart with one step checkout for multiple different stores or brands, avoiding the need for users to navigate to different shopping websites to purchase items. Users, or retailers, may put different items from different stores and brands together to form a group, for example, a look, and check out using a single online universal shopping cart. The universal shopping cart may provide, for example, a percentage of the purchase price to the operator of the system, and sale and fulfillment points to Social Shop Owners facilitating sales, traffic or user engagement.

Methods and systems in accordance with the present invention also provide universal “tagging,” or categorization, schemas to allow for the creation of looks. The universal tagging and categorization assists with the building, remixing, searching and filtering of looks. Remixing is the ability of the system to dynamically swap items into or out of a look based on changing of the search filters, tags applicable to the look, or options selected from the Remix pulldown (i.e., —“New looks from items”), weighted against the user's Style DNA (described below). In addition, the social media and networking capabilities of the system may provide the capability to share looks, items and purchases with friends, colleagues or fashion professionals, for example.

These systems provide, in one implementation, a one-stop, affiliate, visual-based shopping system that allows for incentivized, points-based social commerce through “Social Shops” with flexible delivery options by integrated channels including the internet, television, mobile phones and/or personal data assistants (“PDAs”), and brick and mortar stores or any other yet to be developed device or platform that may leverage the system's data. In one implementation, the system is used in an independent, direct to consumers website. In another implementation, the code may use APIs to allow for and encourage developers to create new ways to leverage the system, similar to the development of apps for the iPhone by Apple, Inc.

Groups are collections of individual items grouped together according to the user's desires, collections of items that go together based on their own subjective criteria or criteria set by the retailer/affiliate they work for. For example, in fashion, group may be synonymous with look, and may be made up of any number and combination of clothing, accessories, or other items, for example items that a user puts together to make up a complete outfit. As another example, in home décor, a group may be made up of any number or combination of furniture, lighting or other items, for example items that a user puts together to make up the decorating scheme of a room. A group may be comprised of as many or as few items as its creator believes are needed to make a relevant group, although the system may make recommendations towards the minimum or maximum specific to any type of product or service. In one implementation, a group is not required to meet any objective criteria of relatedness, but may be composed of any items chosen by the user for any reason.

By creating universal tagging and categorization schemas and a universal look (group) creation tool for uploaded inventory, the system creates a new way to shop, allowing users to pull dynamic pairings into looks and to view relevant looks developed by other system users based on the user's search or filtering selections. The user can then select individual items from any given look and use those items to automatically or manually build new looks. System items and looks can be purchased through one universal shopping cart that sends orders to Affiliate websites and, in one implementation, may process a flat fee, percentile fee, or any other suitable fee arrangement for goods sold, while fulfillment of the purchase order remains the responsibility of the affiliate. In this implementation, the party maintaining the system may promulgate rules, standards, guidelines and/or best practices to be followed by affiliates using the system.

The system removes or reduces many boundaries or constraints for users, thereby saving time and for many, money. They do not have to drive to multiple shops in order to purchase the exact items they want to comprise their look, nor do they have to navigate to multiple websites and endure multiple checkout transactions to assemble said look.

Methods and systems in accordance with the present invention permit users to shop different fashion retailers for example, and engage in disparate product pairing and universal shopping cart checkout. These systems may provide recommendations through social commerce networks across individual shopping sites and retailers and may do so in conjunction with social media and/or networking sites such as Twitter, Facebook, and MySpace. On the system, a universal commerce system provides users the ability to browse items from their favorite retailers or to perform a custom-filtered search based on input parameters, and improves the shopping experience by allowing the user to create targeted searches, which mix and match items based on universal tagging and categorization schemas, their Style DNA/profile, their Style Tribe(s), and their past actions and transactions (as described below).

In one implementation, the system keeps a user's wardrobe within “My Closet” so that the user may build looks from existing “Closet Items.” When a user is at a brick and mortar store, they may scan an item's barcode (using technology such as ScanLife, or ScanBuy) and then the user may choose to have the system “Shop my Closet” for example, which then prompts the system to create looks for the user from items in “My Closet,” predicated on the scanned item, helping the user decide if they would like to purchase the scanned item. The system does this by accessing the user's Style DNA and their existing My Closet items and looks to use as a foundation to run a weighted rank algorithm based on other looks within their Closet and Style Tribe and matching to dynamically generate the new looks. Alternately, the user can scan the item and check if there is already something similar in the user's “My Closet,” allowing the user to forego duplicative purchases and instead purchase a new item that will help her complete one of her saved looks in her “My Lookbook.”

In another implementation, an affiliate model is used in which affiliate companies may be associated with the shopping system. The affiliates may pay a fee on a monthly, quarterly, annual or other suitable payment basis, to be part of the system, which may be based on company size, annual revenue, or any other suitable measure. The affiliates may pay an additional fee for a branded, custom system storefront and may create sub-shops for promotional events such as guest celebrities, stylists, fashion editors, or other promotional events to drive traffic. The affiliates may pay a fee to “sponsor” a custom search profile whereas the affiliate and system owner generate a specific algorithm based on a devised persona, which may be available for a limited period of time. In one instance, this sponsored search profile could be purchased by an affiliate who is part of a movie marketing campaign whereas the persona featured could represent a featured actor within the movie being promoted. The system users could then access the site, select to shop using the sponsored search profile and be delivered results that simulate shopping like the celebrity/actor. The system may create data and reports that show or predict trends and chart out specific demographics' shopping patterns and/or needs. Other models may also be used.

The system also provides a relevance-based, or ranked system that allows for companies, or retailers, to create “Affiliate Shops” that are targeted to specific demographics with any variance of price points and/or retailers; allowing users to shop from a broad range of price points and retailers with high relevance and self-filtering of products, favorite personalities or shops in one convenient place. This may be accomplished through use of a universal shopping cart.

The system allows a user to have a graphic representation of their entire wardrobe on hand and easily accessible. This allows the user to pair items at the point of purchase in brick and mortar stores and interact with social media and/or networking websites to get instant feedback and/or advice from friends on which items to buy. The system provides users a way to avoid shopping “alone,” and may even provide access to recommendations from a personal stylist who may present options based on the user's taste and/or style, while also presenting the user the option of pairing potential purchases with items in their existing “My Closet.”

In another implementation, individuals can open their own “Social Shops” that can be accessed by the user's network, shared with the user's Style Tribe, the user's network and their networks, the user's friends, the user's friends of friends, shared with the entire system, or the user's social networks. In one implementation, the system may “pay” the Shop Owner in System Points when a purchase is made via one of their Social Shops, which could in turn be used to purchase items from the system. The system creates incentivized social commerce, a relevance-based affiliate network, and an open environment that can be leveraged from the internet to mobile phones and/or PDAs, television, retail, tablet, or any other suitable system. The system also gives social influence to a direct shopping context that provides granular specificity and data on ROI and social influence. The retailers may be provided a dashboard reporting analytical details of shopping habits of the users, e.g., if the retailer's looks are being saved, purchased or shared with minimal changes.

For example, if a user expresses interest in another user's shoes during a face-to-face meeting, the second user may access “My Closet” using any suitable mobile communication device and use that device's “bump” application (e.g., Bump Technologies, Inc) or any other suitable sync or transmission application to send the information to the inquiring first user's suitable mobile communication device. By this process, the first user may add the same shoe, for example, in their size to their universal shopping cart and/or browse similar or otherwise related shoes using the system. In one implementation, the second user gets system points just for sharing an item and if the first user ultimately buys the shoes, or item, using the system, the second user gets credit for the sale in the form of additional System Points, points which a user may accumulate by performing various system uses and redeem for items from the system or affiliates. In conventional systems, the first user is instead forced to perform an online search for the designer by name, navigate to the designer's website and search for the specific retailers who carry the designer's items, and either search for which of those retailers sell the desired shoe in their online stores, or travel to the retailer's brick and mortar store to buy the shoe.

As an additional example, the user can take a photograph of any person with their mobile device, PDA, tablet or any such device with a built in camera and submit the image to the system to find and build the photograph subject's look using visual recognition technology, such as Google Goggles, or SnapTell, which can then be saved to the user's “My Lookbook” and may be remixed later, or it can be remixed in real time based on the user's Style DNA and looks previously purchased via the system.

As the system becomes more widely-used by affiliates and individual users in generating looks, and by users in filtering and remixing these looks, the system may incrementally “learn” the relationships between the various items within a look as well as which tags are most commonly associated with one another. Then, the system may dynamically generate looks on its own, for example by drawing on the various Style Profiles within a specific Style Tribe. Additionally, different product categories, for example “Fashion,” or “Home” may be tagged as related to other product categories, for example “Beauty and Cosmetics” groups may be matched to “Fashion” groups, thereby allowing users to more easily find solutions that save them time and money while simultaneously adding value. For example, a new mom can browse her Style Tribe or shop her friends that are also new moms to buy the related new baby goods she might need. She can browse, search, filter, and remix groups of feeding items, bathing items, baby clothing, diapering items, etc. within minutes and be confident in her purchases because they come with the social influence and recommendations of her peers without having to email, call, or request recommendations via a variety of social media, networking sites or blogs.

As used herein, with reference to interaction with the system, the term “click” refers generally to the process of selection. So, those skilled in the art will understand that, for example, when the description states that a user “clicks on” an item on the system, this generally means that the user selects the item.

Although discussed with respect to clothing, methods and systems in accordance with the present invention may apply to any other item, consumer goods or services. Various embodiments consistent with the present invention are described below. Other systems, methods, features, and advantages consistent with the present invention will become apparent to one with skill in the art upon examination of the following figures and detailed description. It is intended that such additional systems, methods, features, and advantages be included within this description.

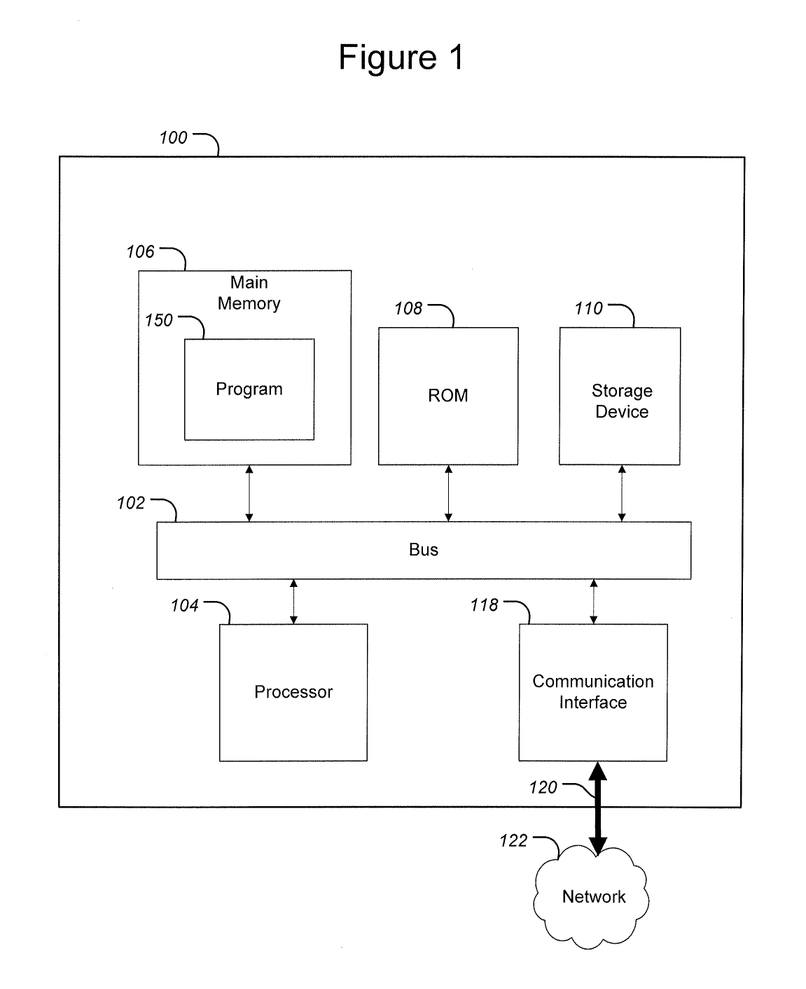

FIG. 1 illustrates an exemplary computer system 100 consistent with methods and systems in accordance with the present invention. Computer system 100 includes a bus 102 or other communication mechanism for communicating information, and a processor 104 coupled with bus 102 for processing the information. Computer 100 also includes a main memory 106, such as a random access memory (RAM) or other dynamic storage device, coupled to bus 102 for storing information and instructions to be executed by processor 104. In addition, main memory 106 may be used for storing temporary variables or other intermediate information during execution of instructions to be executed by processor 104. Main memory 106 includes a program 150 for implementing the shopping system in accordance with methods and systems consistent with the present invention. Computer 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions. The storage device and/or the main memory may store information to be uploaded and downloaded from the system such as looks, categories, schemes, tags, inventory, billing information, user information, shop information, and/or any other information.

According to one embodiment, processor 104 executes one or more sequences of one or more instructions contained in main memory 106. Such instructions may be read into main memory 106 from another computer-readable medium, such as storage device 110. Execution of the sequences of instructions in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions. Thus, embodiments are not limited to any specific combination of hardware circuitry and software.

Although described relative to main memory 106 and storage device 110, instructions and other aspects of methods and systems consistent with the present invention may reside on another computer-readable medium, such as a floppy disk, flexible disk, hard disk, magnetic tape, CD-ROM, magnetic, optical or physical medium, RAM, PROM, EPROM, FLASH-EPROM, any other memory chip or cartridge, or any other medium from which a computer can read, either now known or later discovered.

Computer 100 also includes a communication interface 118 coupled to bus 102. Communication interface 118 provides a two-way data communication coupling to a network link 120 that is connected to a network 122, such as the Internet or other computer network. Wireless links may also be implemented. Communication interface 118 may send and receive signals that carry digital data streams representing various types of information.

In one implementation, computer 100 may operate as a web server on a computer network 122 such as the Internet. Computer 100 may also represent other computers on the Internet, such as users' computers having web browsers, and the user's computers may have similar components as computer 100.

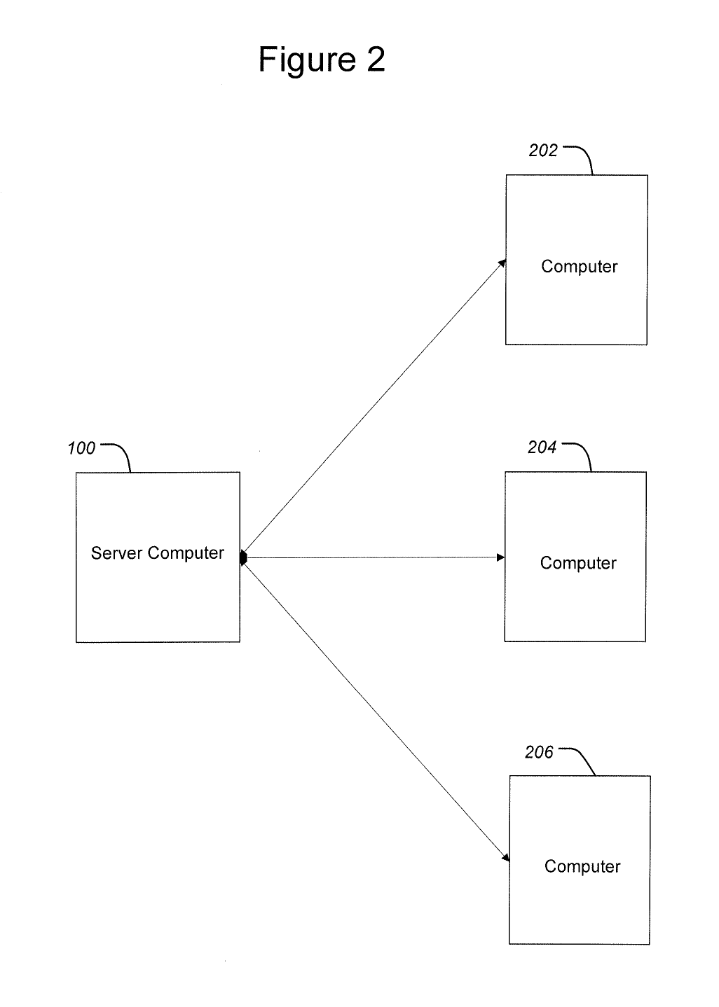

FIG. 2 shows an exemplary computer network such as the Internet having a web server for a website and computers used by various potential users. As described above, computer 100 may be a server having the components described above and may implement methods and systems consistent with the present invention. Computers 202-206 may include web browsers and may be used by users to access the Internet or other network and access server computer 100. There may be any number of user computers and any number of server computers. Users of computers 202-206, for example, may be customers of the system by accessing the website server computer 100.

Below is an example of one implementation consistent with methods and systems in accordance with the present invention. Other implementations are possible, and variations on the implementations below are possible. First, an affiliate company (e.g., an approved system retailer), website or user may subscribe to the shopping system website operated, for example, on the website server 100.

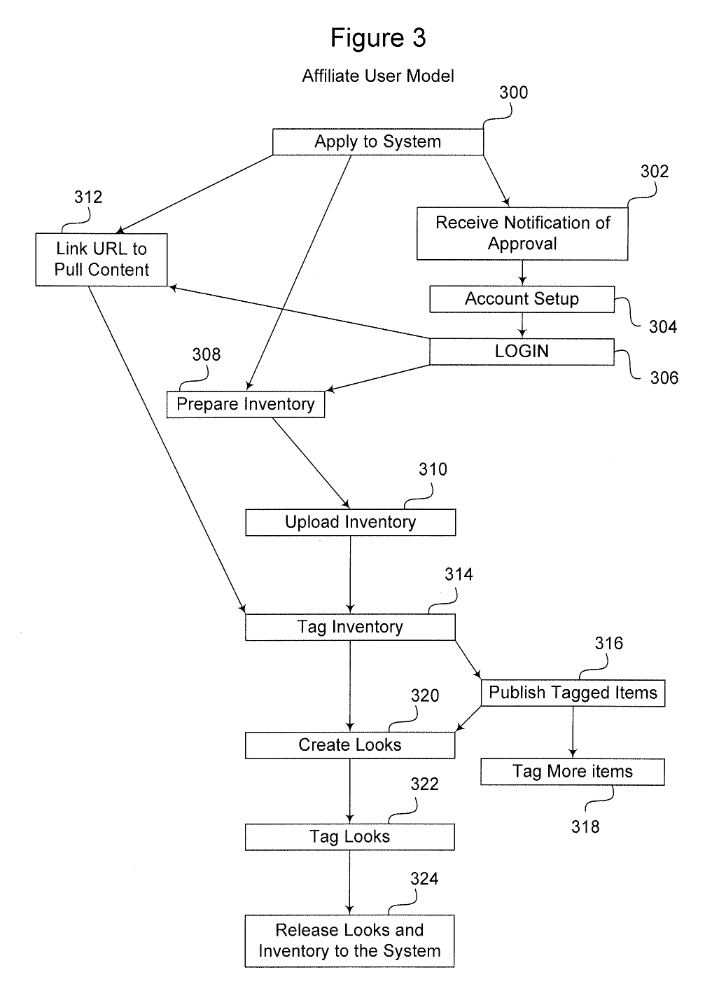

FIG. 3 shows a flow chart outlining the steps of one implementation of the present invention, the Affiliate User Model, a process which outlines various steps but allows for multiple potential workflows. An affiliate applies to become a merchant on the system (step 300), signs the contract agreeing to terms and conditions, including for example an annual or monthly subscription fee based on the size of the affiliate company, its annual revenue, or any other criteria, allowing equal access to the network for both large and small retailers. The Affiliate also agrees to whatever standards and/or use guidelines the system owner wishes to set, and in one implementation, makes the initial payment. In one implementation, a fee is not required. After the Affiliate has applied to become a merchant, the system owner reviews their application to determine whether they are a good fit and that they meet the expected criteria. After review, the system sends out either an acceptance or rejection email, or other type of notification (step 302). If the system rejects it, the process ends. Once the Affiliate has been accepted, they can proceed to Account Setup where they confirm their company's information, upload their logo, establish the primary/Super-user and invite company staff to set up their general use accounts (step 304). An Affiliate can choose to participate in the system for free or to pay a fee in exchange for a premium membership which affords them special use privileges, for example the ability to create, maintain, and operate a “branded shop” bearing the Affiliate's own logo or other brand indicia on the system. Such branded shops could contain looks made up only of the Affiliate's products rather than items drawn from a combination of the brands contained in the system. Within these branded shops, looks can be modified, allowing the user to choose some items from within the branded shop and combine them with items from within the system but outside the branded shop, creating new looks. The user is able to select what they want to buy, which retailer they want to buy it from, the price point they want to correspond to each item within a look and/or the price point they want to correspond to the overall look or any other filters provided by the system, and then go through the checkout process once using the universal shopping cart. Alternately, an Affiliate can also choose to pay a premium for a Licensed Brand Shop to have the system functionality work within the Affiliate's existing e-commerce site, such as group searching, remixing, tagging tools, etc.

Once the Affiliate has received notification of approval, the Affiliate may login to the system (step 306). In one implementation, the Affiliate photographs its items or prepares existing photographs so they correspond with the image preparation recommendations for the system (step 308). The recommendations may include, for example, a request to have the Item Main Image views shot on a white background, to have the images be silhouetted, file sizes not to exceed 700 k, and to save the files as .jpg or .png files no larger than 800×800 pixels and no smaller than 400×400 pixels. In one implementation, primary view images are put on a white background with no harsh shadows and are saved in the recommended sizes and formats for uploading onto the system. The Affiliate submits its images to the system through an Affiliate interface, ensuring the items will be appropriately tracked for sales and that the system operator and Affiliate each receive the appropriate percentage of each sale (step 310).

In lieu of creating and uploading inventory images to the system, an Affiliate may alternately link their system account to the uniform resource locator (“URL”) of another internet website, for example the Affiliate's online shopping website, in order to allow the system to pull content, including inventory images, from that website (step 312). Employing this alternative allows the affiliate to bypass some or all of the inventory image preparation and uploading processes associated with the system.

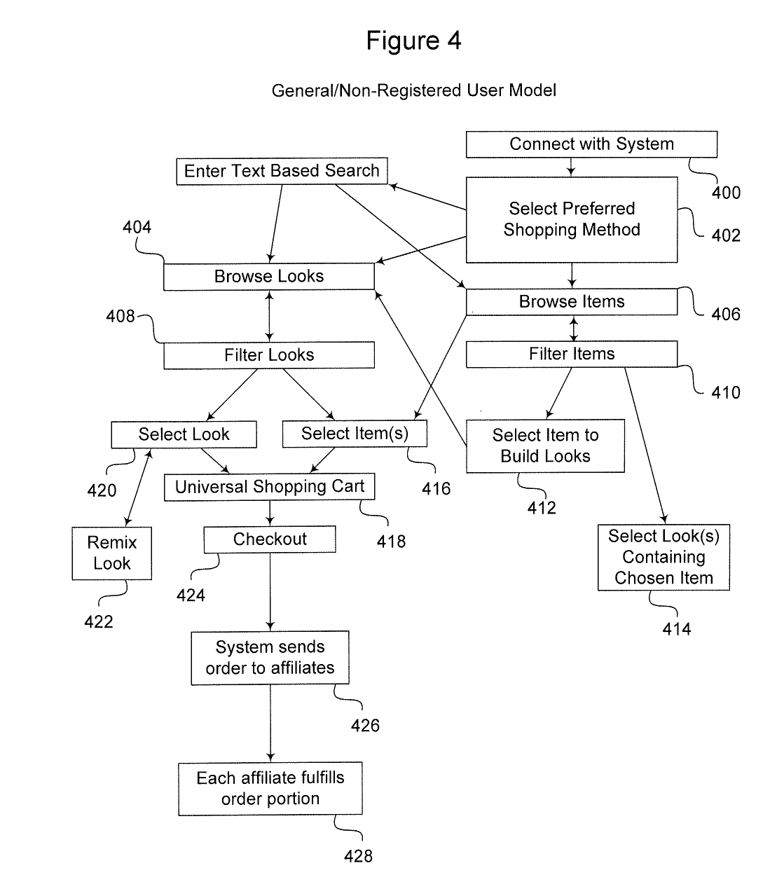

After the Affiliate uploads its inventory images to the system, or pulls such images from another linked URL, it may apply various descriptors relevant and contextual to each item, enabling dynamic look creation and filtering by users, wherein users search items using the various universal shopping filters shown and described in further detail in connection with FIG. 4 below (step 314) or apply remixing to dynamically generate new looks, or groups. Different items, for example shirts, dresses, shoes, handbags, jewelry, or any other type of item, may have a standard set of tags, seasonal tags, trend specific tags, or any other tags as described further below. After tagging its uploaded inventory, an Affiliate may publish tagged items to the system, allowing users to perform system tasks; for example browsing, purchasing, or look creation; using those items (step 316). It may not be required that an Affiliate tag all uploaded items before publishing tagged items to the system. An Affiliate may publish some tagged items, then go back to tag and publish other uploaded items later (step 318).

Once its inventory is uploaded and tagged within the system, the Affiliate can use its own inventory in combination with inventory uploaded by any other Affiliate on the system to create looks (step 320). The retailers may create looks by choosing items for a look, forming a look of the chosen items and entering group tags to be associated with the look, and possibly uploading photos associated with the items or the overall look. This allows affiliates to broaden their potential customer base within the system by creating looks that include items from a number of other brands and/or price points not found within their affiliate shop. In this way, affiliate stores are incentivized to create looks from many brands and price points outside their own inventory, addressing one of the flaws of conventional online shopping systems which use visual pairing technology—conventional systems do not allow for a broad range of brands and/or price points within one look because either the user is limited to the brands and/or price points carried by the particular shopping website, or the user must shop for the desired range of brands and/or price points using multiple shopping websites with no ability to perform a universal checkout. Once a look is created, the Affiliate or user who created the look may add images of models or users wearing the look. In one implementation, the owner of the system may limit the number of such images that may be uploaded, so as to limit image hosting costs by saving bandwidth. Once a look is created, the Affiliate or user who created the look may tag the looks (step 322), specifying which categories the looks fall under, allowing the system to streamline searches and provide more relevant results while capturing another layer of subjective relationships for the items within the group. In one implementation, types of looks have a standard set of tags, seasonal tags, trend specific tags, or any other tags. Additionally, one implementation of the system allows user feedback recommending new categories or tags. Finally, the Affiliate may publish looks and inventory to the system for browsing, use, and/or purchase by users (step 324). Publishing to the system allows users to modify these looks by applying filters, searches, or remixing the Affiliate's published inventory, use the items and/or looks within their own Social Shop, and promote the items and/or looks to their system and social network(s).

The interface for the Affiliate system tool may be a visual interface allowing the Affiliate users to have little to no familiarity with programming while still being able to drag and drop items into the appropriate categories and click to apply the appropriate tags so the application builds their schemas. One implementation includes a drag and drop interface where the user drags the item into the right category and then selects the related tags from visual lists, all while seeing the item's tagging schema building to indicate the final tag set. This same visual process may apply to the tagging of looks. The Affiliate item tagging process may be automated more using visual search image recognition technology, or barcode scanning technology. In one implementation, the system partners with the global barcode standards organizations and governing bodies to have the system's schemas become a new universal standard for inventory as embedded within any items' barcode. For example, item tags may be embedded in a bar code. The Affiliates may then scan an item's barcode with a device that translates its data into the system, thus automating the Affiliate's item descriptive tagging. The image recognition technology may identify key descriptive elements of an item and map those elements to the available descriptive tags within the system. This could save Affiliates time on the descriptive tagging of individual items. Also, once the system has learned enough about which item tagging schemas normally correspond to each other in look creation, the item tagging and look creation process can be fully automated, with the Affiliates modifying system generated and recommended looks to publish rather than creating them from scratch.

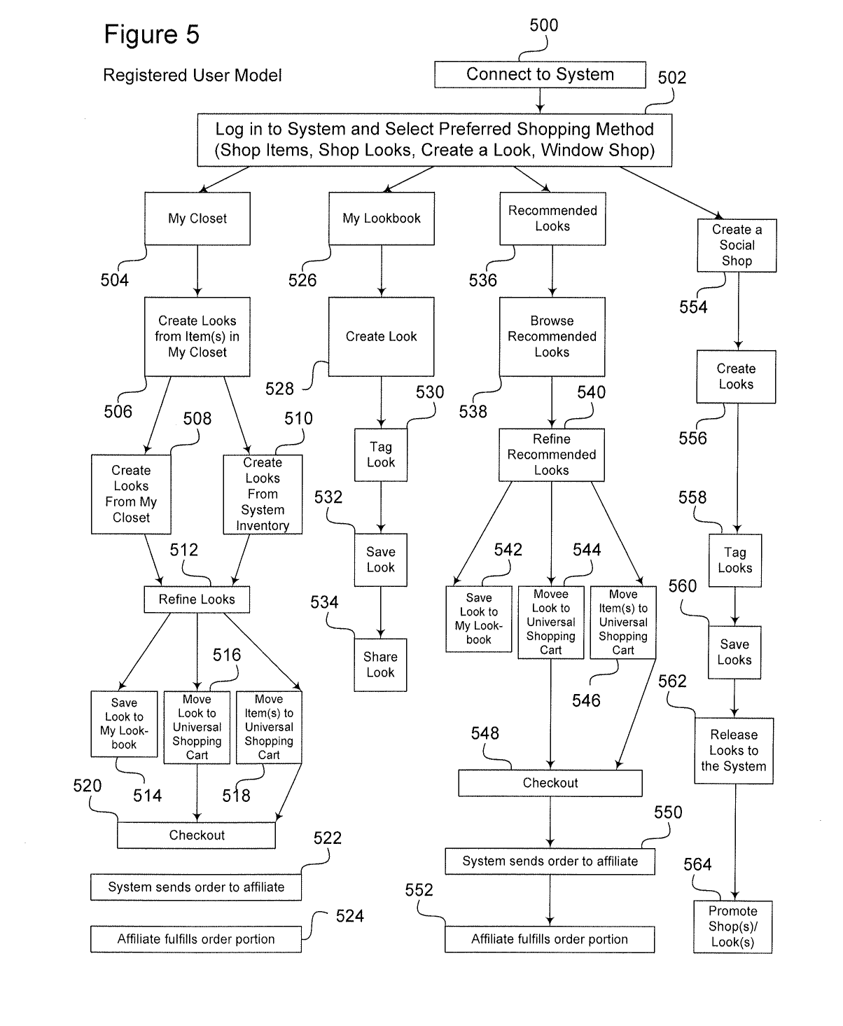

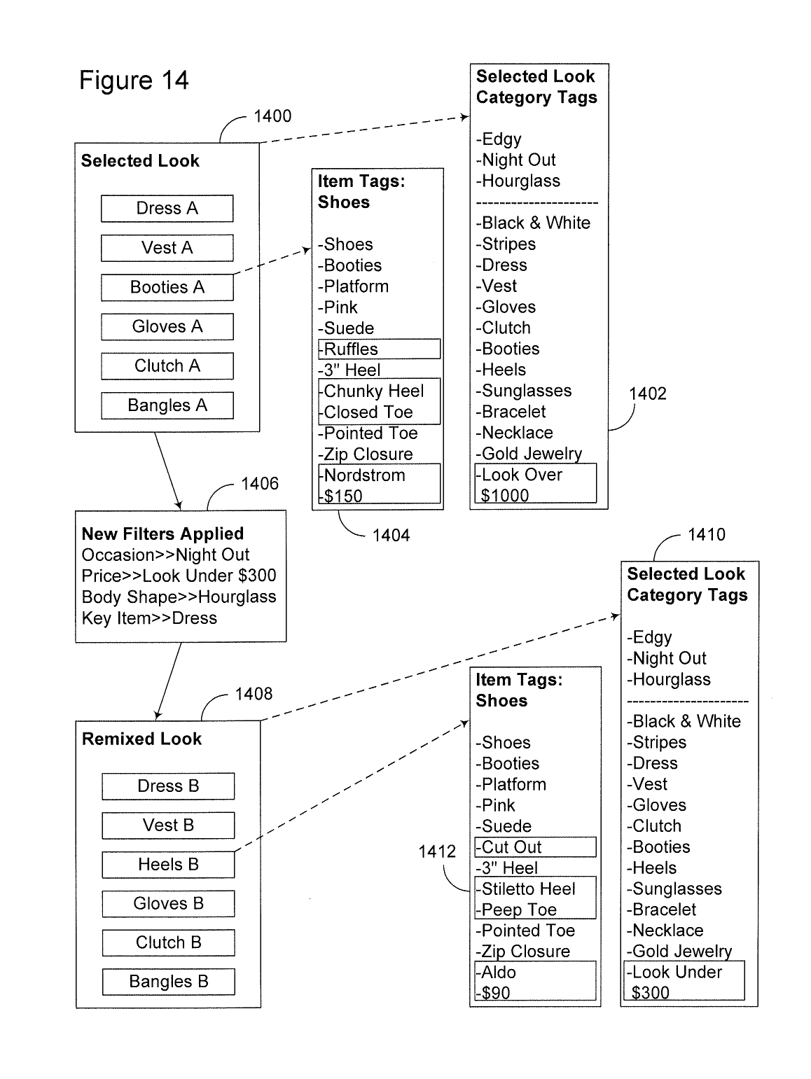

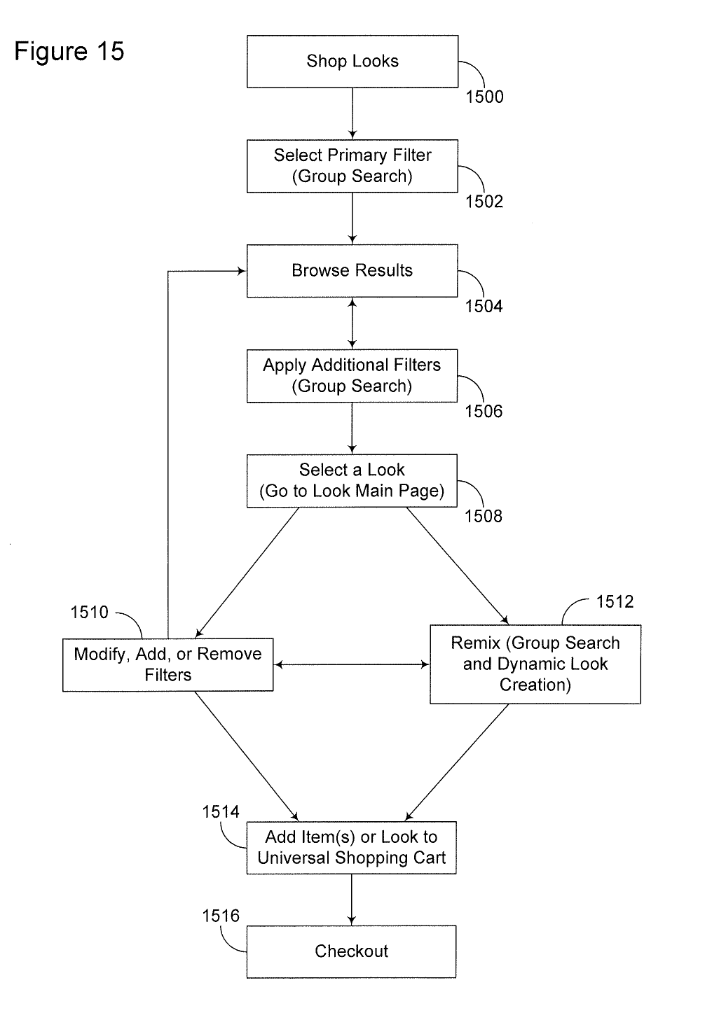

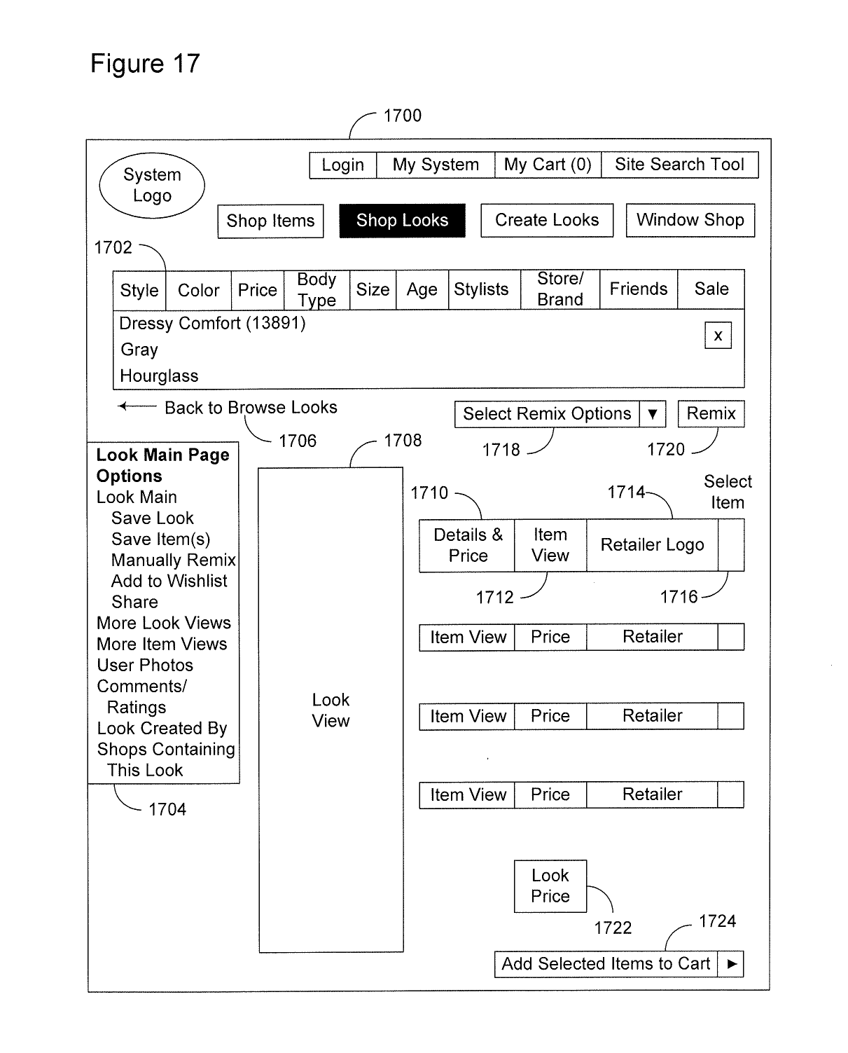

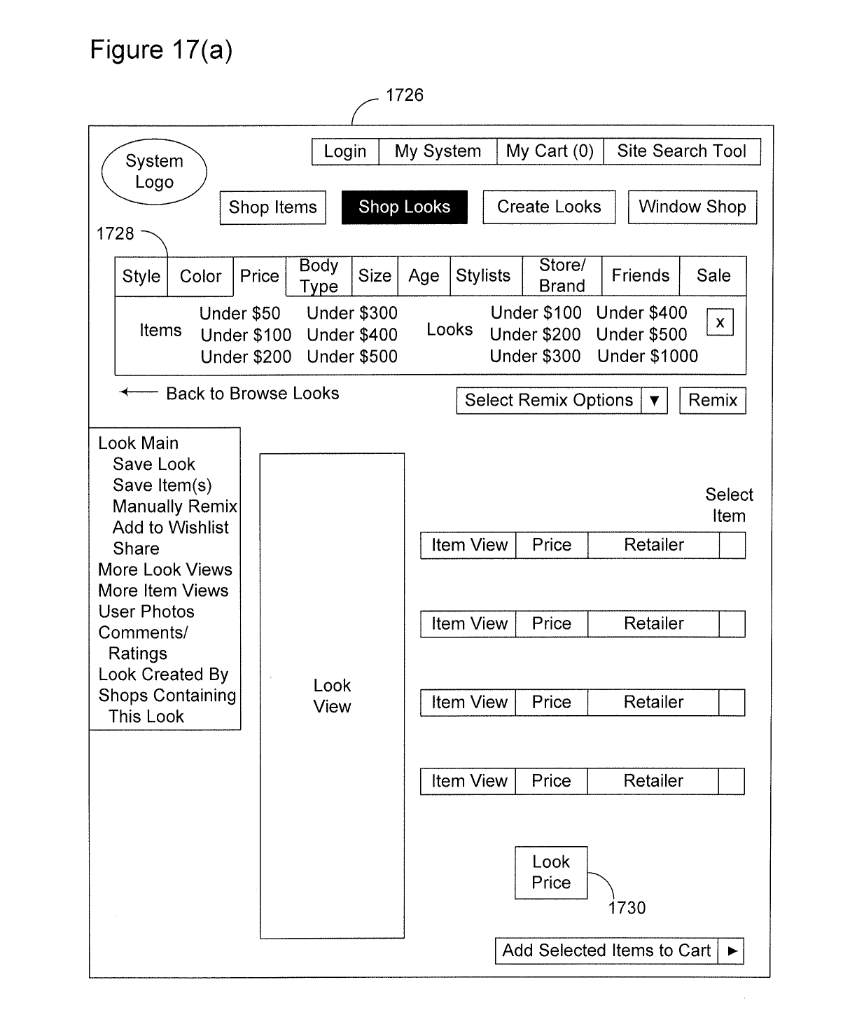

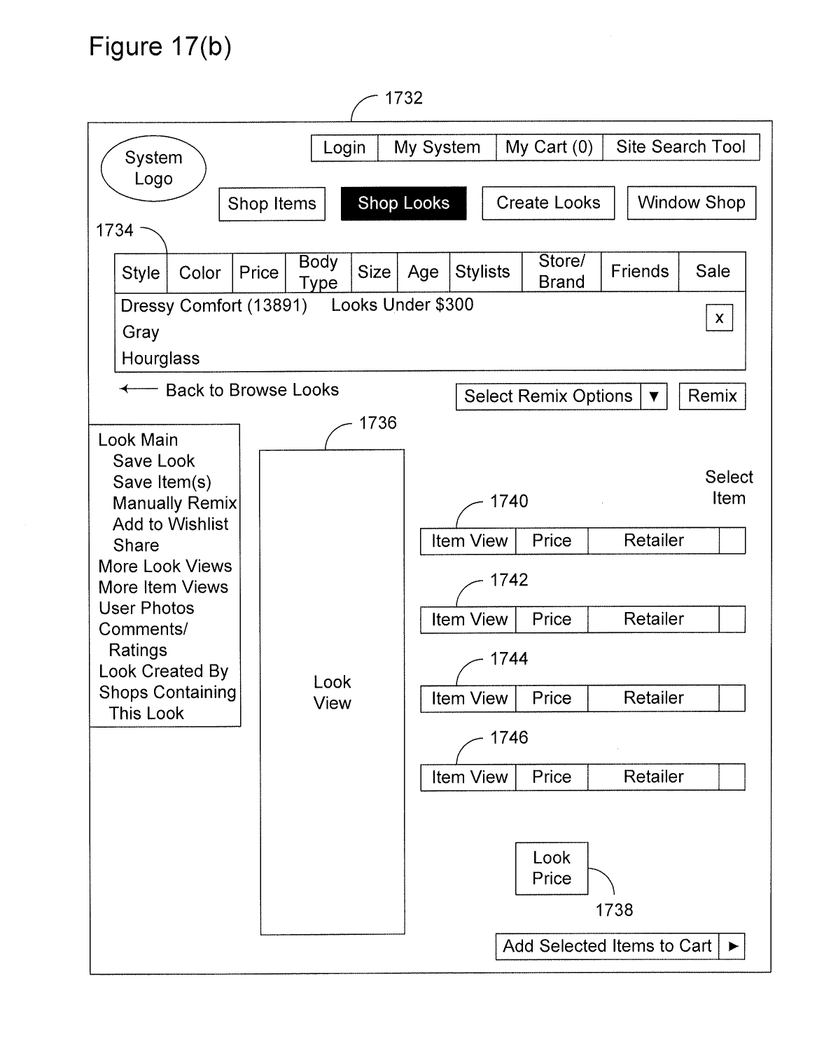

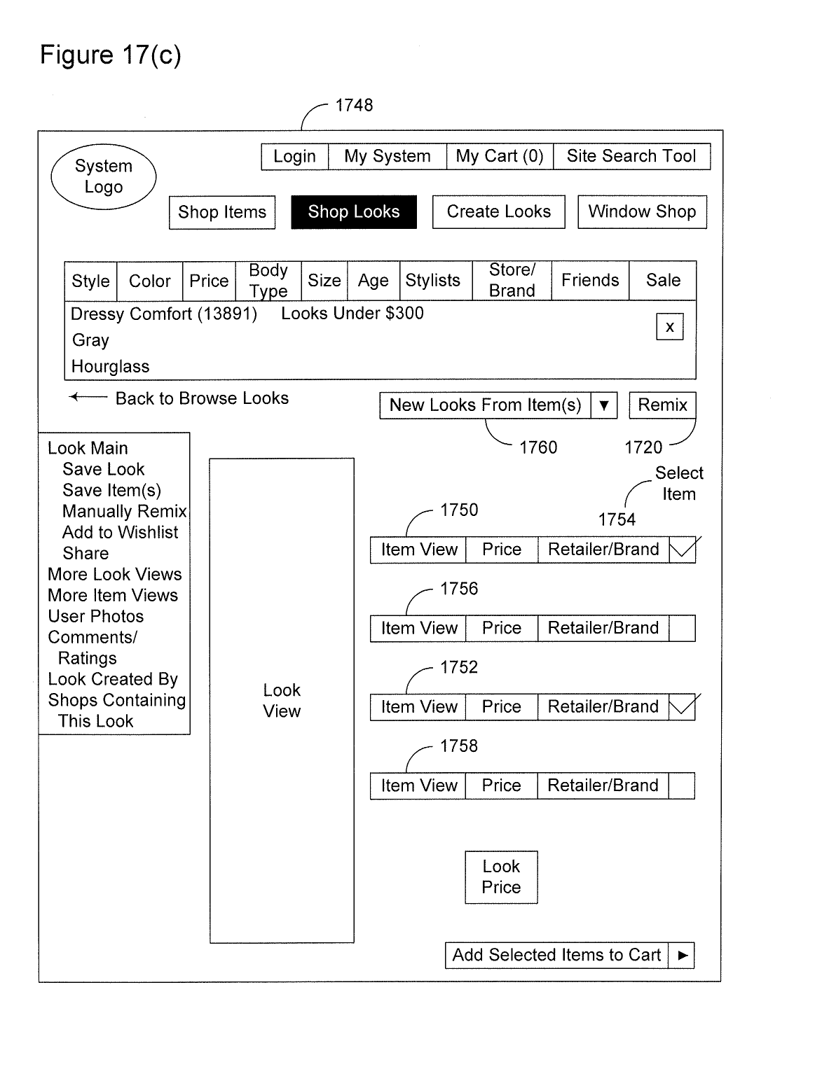

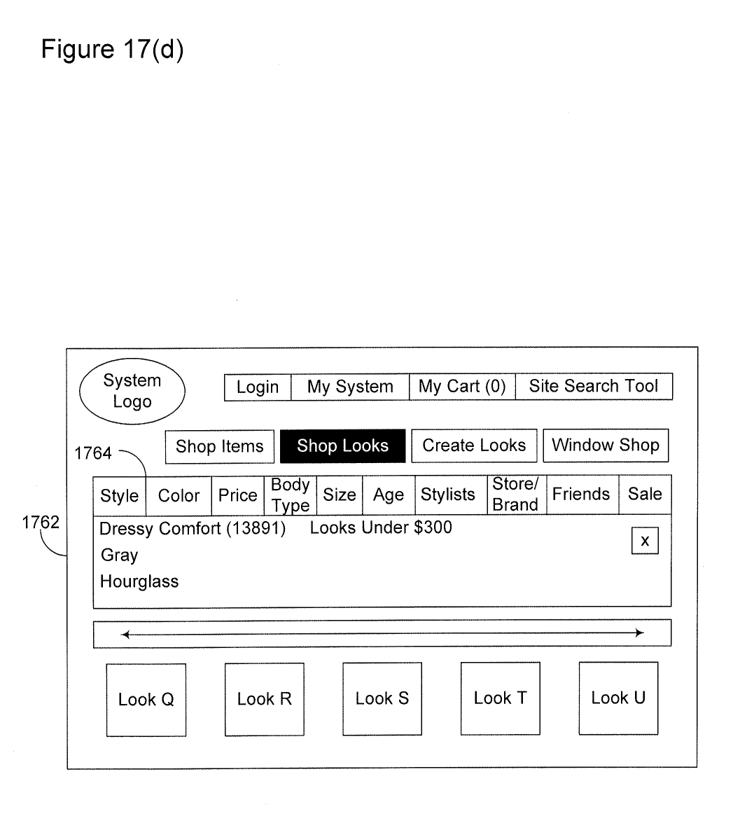

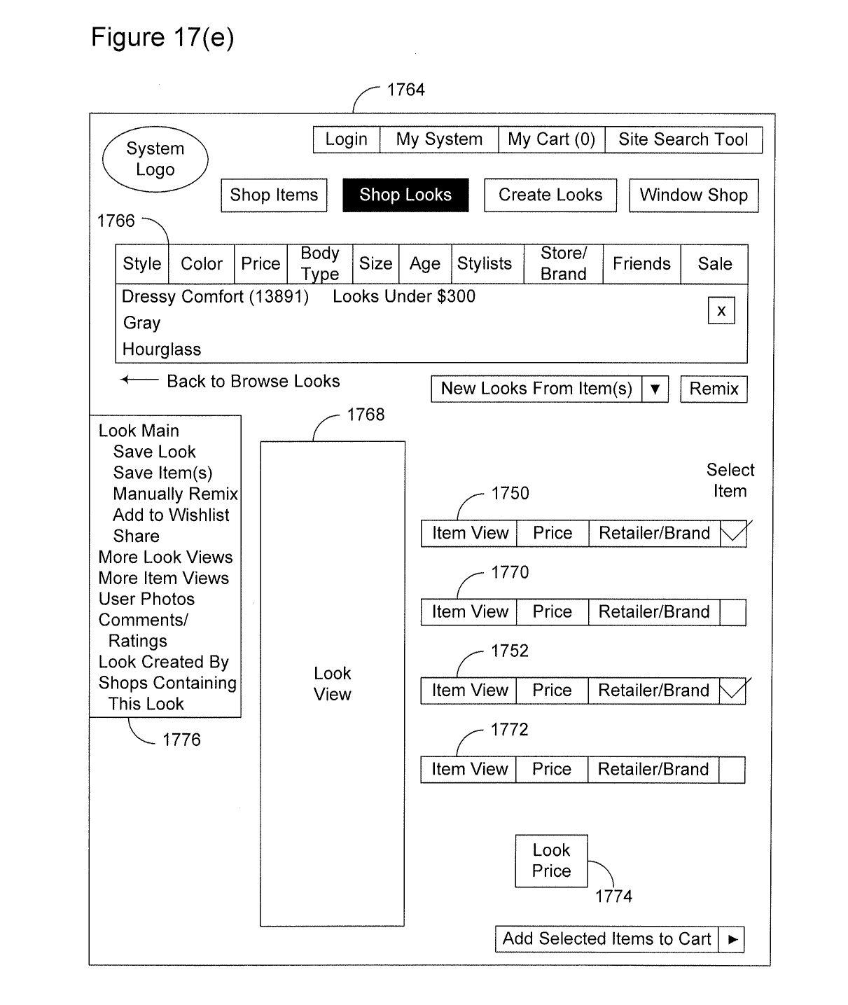

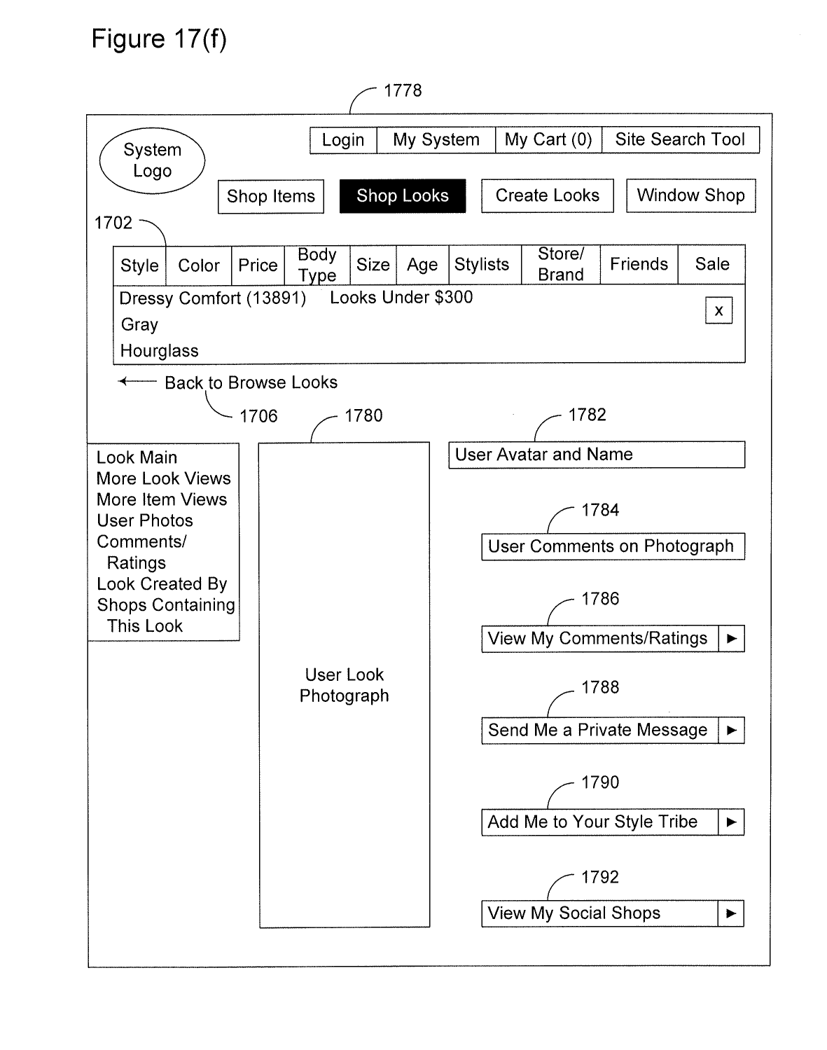

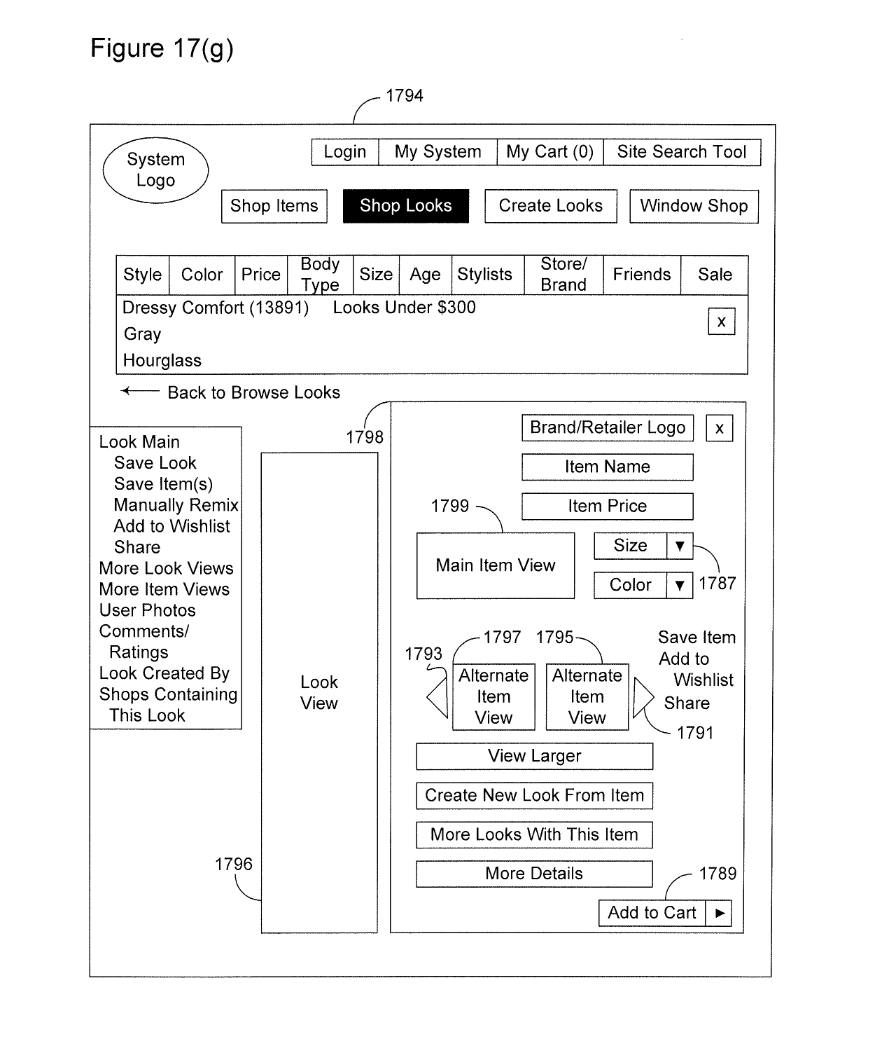

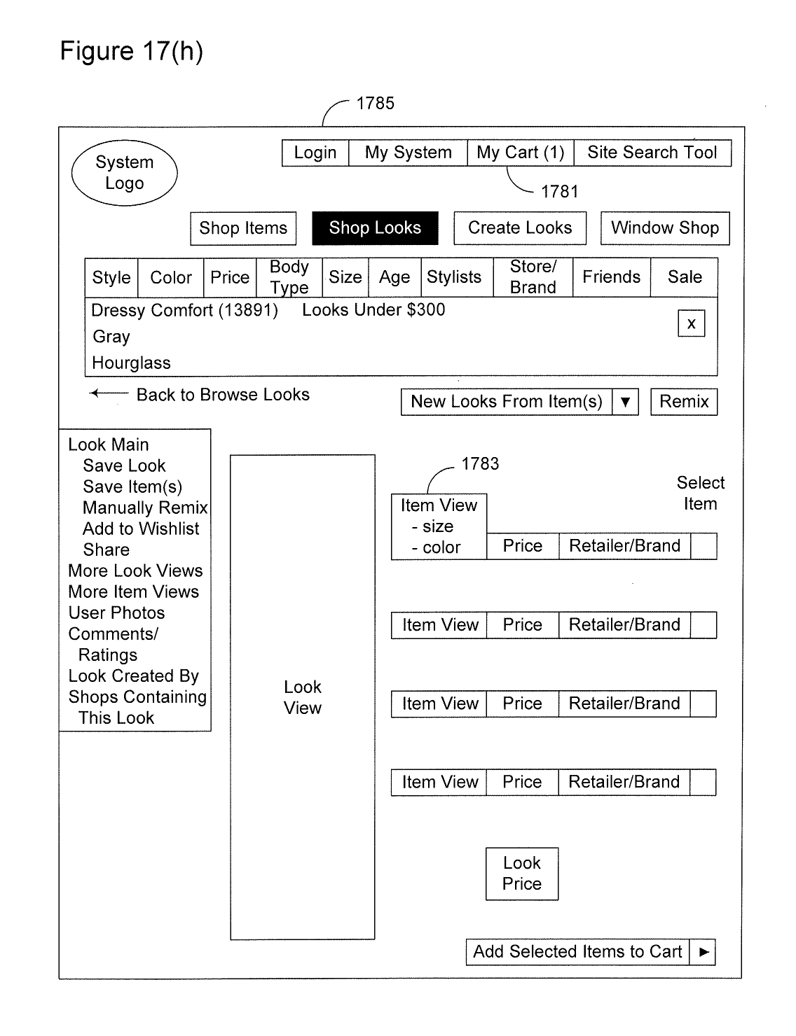

FIG. 4 shows a flow chart outlining the steps of another implementation, the General or Non-Registered User Model, which allows users to browse, build, and/or purchase items or entire looks without registering for the system. First, the user connects with the system via their selected point of entry, be it website, social media, tablet application, widget, or any other applicable point of entry (step 400). The user may then select the preferred shopping method (step 402) from one of the four methods, for example, listed on the system homepage and discussed in further detail in relation to FIGS. 5 and 15 below—“Shop Items,” “Shop Looks,” “Create a Look,” or “Window Shop.” Other pertinent methods of shopping may also be created and allowed by the system owner and/or administrator. Once the user has selected the preferred shopping method, the user may continue to either enter a text based search (step 404), browse looks (step 406) or browse items (step 408). If the user chooses to enter a text based search and then selects a choice from the search results, they may then be directed to browse looks or browse items depending on their selection. In either browse looks or browse items, the user may narrow results via the system's universal shopping filters, either through filtering looks (step 410) or filtering items (step 412). Such possible universal shopping filters include, but are not limited to, color, event, key item, body type, age bracket, trend, store/brand, size, price point per item or per look, guest personalities such as stylists, fashion editors, celebrities, or other guest look curators as discussed above, sale, friends, looks featured in a certain magazine, or any other relevant filter. The universal shopping filters represent exemplary options for regular and group search and/or refinement of search results, but the list outlined here should be understood to be non-exhaustive. Furthermore, filters, tags, and categories can be modified and/or influenced by the system users and Affiliates via an Other field in tagging processes, allowing for the system to learn the newest, most requested modifications made by the crowd. After each successive filter is applied by the user to refine looks or refine items, the system displays the browsing page, either the browse looks page or the browse items page, displaying the results of the newly compiled filtering scheme. The items, looks and shop information may be located on the website server 100. After completing their desired filtering, the user may either select items to build or view looks (step 412), select look(s) containing a chosen item (step 414), select an item (step 416) and move that item into their universal shopping cart (step 418) where it may subsequently be purchased, or select a look (step 420) if the user was previously browsing looks. The user may then remix that look (step 422) either via filters or by applying remix pull-down options, or by choosing one or multiple of the items within a look to keep as the foundation which the user may then automatically or manually build a new look around, as described below in relation to FIGS. 14 and 17. Once a look is finalized, the user may put the entire look into their universal shopping cart, choose to put only certain item(s) within the look into their universal shopping cart, choose not to buy anything or save the look or items to My Lookbook. Then, the user may checkout (step 424), purchasing one, some, or all of the items in the universal shopping cart. The system's website server 100 sends the orders to each Affiliate listing an item purchased (step 426), and each Affiliate is then responsible for fulfillment of their portion of the order (step 428). In one implementation, the system operator gets a percentage of the revenue from merchandise.

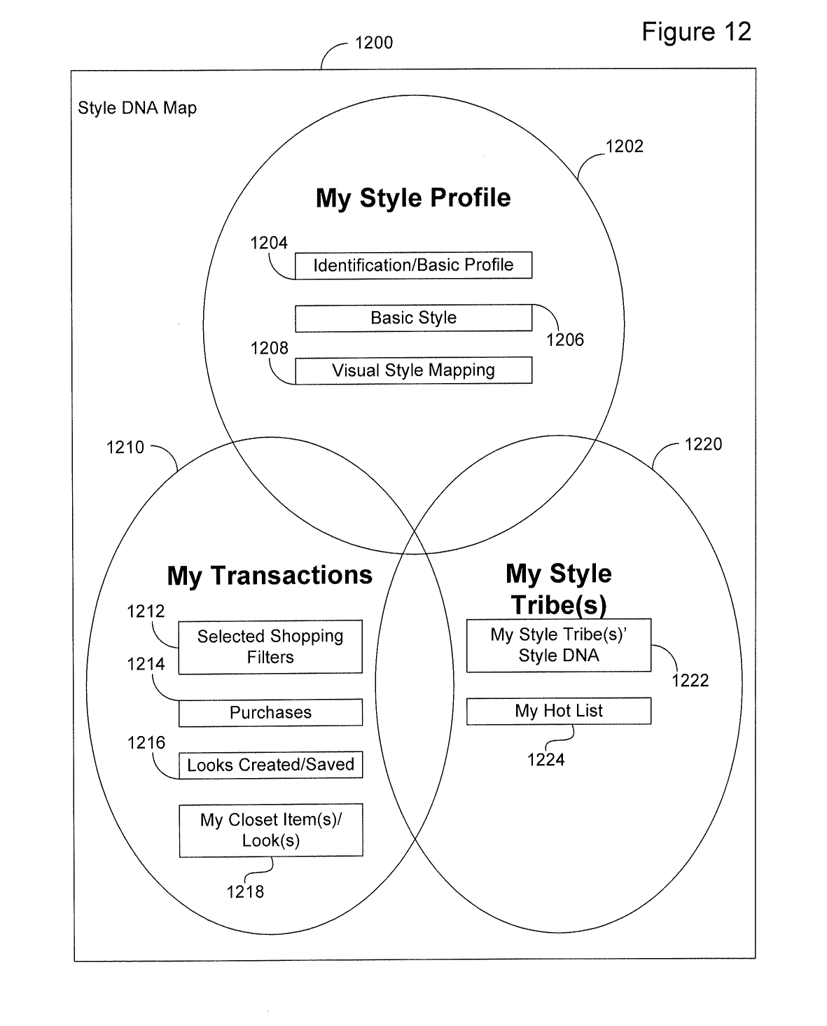

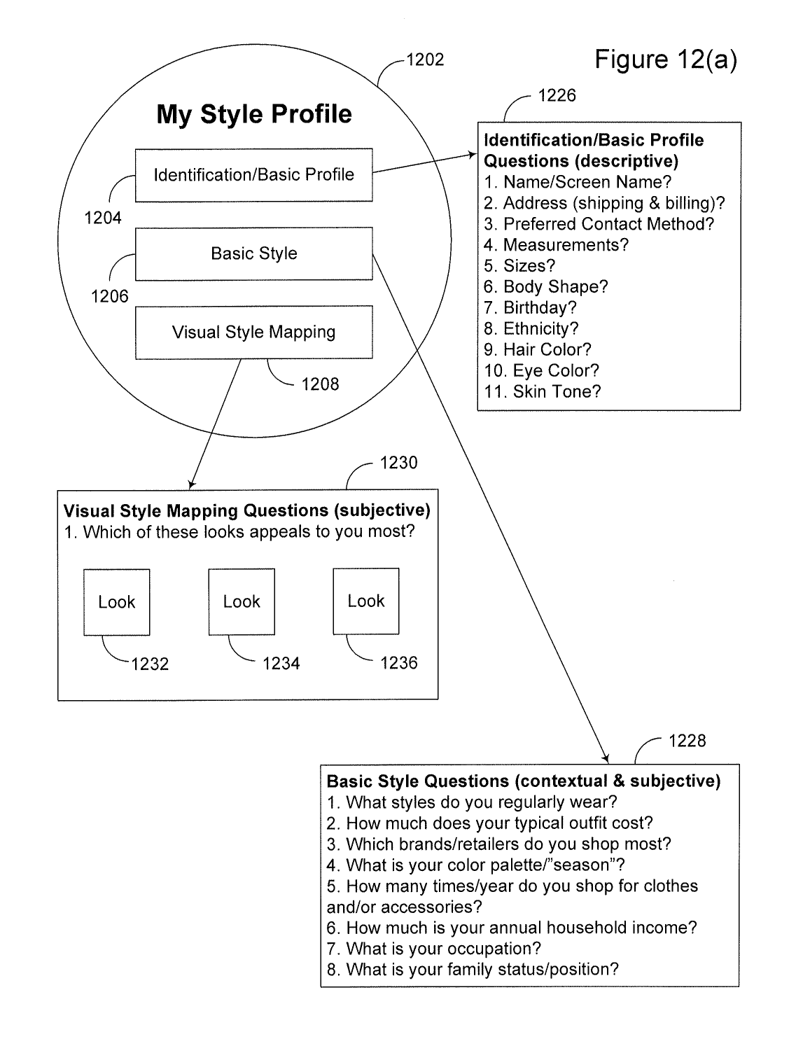

FIG. 5 shows a flow chart outlining the steps of another implementation of the present invention, the Registered User Model, which allows users to perform various, higher level functions after registering for the system. First the user connects to the system (step 500), either by navigating there on a web browser, opening the system application on their mobile device, or by any other applicable method of connection. Next, the user may log in to the system and select the preferred shopping method, either Shop Items, Shop Looks, Create a Look, or Window Shop (step 502) by entering their log in information and then clicking the system function they want to start their session in. In one implementation, the user may perform the user profile creation process as outlined in FIGS. 12 and 12(a) to log in.

If the user's initial preference is to work in the “My Closet” system function, the user clicks the “My Closet” icon, link, or other internet routing mechanism and the system opens My Closet (step 504). My Closet contains information on past purchases made through the system, allowing the user access to those parts of their existing wardrobe, which the user can then incorporate into building looks and/or selecting further items they wish to purchase. In one implementation, the user may also add an item from the system to My Closet despite never purchasing the item on the system. In this way, the user can add items that they already own or items that look like or are otherwise similar to items they already own, but have not purchased through the system, to My Closet, creating a more complete representation of their actual wardrobe for use in shopping, look building, look sharing/recommending, and other system tasks. The user may also delete or archive items from My Closet. This allows the user to remove or reserve items they do not wish to build looks around or otherwise have in their active My Closet temporarily, for example during pregnancy, and fill their active My Closet with items and/or looks which reflect their current weight, measurements, and sizes. In another implementation, this function may be used to fill the user's active My Closet with items and/or looks that only reflect the user's current tastes and/or trends, and are not based on weight, measurements and sizes. From My Closet, users can create looks from item(s) in My Closet (step 506). The user can browse their items or looks through the universal shopping filters discussed in relation to FIG. 4 and select an item(s) that they already own to build looks from. The user may then proceed in one of two ways. First, they may create looks from item(s) in My Closet (step 508), automatically or manually building new looks from items within My Closet. The user can also select items that they do not own within the system to match the selected item(s) to items within My Closet and create new looks, via the remix pulldown from a look page or by locking in items from their My Closet to remix using new system items to dynamically or manually create new looks, only relying on system inventory outside of the user's My Closet when it does not contain an item necessary to complete the look. Alternately the user may create looks from system inventory (step 510), which looks comprise system inventory not contained in My Closet. In this step, the system matches the selected item(s) from the My Closet to items within the system inventory but not found in My Closet to create a look. The system will return any looks on the system that use the selected items. If additional filters are applied, it will filter the look results with those additional criteria. It may also tailor the look results using the user's profile, e.g., the user's Style DNA. After creating these new looks, the user may refine looks (step 512), either by adding new universal shopping filters to their search thereby paring down the resulting looks, or by choosing one or a few of the items within a look and instructing the system to remix the look around the chosen item(s). Once they obtain a desired look(s), the user may save a look to My Lookbook (step 514), discussed further below, move the look to the universal shopping cart (step 516), or move item(s) to the universal shopping cart (step 518). Then, the user may checkout (step 520). Items purchased are processed through the universal shopping cart. The system's website server 100 sends the orders to each Affiliate listing an item purchased (step 522), and each Affiliate is then responsible for fulfillment of their portion of the order (step 524). In one implementation, the system operator gets a percentage of the revenue from purchased merchandise.

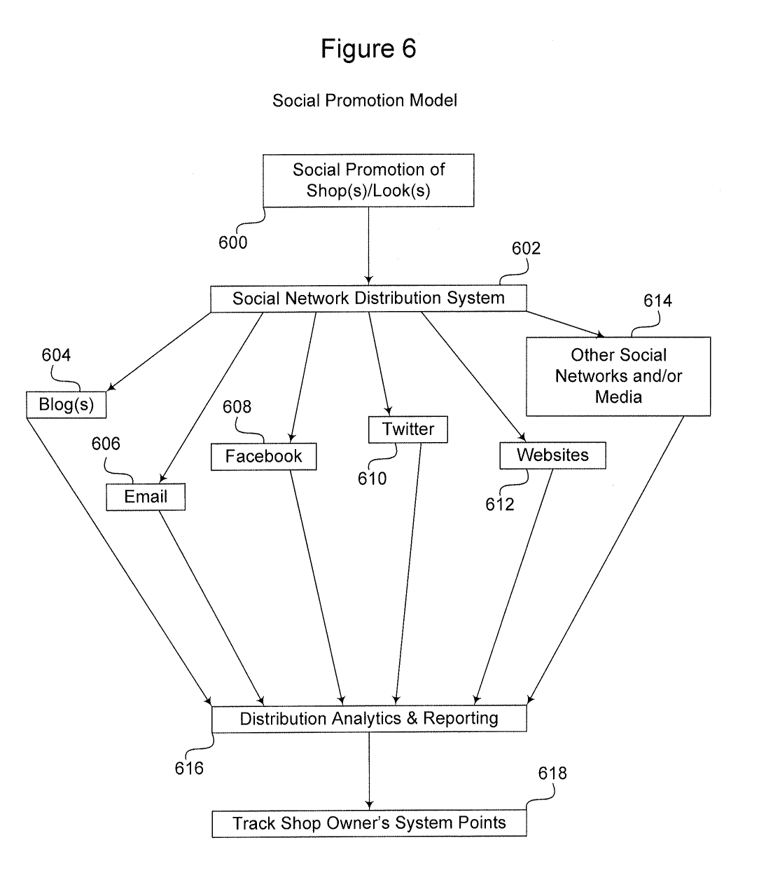

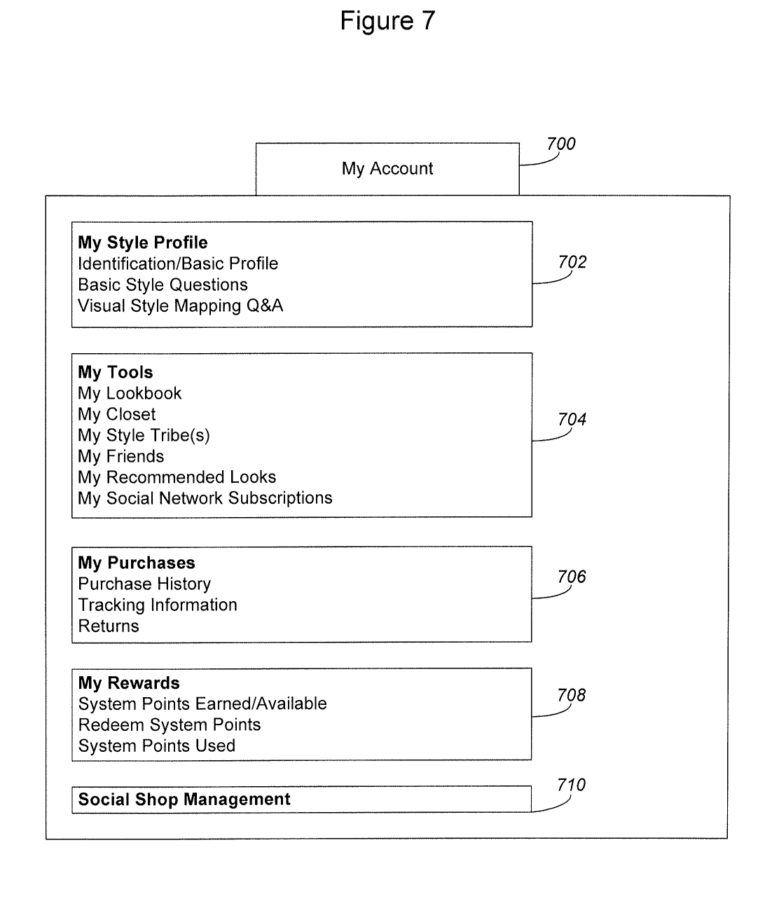

My Closet can be kept private, shared with the user's network, shared with the user's Style Tribe, the user's network and their networks, the user's friends, the user's friends of friends, shared with the entire system, or the user's social networks. The user may also turn My Closet into a Social Shop, which is discussed further below, in relation to FIGS. 6 and 7.

If the user's initial preference is to work in the “My Lookbook” system function, the user clicks the “My Lookbook” icon, link, or other system routing mechanism and the system opens My Lookbook (step 526). My Lookbook contains the user's saved looks, regardless of whether the user ultimately purchased the look. Within My Lookbook the user may create a look (step 528), making new looks which may be saved in My Lookbook. The user may create a look using any system inventory, including items within My Closet as well as system inventory outside My Closet. This ability enhances the shopping experience for system users by allowing users to enjoy creating more looks while simultaneously allowing these created looks to be shared with other users, thereby increasing the overall amount of looks available for system users to browse, refine, and/or purchase. Once the user creates a look, they may tag that look (step 530), further streamlining the system to provide more relevant results to user searches by specifying applicable tags so that search results for those filters, mapped and weighted against their Style DNA, will return the new look. Tagging a look may involve standard tags along with other, more specific tags, for example seasonal tags, trend specific tags, or any other applicable scheme of tagging. This system allows for feedback from the user base to the system owner, alerting the system owner of potential new schemes of tags to add to the system. After tagging a look, the user may proceed to save the look (step 532), saving the newly created look to My Lookbook. Finally, the user may either share the look (step 534), releasing the new look for system use by other users, or the user may keep the new look private. When sharing a look, the user releases the look to the system such that it may be browsed, refined and/or purchased by other system users. Additionally, publishing of a look to the system allows other system users to add the look to their own My Lookbook or Social Shop(s) and to promote the inventory within the released look to their own network(s).

The user may also upload to the system a photograph(s) of themselves or another person wearing a look(s), or item(s), which will then be viewable with their look itself when browsed by other system users. Such photograph(s) may help to build a following for the user's Social Shop(s), for example by allowing other users of a similar body type to evaluate whether they think the selected styles and look is appealing as worn in the picture.

My Lookbook can be kept private, shared with the user's Style Tribe, the user's network, the user's network and their networks, the user's friends, the user's friends of friends, shared with the entire system, or the user's social networks. The user may also turn My Lookbook into a Social Shop, further discussed below.

If the user's initial preference is to work in the “Recommended Looks” system function, the user clicks the “Recommended Looks” icon, link, or other internet routing and the system opens Recommended Looks (step 536). Recommended Looks contains looks that the system has curated or created for the individual user based on the user's Style DNA. The system generates recommendations within the context of “look” grouping or individual items by leveraging a dynamic table that continually updates and maps individual and/or grouped items to a list of similar individual and/or grouped items. The corresponding items reflected by the table remain based upon the indicated interests of user and that of the collective community of system users. The degree of corresponding values, also known as the similarity score, given items may be calculated by several methods. One embodiment in generating recommendations is a straightforward table retrieval of items listed as similar items based on one or more characteristics, for example item type and item color. Another embodiment factors correlations of purchases of items by the number of system users making those purchases (e.g.; a large proportion of customer's within your Style Tribe who bought Item A also purchased Item F within X type of look). Additional methods may include referencing past purchases made by a user or community-based, or cumulative, as well as individual, user voting on looks or items, similar to Facebook's community-based voting “Like” button apparatus. Recommended Looks thus provides a first stop for return users, who may browse recommended looks (step 538), which may include many of the latest items uploaded onto the system, without having to first perform a search. In browsing recommended looks, a user may refine recommended looks (step 540) using the universal shopping filters available on the system to pare the selections to a more narrow range of looks. The user can also remix a selected look via filters, either by applying remix pull-down options, or by choosing one or multiple of the items within a look to keep as the foundation which the user may then automatically or manually build a new look around, as described below in relation to FIGS. 14 and 17. Once a look is finalized, the user may save the look to My Lookbook (step 542), move the look to the universal shopping cart (step 544), move item(s) to the universal shopping cart (step 546), or choose to do nothing, abandoning the look. Then, the user may checkout (step 548). Items purchased are processed through the universal shopping cart. The system's website server 100 sends the orders to each Affiliate listing an item purchased (step 550), and each Affiliate is then responsible for fulfillment of their portion of the order (step 552). In one implementation, the system operator gets a percentage of the revenue from purchased merchandise.

If the user's initial preference is to work in the “Create a Social Shop” system function, the user clicks the “Create a Social Shop” icon, link, or other internet routing mechanism, and the system opens Create a Social Shop (step 554).

Create a Social Shop allows any user to become a Social Shop Owner, and thereby collect System Points for purchases made through their Social Shop. In one implementation, System Points may be redeemable for items available within the system. Create a Social Shop requires the Social Shop Owner to create a Shop Profile and Shop Description, which includes selecting keywords, tags, categories and/or any other suitable differentiation method, allowing their Social Shop to be more easily found within the system. Additionally, Social Shop Owners may upload an avatar or other image to represent their Social Shop. Social Shops may help expand the current popularity of social networking into the realm of commerce. Instead of advertisers coaxing people to purchase products, Social Shop Owners may share their personal likes and dislikes with their friends, and acquaintances, whether they've met them in “real life,” or simply connected with them through the system or other technical means. This process may be a closer proxy for how many people make their shopping decisions. For example, many friendships are forged, at least in part, on similar likes and tastes. A user who agrees with a friend's tastes in handbags is enabled to visit that friend's Social Shop and browse that friend's inventory of handbags, which the user is more likely to find appealing and relevant to their own personal tastes.

After creating a Social Shop, the Social Shop Owner may create looks using any system inventory (step 556), or use existing or modified existing looks, allowing the Social Shop Owner to populate their Social Shop with looks that align with the keywords, tags, and/or other suitable differentiation method that they have chosen to differentiate their Social Shop. In this way, the looks in the Social Shop are most likely to be relevant and appealing to users who have browsed to that Social Shop, especially those users who have arrived by way of a keyword or other search method that narrows results based on relevance to the search. In an alternate implementation, the Social Shop owner can start by creating an untitled, untagged and undescribed Social Shop, where they pull in or create looks forming a cohesive set. They then may title, tag and describe their shop after the looks are compiled. The Social Shop Owner may then tag the looks (step 558) with their subjective categories provided by the system and/or any they may choose to add, further streamlining the system to provide more relevant results to user searches, within the Shop Owner's Style Tribe(s). Tagging looks may involve standard tags along with other, more specific tags, for example seasonal tags, trend specific tags, or any other applicable scheme of tagging. This system allows for feedback from the user base to the system owner, alerting the system owner of potential new schemes of tags to add to the system. After tagging the new looks, the user may save the looks (step 560) adding looks to their Social Shop. After saving looks, the Social Shop Owner may publish the looks to the system (step 562) so that the newly created looks will appear in the owner's Social Shop. Publishing a look to the system allows it to be browsed, refined and/or purchased by other system users as specified by the Social Shop Owner. The Social Shop Owner may choose to share the looks in their Social Shop with the user's Style Tribe, the user's network, the user's network and their networks, the user's friends, the user's friends of friends, shared with the entire system, or the user's social networks. Finally, the Social Shop Owner may choose to promote their shops(s)/look(s) (step 564), executing promotions within the system or via social networks, blogs, or other such sites or channels. Additionally, release of a look to the system allows other system users to add the look to their own My Lookbook or Social Shop(s) and to promote the inventory within the released look to their own system network. This allows system users to assimilate a look and promote it to their system network through their own shop, thereby earning System Points for themselves. This incentive structure helps system users to promote the greatest number of items to the greatest number of potential users, increasing potential profit for those involved—system owner, Affiliates, and users, while also allowing users to easily browse a broad range of retailers, items and price points.

FIG. 6 shows a flow chart outlining the steps which Social Shop Owners and/or Affiliates (collectively, “Shop Owners”) may follow to perform social promotion of their Social Shop(s) and/or Affiliate Shop(s). Any Shop Owner may perform social promotion of their shop(s)/look(s) using the various system tools (step 600). As a Shop Owner builds their system network and engages in social promotion of their shop, they become increasingly likely to earn more System Points. In one implementation, the users may receive system points based on how much “traffic” or “unique monthly users” their Social Shops attract, for making a direct recommendation via a PDA, mobile, tablet or any “bump” technology enabled device, or any other such sharing of items or looks. The system may offer system points as rewards for actions that drive increased reach of the platform, increase the number of unique users, and for actions that lead directly to conversion, which may result in the highest points awarded. Additionally, increased networking and social promotion expands the number of looks available for users to browse, refine and/or purchase, increasing overall system performance and user satisfaction. System tools may include applications for Facebook, MySpace, Twitter and any other Social network and/or media. The system may export item(s) and/or look(s) through promotional tools such as a “Featured Item,” “Look of the Day”, or other promotion. The system may also export item(s) and or look(s) through email to anyone in the user's system network or other personal network, for example email contacts or Facebook friends. In one implementation, this is done through a personalized email sent to a member of the user's system network with a descriptive email message of the reason the user is sending the look, for example, “System User X has created this look for your upcoming job interview.” Not only is this function potentially helpful to the recipient, but it facilitates communication and the forging and/or maintenance of user friendships by allowing users to make a thoughtful gesture. This networking function may increase user satisfaction and system prestige. The system may also export entire Social Shop(s) to a user's blog(s) and/or website(s). In other implementations, users may export item(s), look(s), and/or Social Shop(s) using other system tools, or they may develop custom applications and/or widgets using the system's APIs.

The social network distribution system (step 602) contains various network distribution tools which Social Shop Owners may use to promote their shops, including blog(s) (step 604), email (step 606), Facebook (step 608), Twitter (step 610), websites (step 612), or other social networks and/or media (step 614). It should be understood that this list of system network distribution tools is not meant to be exhaustive, and may include any other suitable tool. For example, in one implementation, users are allowed to develop their own tools using the system's APIs. System tools provide the linkage and tracking for distribution analytics and reporting (step 616), which allow a Social Shop Owner to see what tools are performing best for promoting their shop. Distribution analytics and reporting are also tied to the overall system database, allowing the system to track individual demographics' browsing and shopping behavior. Additionally, when Shop Owners use the system network distribution tools or tie in to the system using the provided API protocols, the system may track Social Shop Owner's System Points (step 618) within the Social Shop Owner's “My Account,” specifically in “My Rewards” discussed below in relation to FIG. 7.

Social Shop Owners may promote their Social Shop using various system tools, as described in relation to FIG. 6. In one implementation, bumping is used (see Bump Technologies, Inc, http://bu.mp). In this implementation, the bump allows a Social Shop owner to share an item or look with another user, and after said bump that user can go directly to their universal shopping cart and purchase the bumped item or look using their mobile device. Social Shop Owners building their system networks and promoting their Social Shops is likely to increase their conversions, which in turn increases their System Points, or total rewards. Additionally, this behavior also improves the overall system performance, meaning that system functionality aligns the interests of retailers and consumers. Other system tools for Social Shop promotion may include applications and/or widgets for Facebook, Twitter, MySpace, other Social networks and/or media, and any other relevant system tools.

FIG. 7 shows an exemplary embodiment of a user's “My Account” page. My Account 700 allows a user to complete, in one implementation, three levels of Style Profile information and questions and answers, as well as to access the user's “My Tools,” “My Purchases,” “My Rewards,” and “Social Shop Management” pages.

My Style Profile 702, discussed in further detail below in relation to FIGS. 12 and 12(a), allows a user to populate basic identification and profile forms, and answer a series of style questions based on written questions and/or a series based on visual and/or pictorial prompts in order to build the user's “Style DNA.” In one implementation, there are three levels of engagement in building My Style Profile 702, potentially involving three different levels of time commitment. The first level involves populating an Identification/Basic Profile form, which may ask for the user's name, location, age, ethnicity, hair color, eye color, skin color, and other basic personal descriptive and identification information. The second level involves answering a series of basic style questions which allow the system to discern the user's shopping habits, preferred price points, preferred designers, and other information about their normal methods of shopping, both online and at brick and mortar stores. The third level is Visual Style Mapping, which asks the user to answer questions based on visual and pictorial cues, such as asking a user to choose the most appealing look from a group of looks, to build a more targeted tag profile based on the user's personal “style” and tastes, allowing the system to build the foundation of the user's “Style DNA,” discussed below in relation to FIG. 12. Visual Style Mapping allows the system to get “smarter,” using the user's answers to begin the process of “learning” the user's subjective style and tastes. Later, this process continues based on the user's system behavior, including browsing, saving and purchasing behavior. The system tracks the items and looks that the user has browsed, purchased or saved. Tags of these items and looks may be used to influence the search or remix results for this user, whereas the looks that are returned are more likely to have items having these or similar item or look tags. For example, if a user purchases a certain designer, the tags of that designer may be used in the search or remix results to return looks also having those or similar tags. Looks that are saved to My Lookbook, are purchased, or are saved as an item in your closet, may be given higher weighted ranking mapped against the user's Style DNA. Each increasing level of engagement within My Style Profile 702 completed by the user allows the system to hone in on the user's personal style and tastes, thereby allowing the system to return increasingly targeted search results for the user.

My Tools 704 allows a user to access their “My Lookbook,” “My Closet,” “My Style Tribe(s),” “My Friends,” “My Recommended Looks,” and “My Social Network Subscriptions.”

“My Lookbook” holds looks that the user has created or otherwise wishes to save to their “My Lookbook.” Looks can be saved into “My Lookbook” regardless of whether the user has purchased the look. “My Lookbook” functions as an electronic scrapbook which the user can revisit anytime, for example to browse looks they enjoy, remix the looks therein to fit their current tastes, or share looks with friends and/or family, for example to share gift ideas.

“My Closet” is a collection of system items and looks that can be made from these items that the user owns, or that are chosen by the user for some other reason, for example the item is similar to something the user owns but did not purchase via the system. Purchases made on the system may be automatically added to the user's “My Closet,” and the user can also add system items that they purchased elsewhere and any other system items they wish, for example if the system item looks like or is otherwise similar to an item the user already owns, to create the most complete representation of their actual wardrobe for system use. In one implementation, the system may leverage technology such as Google Goggles or Snaptell, allowing users to photograph item(s) and then use the system to find the closest match(es) to that item, which the user may then save in “My Closet” to represent the photographed item. The system may offer a system credit card that may be used at any e-commerce site or brick and mortar retailer that is affiliated with the system to automatically track purchases that map back to items within the system. In one instance, this could be a method of populating the user's “My Closet” with relevant purchases, even made outside of the system.

“My Style Tribe(s)” may embody two separate functions. First, it contains a sortable, visual listing of a user's item or look recommendations and selections for their Tribe(s). Each of a user's Style Tribes are made up of other users whom the system identifies as the closest matches to the primary user's Style DNA, described further below in relation to FIGS. 12 and 12(a). The system may continuously recommend new Style Tribe members for each user, and the user can choose to add or remove them from their Style Tribe at any point. A user's Style Tribe may lend value added social influence for each user's recommendations, searches, filtering, remixes, or other system processes. Second, it allows the user to select a “Watch List” or “Hot List,” a list curated by the user and containing some number of other users whose recommendations most appeal to the user or who the user wishes to promote. For example, the system may allow a user's “Watch List” or “Hot List” to contain 5 other users, 10 other users, or any other number of users as dictated by the system owner. The most “Watched” Tribe member can then become the Style Tribe Leader and as such, can receive increased visibility and other benefits dictated by the system owner.

“My Friends” allows users to invite others to become users and to add other users as friends via import of their friends' lists from other social media or import of their email contacts. Using “My Friends,” a user may also search for people to add as friends and send friend invitations, which may be accepted or ignored by the invitee. If any of a user's friends has a shared Social Shop(s), they may be viewed here as well.

“My Recommended Looks” contains looks recommended to the user by the system, friends, and/or Style Tribe members. In one implementation, the user can choose to remove a look and the system will respond by asking the user to provide a reason why they wish to remove the look. The answer may be chosen from a limited set of possible answers, or the system may accept user input defining the reason. This question and answer will help the system refine the user's Style DNA and item/look recommendations.

“My Social Network Subscriptions” allows the user to manage their other social networking and/or media accounts and those accounts' interaction with the system. For example, the user may want to ensure access to their friends from other social networks and/or media in order to promote the user's Social Shops to said friends.

My Purchases 706 allows a user to access their Purchase History, Tracking Information for shipped purchases, and Returns. Additionally, this is the section where the user will have options for contacting system Customer Service and individual merchant's Customer Service from which they have purchased in the past.

My Rewards 708 allows the user to track their earned and/or previously redeemed System Points and to redeem System Points for item(s) and/or look(s) available on the system. In one implementation, the My Rewards 708 may also include pictures of “upsell item(s),” item(s) chosen based on the user's “My Style Profile” or “Style DNA”, compatibility with item(s) in the user's “My Closet,” or any other pertinent sorting criteria, and which also indicate the price of the item(s) in System Points and either how many System Points the user would have remaining after redeeming System Points in exchange for the item(s), or how many more System Points the user would have to earn in order to redeem System Points in exchange for the item(s). Additionally, the “System Points Earned/Available” link catalogues each separate block of System Points based on how they were earned, allowing the user to track whether they have earned them via their Social Shop(s) or via buying item(s) and/or look(s) from the system. In another implementation, the user can select an Item to “save up for” via system points. As friends, or networks connections purchase through the user's Social Shop(s), the system may provide an audible sound cue to the user's mobile, tablet, computer or other such device, for example, to prompt the Social Shop Owner to check their system points status, thus driving return visits to the system. This audible cue may be activated or deactivated by the user and is not meant to serve as the only prompting method to entice return visits.

Social Shop Management 710 allows the user to access their existing Social Shop(s), create new Social Shop(s), maintain and update existing Social Shop(s), and/or promote their existing Social Shop(s). This function also provides access to the user's Social Shop(s) analytics and reporting, allowing them to digest these statistics and create more effective promotional campaigns for their Social Shop(s) by accounting for and leveraging the promotional channels that are delivering the best results.

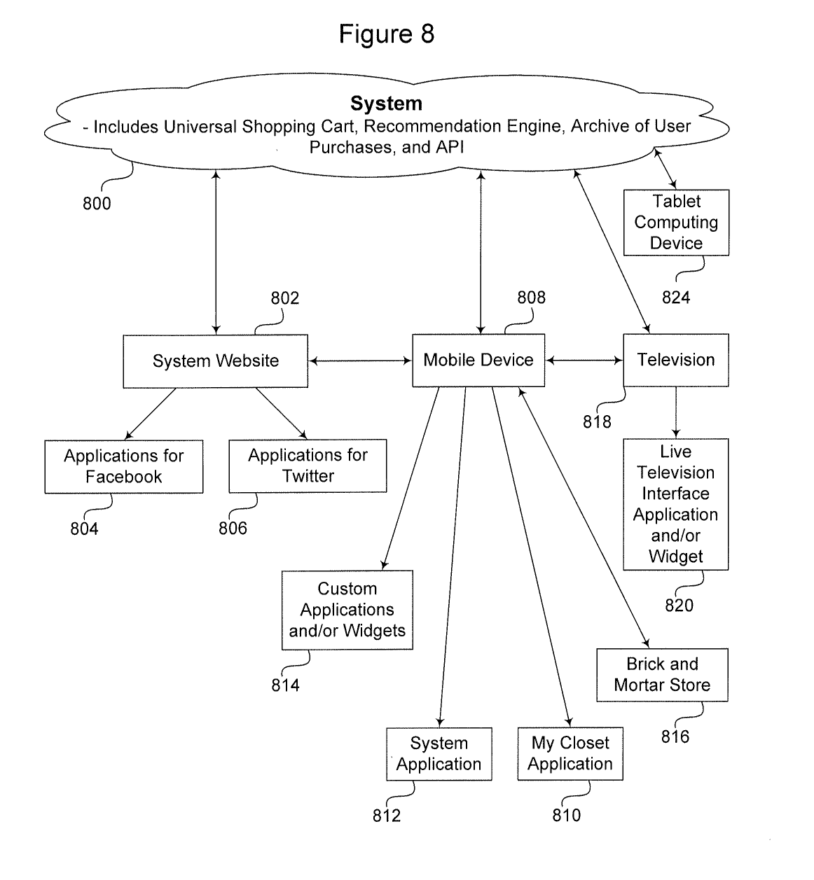

FIG. 8 is an exemplary, high-level representation of one method of integration and media distribution within the system. The system 800 may be accessed via a System Website (step 802) which, through Affiliates, Social Shop(s), Social Shop Promotion, and various other interactive tools, creates a network of users who have access to their My Closet, a system representation of their wardrobe, to use for example, for browsing, sharing with others, or shopping for items to update or add to their wardrobe. Through the system's APIs, developers may create applications for Facebook (step 804), applications for Twitter (step 806), and/or applications for any other social networking or social media system.

The system 800 may also be accessed via mobile device (step 808), such as a mobile phone or PDA, including access through applications and/or widgets to various system tools. For example, the user may access a My Closet application (step 810), a system application (step 812) including the system functionality, or custom applications and/or widgets (step 814), developed through the APIs. Additionally, in one implementation, if the user has downloaded a barcode scanning application, such as “ScanLife,” they may scan barcodes on item(s) within a brick and mortar store (step 816). Then, the user may use the system to incorporate the scanned item into looks or otherwise manipulate the system to aid them in the purchasing decision. The APIs may encourage developers to create custom applications that leverage the system in new ways to increase the reach and maximize the system's users.

System 800 may also interface with television (step 818). Live television interface applications and/or widgets (step 820) represents applications and/or widgets which exist live within a digital television interface, like the Twitter and Facebook widgets developed on Verizon's Fios television service for example. In one implementation, System 800 may be used by sponsors or advertisers of television programming, giving users the ability to remix, modify, save, share, or buy look(s) or item(s) worn during the show using the system interface with their television, moving the look(s) or item(s) seen during the program directly to their universal shopping cart, with no need to access the system through other ways, such as a computer.

A tablet computing device, such as the iPad by Apple, Inc., may also be used to access the system (step 824). In one implementation, the system generates new revenue by charging fees to allow magazine publishers to offer premium advertising services, such as shopping, remixing, modifying, filtering, saving, sharing, and/or buying of looks or items featured in the advertising, editorial, or any of their pages or covers. For example, a user could view a Look or Item within a magazine on an iPad or similar device and use the system application/functionality to remix the look or items to the user's price points, size, body type, etc. This allows them to purchase and convert on the spot rather than having to find a way to recreate something they like manually on their own.

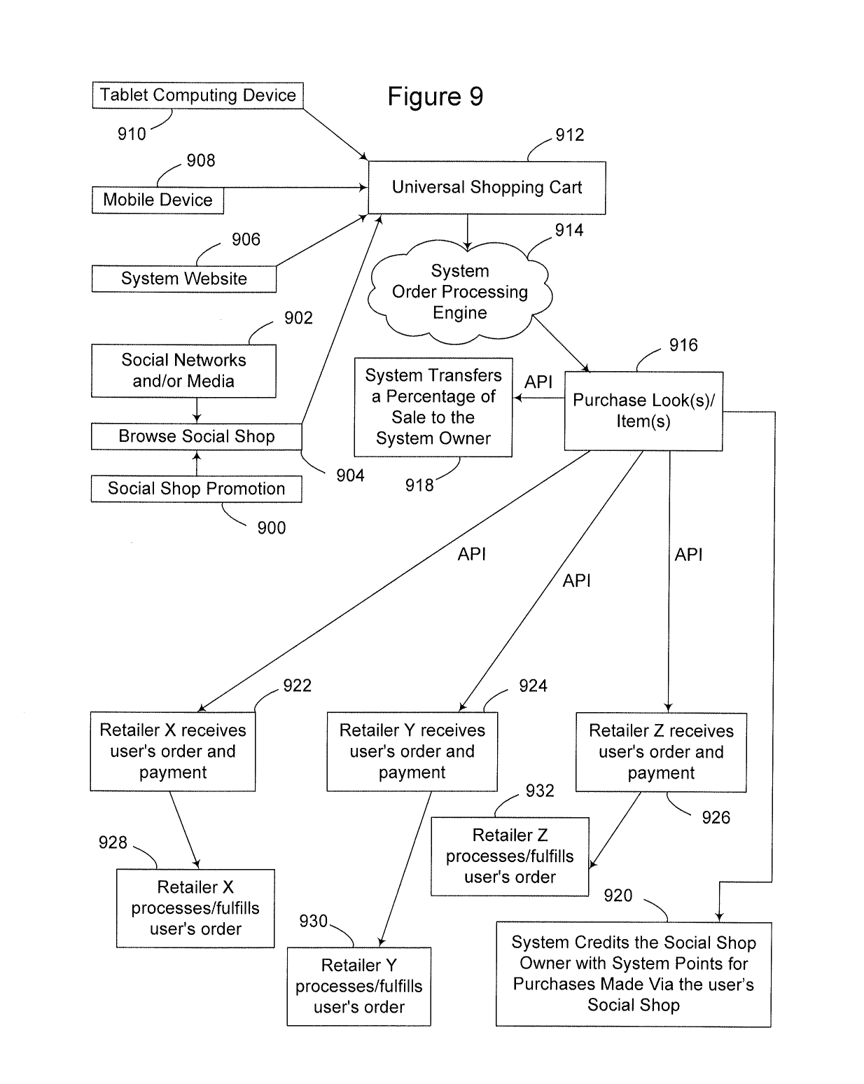

FIG. 9 shows an exemplary embodiment of universal shopping cart processing, beginning with exemplary points of entry—into a Social Shop Promotion (step 900) via a Social Network and/or Media (step 902), into a Social Shop Promotion via browsing a Social Shop (step 904), via the system website (step 906), via a mobile device and associated applications and/or widgets (step 908), or via a tablet computing device, associated applications and/or widgets (step 910) or any yet to be created device that could leverage the system. The system tracks and records users' points of entry and corresponding browsing sessions, ultimately adding them to the system's behavioral learning library, for example to refine the user's “Style DNA.”

After entering through any of the aforementioned entry points, the user may then put look(s) and/or item(s) they wish to buy into the universal shopping cart (step 912). Look(s) and/or item(s) that are added to cart are placed into the System Order Processing Engine in preparation for transaction completion (Step 914). Orders are processed through the System Order Processing Engine using APIs to confirm final availability with each retailer.

If the user makes the final decision to purchase look(s) and/or item(s) (step 916), in one implementation the system transfers a percentage of sale to the system owner (step 918), depending on the contract terms between the system owner and the affiliate responsible to fulfill the sale. Simultaneously, if the items were purchased via a user's Social Shop, the system credits the Social Shop Owner with system points (step 920), giving the Social Shop Owner from whom the user originally selected the look(s)/item(s) for purchase an account credit for the number of System Points corresponding to the user's overall order total, as well as points available due to points based promotions applicable at the time the order was made. The user completes the cart transaction for the look(s), item(s) and corresponding retailers within their order through the universal shopping cart, allowing for a seamless and streamlined check out experience. Also, concurrently with the purchase of look(s) and/or item(s), the system sends each individual retailer responsible for fulfilling part of the order a separate order specifying which item(s) the user has purchased from that retailer and the corresponding amount of payment due the retailer (steps 922, 924, and 926). It should be understood that in other exemplary embodiments, this step may involve any number of retailers, including only one retailer being responsible to fulfill an entire order.

The system also employs APIs to maintain a live stream of data from each of the multiple retailers involved in a single transaction. These APIs allow for the retailer to receive its portion of the order and its corresponding payment, minus the percentage fee paid to the system owner, if applicable, allowing each retailer to process and fulfill their portion of the order. After the retailer(s) receive an order and corresponding payment, the work of the system is over, and it becomes the responsibility of each individual retailer to process and fulfill their portion of the universal shopping cart transaction (steps 928, 930, and 932). Through the API, in one implementation, the system sends an order and payment, minus any fee, for the item(s) to the responsible retailer. The retailer is then responsible for fulfillment of that order including shipping the item(s) to the user, and the API continually sends a real-time stream of the order's status so the system can generate and send status emails, tracking information, and the retailer's return policy. In one implementation, this process runs simultaneously and extends to as many unique retailers as are involved with a single order. For example, the user may have purchased an entire look using the system, with a dress purchased from Retailer X, shoes purchased from retailer Y, and accessories such as a handbag and jewelry from Retailer Z, and the process would run separately for each of these three retailers. In an alternate implementation, the system sends orders via the APIs and extracts the system fee(s) agreed upon with each retailer/affiliate as a monthly or bi-weekly payment to the system. An API is an interface that defines and maintains the manner in which the initial transaction entity, here the system, communicates with the secondary entity or entities, here the retailers or affiliates. The API allows the purchase transaction to be communicated with the remote transaction application of the retailer or retailers involved in the purchase via a series of calls. These calls are managed between the entities through the Web Services protocols (inclusive of Extensible Markup Language (“XML”) which is the programming language by which applications communicate over the Internet) that are incorporated into the system API. The API itself may be comprised of code written as a series of XML messages. Each message relates to a different function of the entity communication service, such as security processing, retailer identification, item number, price, or other functions.

By this process, the universal shopping cart allows for a user to purchase items from multiple retailers via APIs on the back-end, or server side of the system, which provide streaming, live communication between the Affiliate retailers' websites and the system. The universal shopping cart becomes a seamless extension of a retailer's existing e-commerce website and, in one implementation, without requiring changes in warehousing or inventory management.

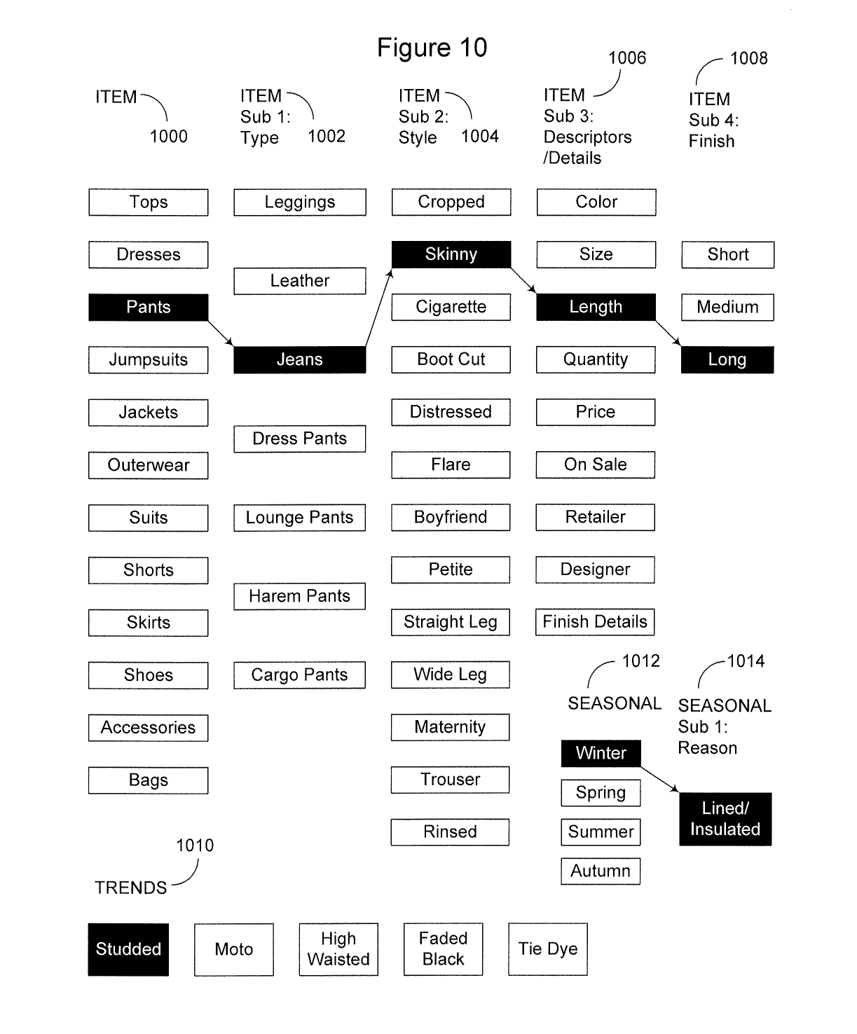

FIG. 10 shows an exemplary embodiment of the Inventory Upload Tagging Schema associated with the system. Using said schema, affiliates may tag their inventory in a specific manner, effectively “describing” each of their items to the system in specific detail so that each item is searchable by users. First, the affiliate chooses a general ITEM 1000 tag for each uploaded item. FIG. 10 shows 12 examples of possible top level item tags, but it should be understood that there may be more or less possible tags in other exemplary embodiments. Once the affiliate tags the item with a general, top level ITEM 1000 tag, a first sub-list of item tags, ITEM Sub 1: Type 1002, appears, allowing the affiliate to further classify the item based on the type of general item. For example, in FIG. 10, the affiliate chose the ITEM 1000 tag “pants,” and the System pulled up the ITEM Sub 1: Type 1002 menu for pants. Again the affiliate may choose one of these options, for example based on which option the affiliate thinks is most applicable to the item. Once the affiliate tags the item with an ITEM Sub 1: Type 1002 item tag, a second sub-list of item tags, ITEM Sub 2: Style 1004 appears, allowing the affiliate to further classify the item based on the style of the item, choosing one or many of the tags as appropriate to that item. For example, in FIG. 10, the affiliate chose the ITEM Sub 1: Type 1002 tag “Jeans,” and the system pulled up the ITEM Sub 2: Style 1004 menu for jeans. Again the affiliate may choose one of these options, for example based on which option the affiliate thinks is most applicable to the item. Once the affiliate tags the item with an ITEM Sub 2: Style 1004 tag, a third sub-list of item tags, ITEM Sub 3: Descriptors and Details 1006 appears, allowing the affiliate to further classify the item based on the descriptors and/or details applicable to the ITEM Sub 2: Style 1004 tag of the item. For example, in FIG. 10, the affiliate chose the ITEM Sub 2: Style 1004 tag “Skinny” and the system pulled up the ITEM Sub 3: Descriptors/Details 1006 menu for skinny jeans. Once the affiliate tags the item with an ITEM Sub 3: Descriptors/Details 1006 tag, a fourth sub-list of item tags, ITEM Sub 4: Finish 1008, appears, allowing the affiliate to further classify the item based on the finishing of the ITEM Sub 3: Descriptors/Details 1006 of the item. For example, in FIG. 10, the affiliate chose the ITEM Sub 3: Descriptors/Details 1006 tag “Length” and the system pulled up the ITEM Sub 4: Finish 1008 menu for finishing of the length of skinny jeans, and the affiliate chose “long” as the length of the skinny jeans being described. It should be appreciated that in this and other exemplary embodiments, it may be possible for the affiliate to apply more than one tag in a given sub-list to a single item. For example, some jeans may be skinny and distressed. In that instance, it may be possible for the affiliate to choose both the “skinny” and “distressed” options in the ITEM Sub 2: Style 1004 menu. In this embodiment, the ITEM Sub 3: Descriptors/Details 1006 menu for both the “skinny” and “distressed” categories of ITEM Sub 2: Style 1004 would then appear, and the affiliate would continue to tag the item accordingly. Although FIG. 10 shows a general item list and four sub-lists, it should be understood that the number of deeper level classification sub-lists may vary depending on any pertinent reason, for example higher level choices may lead to fewer sub-lists, or the system owner may simply choose to add or subtract sub-lists. Tags at or below the top level may offer an option to allow the users to recommend new tags and categories. Once a new tag or category reaches a determined threshold of similar or same requests, the new tag or category may be dynamically or manually added to the tagging options. Similarly, any irrelevant tags or categories may be removed or archived, reducing their relevance in search results.

In addition to the general item tagging and the associated sub-list tagging, in one implementation the system owner may also offer further tagging categories such as TRENDS 1010 and SEASONAL 1012. In TRENDS 1010, the affiliate is permitted to tag the item based on current trend tags offered by the system owner. The trend tags shown in FIG. 10 are merely examples, and may vary or not be available in other exemplary embodiments. In FIG. 10, the affiliate tagged the skinny jeans under TREND 1010 as “studded.” Additionally, in one implementation, SEASONAL 1012 may be available, enabling the affiliate to tag their item based on the season they wish it to be associated with, and in one implementation, the SEASONAL 1012 tags may offer sub-lists in order that the affiliate may select the reason their item is appropriate for that season. In the example of FIG. 10, the affiliate tagged the studded, long, skinny jeans as winter appropriate under SEASONAL 1012, and then specified that they are winter appropriate because they are lined and/or insulated under SEASONAL Sub 1: Reason 1014.

Once an item is uploaded onto the system and tagged by the affiliate as outlined in FIG. 10 and the above description, users are able to browse that item based on specific, targeted searching. For example, the studded, lined and/or insulated, long, skinny jeans described above would be returned by the system in response to a number of searches. For example, they would be returned in response to searches for: winter items, pants, long jeans, studded items, skinny jeans, long pants, lined/insulated items, and a number of other targeted searches based on the tagging schema offered by the system. This system allows users to quickly and specifically search for the exact item they want to buy, without having to browse through hundreds of search results because of inadequate filtering.

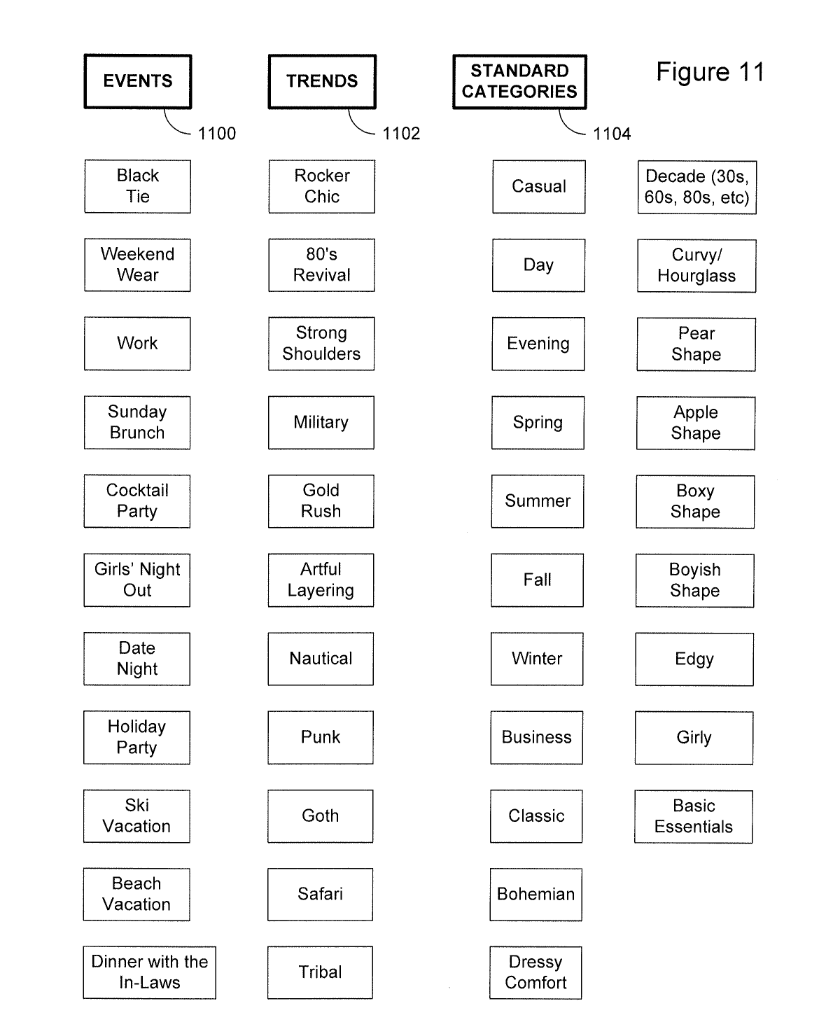

FIG. 11 shows an exemplary embodiment of the Look Tagging Schema associated with the system. Look tags apply to a look as a whole. They may represent the look creator's subjective point of view, taste and style, thus layering subjective relationship context to the items descriptive tags within the look. Descriptive tags, for example, may include top, blouse, peter pan collar, buttons, orange, drop waist, etc. Subjective tags for example, may include edgy, feminine, classic, nighttime, etc. In one implementation, look tags are subjective and item tags are descriptive. In this implementation, individual items do not get manually tagged with subjective categories, but they “inherit” categories from the looks that the item is used in, and those categories are given relevance within the Style Tribe of the look creator. Thusly, a single item can be deemed “Edgy” and “Urban” within one Style Tribe, but the same item may be given weight as “Punk”, “Goth” or even “Classic” within different Style Tribes. As with item(s), the system, in one instance, makes affiliate and user created looks specifically searchable based on the high level tagging schema available to system users. EVENTS 1100, TRENDS 1102 and STANDARD CATEGORIES 1104 show tag headings which may be implemented by the system owner to organize tags for easier tag browsing and application by users. For example, EVENTS 1100 comprises tags users would be expected to apply to looks created for a specific event, such as “Work” or “Beach Vacation.” TRENDS 1102 comprises tags users would be expected to apply to looks which embody a trend, which are theme based, such as “Punk” or “Military.” Finally, STANDARD CATEGORIES 1104 includes less classifiable tags such as “Casual” and “Edgy.” Further implementations may have more or fewer tag categories and/or tags. Further implementations may also have tag subheadings. The look creator's categories and tags are then weighted against a user's Style DNA via the system's algorithm when running a search or group search query. A user may tag a look with as many relevant tags as they see appropriate. In one implementation, the system increases ranking and/or visibility of and affiliate's items/looks that are continuously published with appropriately tagged items, and relevant and appropriately tagged looks that connect with a user's Style Tribes by way of the user's looks being saved, purchased or shared with minimal remixing. In one implementation, a user's visibility and relevance is determined by an Affiliate or user's ability to create Looks desired by the crowd, or their Style Tribes.

FIG. 12 represents an exemplary embodiment of the “Style DNA Mapping” function of the system. Style DNA Mapping is a record of the user's “Style Profile,” transactions, and “Style Tribe.” Using the user's Basic Profile, answers to style questions, and transactions, the system maps the user's “style” to that of other users with similar Basic Profiles, who gave similar answers to the Style Profile questions, and have bought similar items. The system matches Style Tribe members to a user using a weighted mapping of the system user's Style DNA against the primary user's Style DNA. For example, the most critical matches may be a user's descriptive Style DNA Basic Profile answers, such as measurements, sizes, body shape, age, hair color, skin tone, and perhaps geographic location. The next highest ranked may be mapping how closely they match on answers to a few of their Basic Style Questions, and then lastly matching their answers on the Visual Style Mapping, in one instance. This example is not intended to limit the variables or ranking that the system may use. The system then assembles these similar users into a Style Tribe and adds the overlapping Tribes' Style DNA meta data, for example tags, to the users' Style DNA Map. Tribe members with the closest mapping Style DNA to the user having the most influence on the user's recommendations derived from the system. As a user provides more information, their Style DNA Map becomes more accurate. For example, the user's Style DNA Map may be limited if the user chooses not to complete the Basic Style Questions or Visual Style Mapping Q&A, but the system leaves this choice to the user to complete those items at a later time. On the other hand, by answering the Style Profile questions, the user provides more data for the system to build their Style DNA, making it more targeted and accurate. Through this implementation of the system, the user may choose to begin browsing buying, and/or building or remixing looks immediately, instead of spending a large amount of time entering profile information, and the system nonetheless refines its recommendations for the user based on the user's behavior in browsing, buying, and building or remixing looks. In one implementation, the user has to answer a minimum set of questions to begin using the system.

A method is employed for building a dynamic element, or keyword, correlation table in which elements, for example the tags and categories comprising a unique user's Style DNA, and the corresponding identification keywords are sorted by preference-based valuation derived from weighted attributes of the individual's selected preferences in combination with those preferences chosen by aggregate via groups for which the individual is a member. This process may enable a construct in which a context of preference is leveraged as a primary query parameter for item searching based on specific groups. The corpora and range of the searchable items may correspond to the correlation table of items and look groups associated with the individual and that of the individual's chosen groups. Through the utilization of this method, the group search functions in a dynamic way to produce query results offering the highest probability of preferential aesthetic alignment between that of the user and that of the group.

The first component of a Style DNA Map 1200 on the system is My Style Profile 1202, as detailed further below in relation to FIG. 12(a). In one implementation, there are three levels of engagement that involve different levels of time commitment, allowing the user to get started quickly and add more detail later. My Style Profile 1202 allows the user to choose to populate their Identification/Basic Profile 1204 with general personal information. Additionally, a user may choose to answer none, some, or all of the questions under Basic Style 1206. In one implementation, these are a series of written questions and answers about the user's personal tastes. A user may also choose to answer none, some, or all of the questions under Visual Style Mapping 1208, a further set of style questions and answers about the user's personal tastes based on pictures and/or other visual cues.

The second component of a Style DNA Map 1200 on the system is My Transactions 1210. My Transactions 1210 is a record of a user's system activities and/or transactions. Selected Shopping Filters 1212 is a log of the shopping path(s) and filters applied by a user during a session on the system. Using this tool, in one instance, a user can recreate prior browsing, for example, if the user came across an item or look they wanted to purchase, then navigated away from the page before putting the item or look in their universal shopping cart, the user could use Selected Shopping Filters 1212 to find the item or look again. In another instance, the Style DNA Map information is stored on the back end of the system and is not visible to the user. Purchases 1214 is a log of items and looks previously purchased by a user, as well as the path(s), filters and remixing the user applied that lead to the item or look. Looks Created/Saved 1216 is a record of the path(s), filters, and remixing the user applied in order to create and/or save a look to their “My Lookbook” or “My Closet.” My Closet Item(s)/Look(s) 1218 is a record of the items and looks that a user has saved or purchased on the system.

The third component of a Style DNA Map 1200 on the system is My Style Tribe(s) 1220. My Style Tribe(s) 1220 is a list of other users whose Style DNA Map closely matches the user's Style DNA Map 1200. My Style Tribe(s) 1220 represents the collective likes of a group of individuals who appear likeminded to the system in areas such as, but not limited to, style, taste, system use behavior, appearances, body type, hair color, geographic location and age. Members of My Style Tribe(s) 1220 are likely similar in a number of Style DNA elements. My Style Tribe(s) 1220 links to a list of members of the individual Style Tribes. In one implementation, users may manually curate My Style Tribe(s) 1220, adding or removing users as they wish. The Style Tribe system functionality creates additional benefits for users who rarely access the system. Activity by members of My Style Tribe(s) 1220 may continuously feed into the user's Style DNA Map 1200, updating it to match use trends of other users who are most likely to have similar tastes and desires as the user. Additionally, the user may alter any unwelcome changes which occurred as a result of the system behavior of My Style Tribe(s) 1220 on their next visit to the system, when they can view and/or remove any new recommended tribe members. One benefit of the assembly of My Style Tribe(s) 1220 is to offer further opportunities for time savings. Users, who are likely to share similar tastes with members of My Style Tribe(s) 1220 may quickly access the shared item(s) or look(s) of anyone within My Style Tribe(s) 1220 by clicking the link to that user's profile within Style Tribe list. There, the user is more likely to find shared item(s) or look(s) they enjoy, avoiding the trouble of browsing for such items or looks with no direction. In one implementation, users may also earn System Points as a reward for browsing and/or buying within a Social Shop created by a member of My Style Tribe(s) 1220.

My Hot List 1224 is a list of users manually chosen by the user to further optimize the user's Style DNA Map 1200, for example because the user most closely identifies with the style of another user chosen as a My Hot List 1224 member. In one implementation, the system may also populate My Hot List 1224 by adding members of My Style Tribe(s) 1222 whose Style DNA Map most closely resembles Style DNA Map 1200. For example, the system may populate My Hot List 1224 with the ten members of My Style Tribe(s) 1222 whose Style DNA Map is most similar to Style DNA Map 1200.

Another benefit of the system's Style Tribe functionality is that retailers may utilize it to optimize merchandising for the primary Style Tribe(s) within their target audience. For example, a retailer may employ stylists in the task of creating looks and/or Social Shops, which various Style Tribes may then browse and/or buy. Additionally, members of Style Tribes may add the retailer's user account to My Style Tribe(s) 1222 and/or My Hot List 1224 in implementations where these lists are manually curated.

FIG. 12(a) represents a more in depth depiction of My Style Profile 1202. Identification/Basic Profile Questions 1226 is a representation of one implementation of the expanded sub-menu accessed when a user clicks on the Identification/Basic Profile 1204 hyperlink. In this implementation, Identification/Basic Profile Questions 1226 contains a series of basic questions allowing the system to collect minimal information for setting up an account so that the user may have access to the benefits of membership, for example saving items and/or looks and building the user's Style DNA Map. Identification/Basic Profile Questions 1226 represents a series of questions that may be asked in one implementation, allowing the system to capture information such as: the user's name and screen name, the user's address, for example to use in geo-targeting; the user's preferred contact method, the user's measurements, for example height, bust, waist and inseam; the user's sizes (or size ranges) in various items, for example tops, pants, dresses, skirts, jackets and shoes, the user's body shape, the user's birthday and/or age, the user's ethnicity, the user's hair color, the user's eye color, and the user's skin tone. It should be understood that these types of information are offered by way of example, and are not meant to limit the technology to only collecting those categories of identification/basic information. In one implementation, the user may enter multiple sizes for each item, one of the middle sizes being the user's usual size, but the range of sizes allowing for differences, for example the differences in size between different retailers, or lifestyle changes, such as pregnancy or other weight fluctuation. Additionally, in one implementation the system provides guidance or assistance to the user in selecting their body shape by providing figures and descriptions representing the various body types.

Basic Style Questions 1228 is a representation of one implementation of the expanded sub-menu accessed when a user clicks on the Basic Style 1206 hyperlink. The questions in this section are designed to collect basic information about the user's shopping and dressing habits and other general information about the user's lifestyle. Basic Style Questions 1228 are provided by way of example and are not meant to limit the technology to only asking those questions. In one implementation, the questions will be multiple choice questions, with the system providing a series of possible answers for the user to choose among. Additionally, in one implementation, the user is afforded the opportunity to choose a non-responsive answer, for example “I prefer not to answer,” or otherwise avoid providing information they wish to keep private. The user has privacy control on visibility of their answers. However, answered questions are accessed and weighted by the system in processing recommendations or alternately running algorithms for that user or their Style Tribe(s).

Visual Style Mapping Questions 1230 is a representation of one implementation of the expanded sub-menu accessed when a user clicks on the Visual Style Mapping 1208 hyperlink in step 1206. These questions are designed to allow the system to add more subjective data to the users' Style DNA Map 1200 and begin the learning process to provide “smart recommendations,” which combine the descriptive, contextual, and subjective relationships by assigning weighting factors to the meta data. Visual Style Mapping Questions 1230 include one or a series of pictorial multiple choice questions, the system asks a question and the user chooses their answer from a series of photographs or other images. In one implementation, the images have meta tags that are identified with each selection, which allows the system to use the answer to build the user's Style DNA Map 1200 and learn their preferences to improve style recommendations. In one implementation, Visual Style Mapping Questions 1230 allow a user to self-identify with a Style Tribe. When a user chooses a look to answer a question, they may then view the creator of the look and choose to add this individual to their Style Tribe and/or Hot List. One example of a pictorial multiple choice question is shown in Visual Style Mapping Questions 1230. The system may provide a question to the user, and provide a number of pictorial representations for the user to choose an answer, for example, Look 1232, Look 1234, and Look 1236.

Simultaneous Multivariate Grouped Items Search Queries (“group searching”) refers to the system's ability to perform searches based on filters or manual search entries, which return results as groupings of related items (“groups”), which include but are not limited to “looks” as defined and discussed throughout this document.

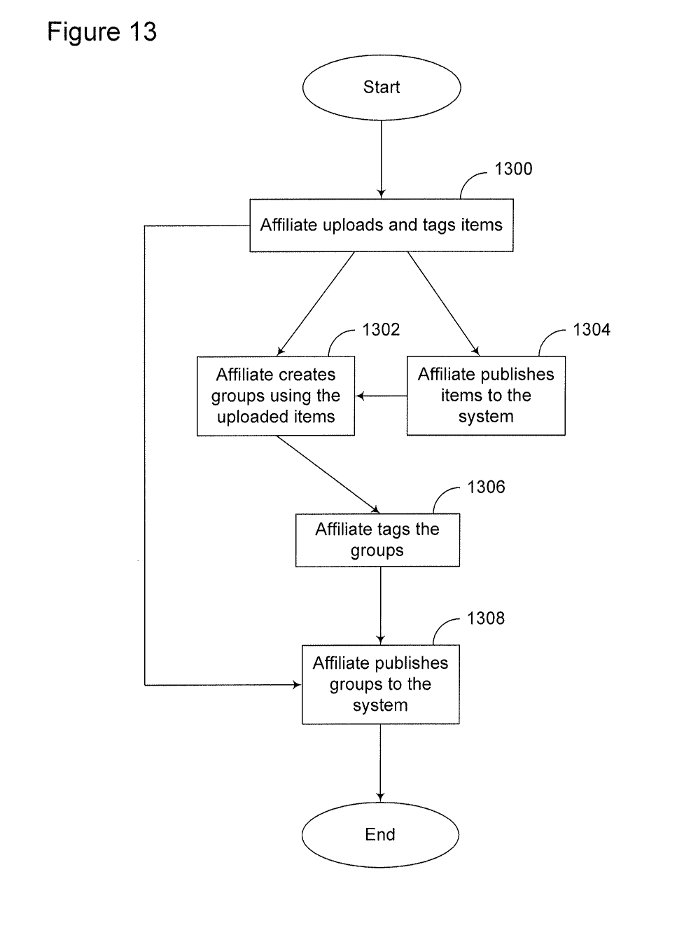

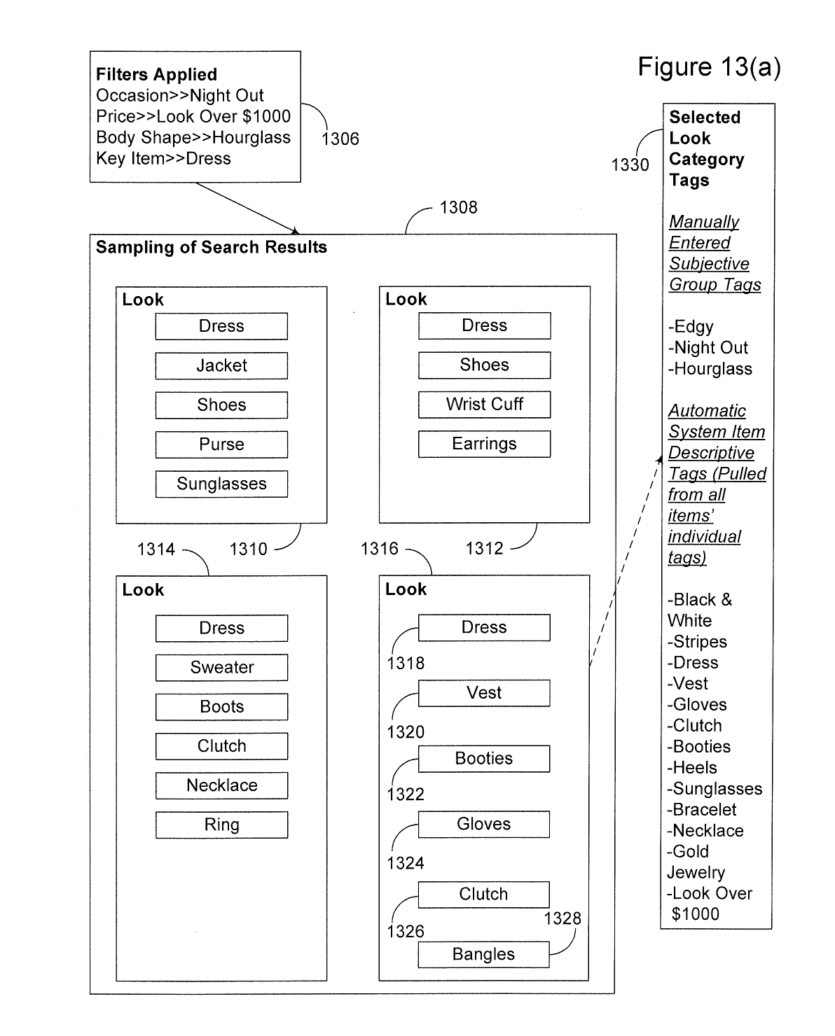

FIG. 13 represents the filters, tags and functionality associated with Group Searching on the system. Once an Affiliate uploads and tags items (step 1300) using the visual tagging tool, it may use the visual group creation tool, which may leverage standards now used on many sites, such as Polyvore.com, Kaboodle.com, ShopStyle.com, etc., to create visual groups using the uploaded items. Each Affiliate or user that creates a group/look (step 1302), creates subjective and contextual relationships (e.g., items with certain description tags belong with other items with other description tags in a group) between each of the items within the group that the system then learns as disparate items that can belong together within the context of the group creator's Style DNA. The contextual and subjective relationships are then derived from each item's descriptive tags within the context of the group creator's Style DNA (and there within Style Tribes). Next, the Affiliate may tag the groups (step 1306), applying the higher level category tags related to the collection of items as described in connection with Selected Look Category Tags 1330 of FIG. 13(a). In one implementation, the group tags apply to and describe the group as a whole, as opposed to applying to individual item(s) within the group (e.g., edgy, urban, date night). However, in the context of a Style Tribe, an item may inherit a group tag if the item appears in a threshold number of groups having that group tag. For example, an item may inherit the group tag “edgy” if it appears in 50 different groups having the group tag “edgy.” In this context, the tag “edgy” becomes a category tag layered on the item within the context of the Style Tribe. A Group may represent disparate items that when put together can create a relevant and useful set of goods and/or services. Items may represent services as well as products. Users may also create groups from the items on the system, but, in one implementation, items are uploaded by Affiliates to ensure the largest population of seasonal inventory and to provide a connection, via APIs, so that each sale is attributed to the proper Affiliate.

FIG. 13(a) represents an exemplary implementation of the System's Simultaneous Multivariate Grouped Items Search Queries, as applied to filtering groups/looks. FIGS. 13(a) and 14 reveal the tagging, or meta-data that may be attributed to items and looks on the back-end of the system, as opposed to the tagging of items on the front-end as seen in FIGS. 10 and 11. “Front end” here refers to things viewable by the user. In one implementation, these back-end tags are not visible to users, but rather drive the logic for the algorithms and logic from within the system.

In one implementation, an example of which is shown in FIG. 13, groups that match a requested search are returned as a result of a user search, applying one or multiple of the various filters offered by the system as shown in Filters Applied 1306. In another implementation, the user may manually enter search terms. The visual layout of the filters may vary from what is presented, for example the system may include sliding menu functionality, allowing the user to access sets of filters which slide horizontally across the top of the screen, maximizing the filter page area. After the user selects the search filters and initiates the search, the system returns search results comprising groups matching the search filters such as Sampling of Search Results 1308. A full set of search results may contain for example, only one or two groups, or it may contain many thousands of groups, or more. In this example, the user has applied the Filters 1300 Occasion: Night Out, Price: Look Over $1000, Body Shape: Hourglass, and Key Item: Dress. The system searches and returns, in this example, four looks 1310-1316, that match those filters. In doing so, the system searches the tags that are applied to each of looks 1310-1316 as a whole. Search results are returned based on how closely the resulting groups' Look Category and collective Item Tags match the user selected filters, while being mapped to the user's Style DNA. The system runs through the search algorithm and finds Look Category Tag matches attributed to the available looks on the system.

In one implementation, the search algorithm proceeds as follows—a user whose Style DNA has mapped the user to a Style Tribe of other users predominantly matching the first user's Style Profile, for example because they share matching body type, geographic location, hair color, eye color, skin tone, are of similar height, or share other profile answers, may perform a Group Search by selecting an item to view looks incorporating the item. In one implementation, the user choosing “View All Looks With This Item,” prompts the system to search the database and deliver results showing looks that include the selected item. “First level ranked results” may include looks which include the selected item and also include items made by designers whose items the user has purchased or saved and that also overlap with top items purchased or saved by the user's Style Tribe. “Second level ranked results” may include looks that include a majority of items that have been purchased or saved by the user's Style Tribe members. “Third level ranked results” may include looks that include items from Affiliate Retailers that the user has identified as among the user's favorite retailers in the user's Style Profile, even if the user has not purchased or saved that retailer's items on the system. In one implementation this level of results may also include looks that include items from similar Affiliates or retailers to the user's favorites, for example, Affiliates or retailers with similar company profiles. In one implementation, the system would show resulting looks which include the selected item with relevant rankings of other item combinations before showing the looks which include items that fall outside the user's identified Style DNA. After the looks that fall outside the user's Style DNA, there may also be results showing looks using a similar primary selected item and associated looks. Results may be browsed through and further filtered. Alternately, the user may navigate to another point on the results display bar to view more middle or end tier matching looks to view looks which are more loosely matched than the top tier results.

The resulting groups are matched via their universal tagging schema which defines each group from its subjective, user-defined look categories as well as its automatically populated item descriptive tags (e.g., item dimensions, sizes, price, or any data that is dynamically pulled from the Affiliate's product web page as linked within the item upload and tagging process), sub-categories and granular details in material, construction & finish that match a requested search. Thus, the groups are tagged as seen in the example tags related to Look 1316, shown in Selected Look Category Tags 1330. Some of the tags are “Manually Entered Group Tags,” applied to the group by the user who created the group based on that user's subjective vision of what style or trend the look represents. These tags are applied on the front-end of the system and in one implementation, are visible to the user. Other tags are “Automatic System Item Tags,” a collection of the descriptive tags attributed to the various individual items within the group which are added to the group by the system. In one implementation, these tags are applied on the back-end of the system, and the user does not see them. In this example, the items Dress 1318, Vest 1320, Booties 1322, Gloves 1324, Clutch 1326, and Bangles 1328 have the individual item tags black and white, stripes, dress, vest, gloves, clutch, booties, heels, sunglasses, bracelet, necklace, gold jewelry, and look over $1,000 applied to them, but now have also inherited the group tags of being “Edgy, Night Out, and Hourglass” via association with this Group's category tags within the context of the related Style Tribe(s).

This universal tagging process allows groups' and items' tags to be mapped or weighted against those of other groups and items. The System leverages this ability in order to deliver the closest matching results, displaying the Sampling of Search Results 1308 in descending order of relevancy. Additionally, as the system “learns” what item tags are frequently matched together in groups, the system may automatically generate groups to match search filter queries and pre-populate Style Tribes with group recommendations for remixing. It should be understood that the Look Category Tags and Item Tags shown in FIGS. 13(a) and 14 represent examples of possible Look Category Tags and Item Tags, but are not meant to be limited to the various tags depicted.

When viewing a group the user may also be permitted to “lock in” certain items within that group so that they will not be removed during the remixing process, and then activate the remix system function by first applying the remix parameters, in one implementation, in a pulldown menu. The remix parameters can vary from, “New Looks from Items,” to “Shop MyCloset,” “Shop My Tribe,” “Shop My Friends,” “Shop the Trends,” “Surprise Me,” or any other number of options decided upon by the system owner. “Remixing” is the dynamic modification and/or generation of a look or looks by the system in response to the user changing filters or applying additional filters as described below in relation to FIG. 14, or in response to the user “locking in” items to build new look(s) from their selected options available with the Remix pulldown menu as described below in relation to FIGS. 17(c)-(e). These are two exemplary methods of remixing using the system, but remixing may encompass any other suitable method of using the tags to identify and dynamically swap out alternate options based on matching of filters, process options, the user's Style DNA, and/or other variables. A remix match does not have to be a 100% tag for tag mirror of the original item; it may only match the new selected variable and perhaps only 90% or less of the other tags, in one instance. (See FIGS. 14 1402-1404, and 1412-1410) However, in one implementation, the highest match may represent the initial item(s) shown, with later item(s) shown in descending order of matching tags. When a user performs a remix, the system searches through the database for the item with the closest possible set of item tags to the original items' tags with the new filter applied.

In this scenario, the locked in items of the look remain, while the rest of the items in the group are “swapped out,” replaced with new items based on the tags of the previous items and the overall tagging of the group. The universal tagging of the group and items within the group allows the system to find the closest possible matches to the swapped out items based on the selected filters and the user's Style DNA, and thus, to simultaneously swap out multiple items within a look. Additionally, users also have the option to browse search results containing groups that match the new selected filters. Users may also modify looks created by affiliates or other users via search filters, the remix function, or manually editing and creating new looks of their own. This ability to create “user modified content” from pre-existing system groups rather than manually creating “user generated content” from scratch, as required by conventional shopping websites, is an improvement over conventional systems to be realized by one implementation of the present system. User ability to modify pre-existing content results in time savings and also gives users the ability to engage with high fashion looks such as those seen in fashion magazines and on fashion show runways, and remixing them to fit the user's budget, body type, or any other subjective or objective criteria.

FIG. 14 represents an exemplary implementation of the system's remix function, which allows rearranging of groups returned as a result of group searching. Selected Look 1400 may be chosen from the search results in FIG. 13(a), Sampling of Search Results 1308, or returned as a result of some other system activity. Selected Look Category Tags 1402 are the Look Category Tags associated with Selected Look 1400, with the manually-entered group tags from the look creator shown above the dotted line, and the automatically-generated system item tags below the dotted line. Item Tags: Shoes 1404 is a representation of the Item Tags associated with Booties A, the shoes in the Selected Look 1400. In order to remix Selected Look 1400, the user may lock in any items they wish, or no items, and then change the filters (or use the remix pulldown menu), upon which the System will remix the look to match New Filters Applied 1406, resulting in Remixed Look 1408. In the example of FIG. 14, the user modified the Price Filter from “Look Over $1000” to “Look under $300.” This change automatically triggered the system to search the database, checking the tags of the closest possible matches on the system with the new filter/variables based on New Filters Applied 1406, which returned Remixed Look 1408, containing the closest matching new item to the tags of the original item and weighing those results against the user's Style DNA. Once the look is remixed to meet the new criteria, the user may click on “BACK to Browse Looks” to browse through the looks that match the new filter criteria. Selected Look Category Tags 1410 are the Look Category Tags associated with Remixed Look 1408, with the manually-entered subjective group tags from the look creator shown above the dotted line, and the automatically-generated system descriptive item tags below the dotted line. Item Tags: Shoes 1412 is a representation of the Item Tags associated with Heels B, the shoes in the Remixed Look 1408. These tags are not indicative of all comprehensive tagging possibilities on the system. Because the user chose Selected Look 1400 from the search results, they were in a “single look view,” and the System dynamically swapped out items within Selected Look 1400 that were not locked in to create Remixed Look 1408 that matches New Filters Applied 1406. In one implementation, if the user had locked in items totaling more than $300 so that the system could not create Remixed Look 1408 to match New Filters Applied 1406, the system would instead display a message stating, for example, “The locked in items exceed the selected Price. Please unlock some items or choose a different Price filter.” The process just described is one exemplary way that a user may remix a look. Other remixing methods and systems are described in connection with FIG. 15 and FIG. 17(c)-(e), but may be configured in any number of alternate implementations decided upon by the system owner.

In another implementation, the application of New Filters Applied 1406 to a Sampling of Search Results, or “multi-look view,” such as Sampling of Search Results 1308, may result in the system returning multiple new and/or remixed looks for the user to browse.

Overall, the system processes of Group Searching and Remixing deliver results as groups of related items, providing increased ease of use, efficiency, time savings and value added socially-influenced relevance to the user. Additionally, affiliates and other retailers may sell more products by tapping into invisible markets and leveraging the potential for peer-to-peer incentivized social commerce. The user may discover system looks which include items from high-end designers, and then remix those looks to meet their own personal needs, perhaps, for example, at a lower price point, different body type, or color palette. The system makes it possible for a user to transform a look they like, but cannot buy and wear for any reason, for example price point, colors or fit of the items, and remix that look to something that matches their needs.

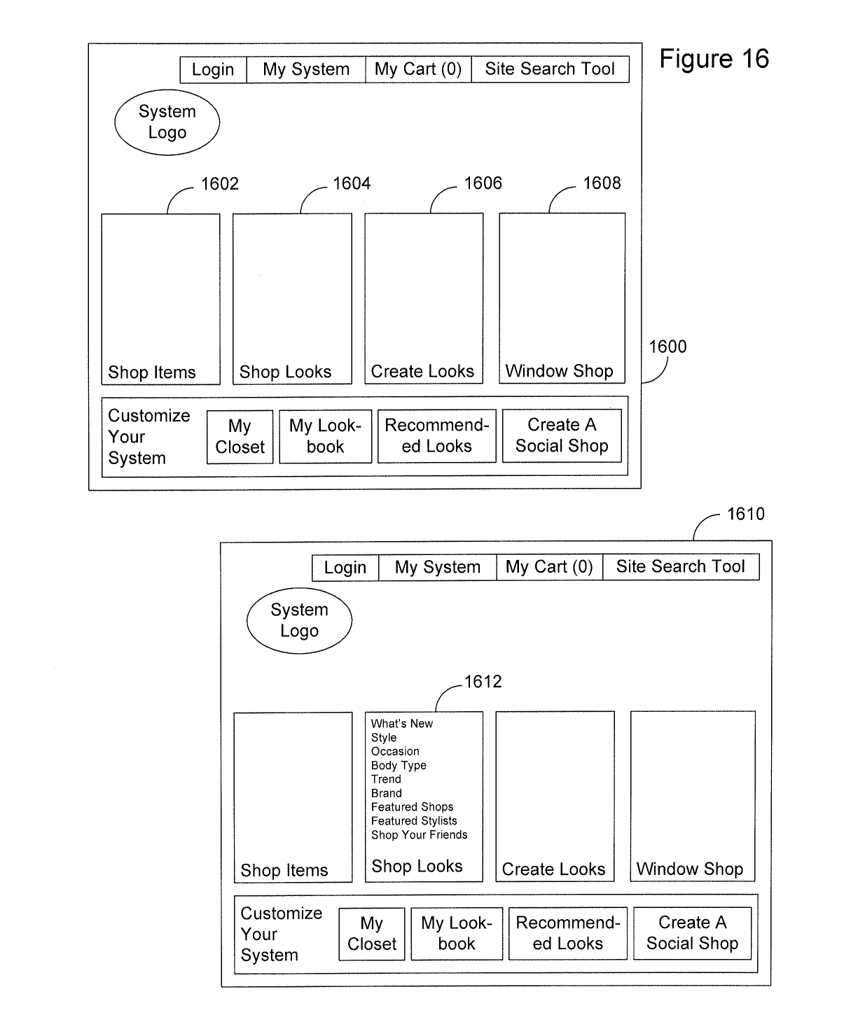

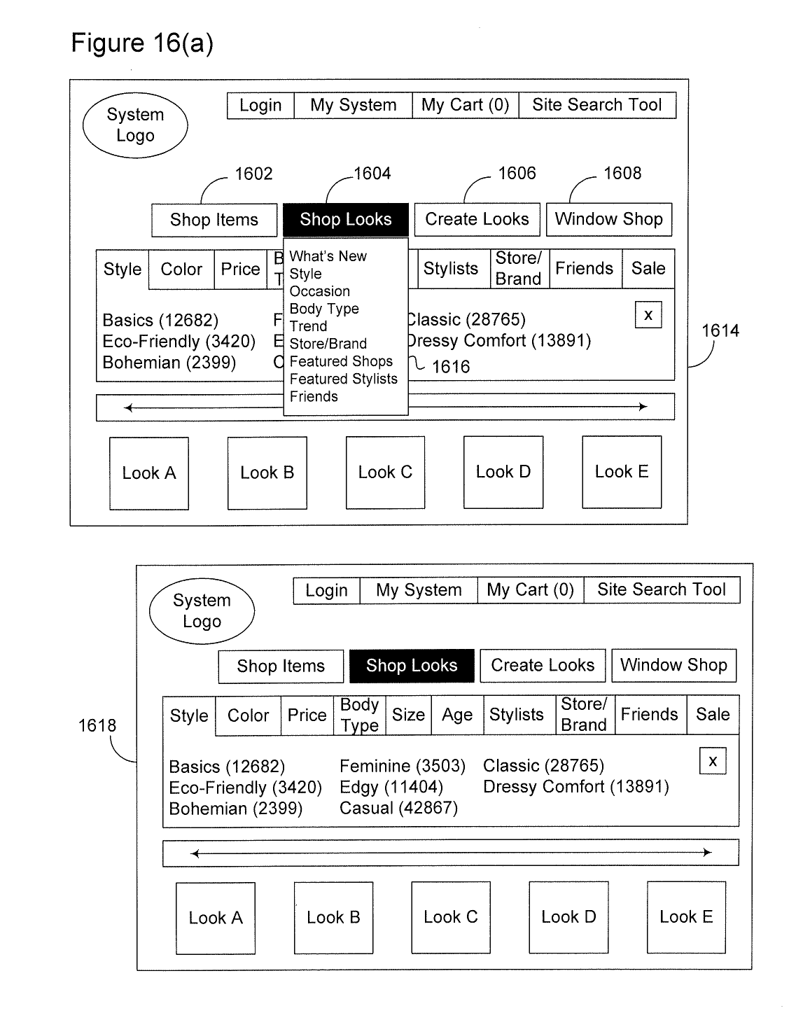

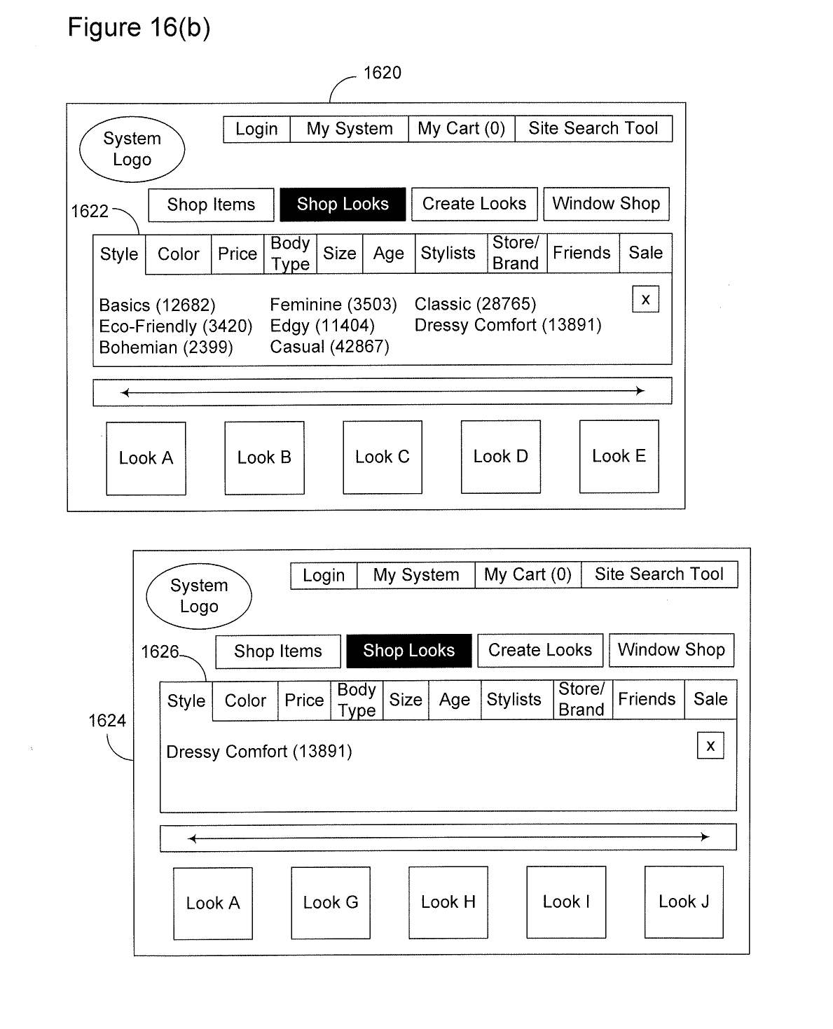

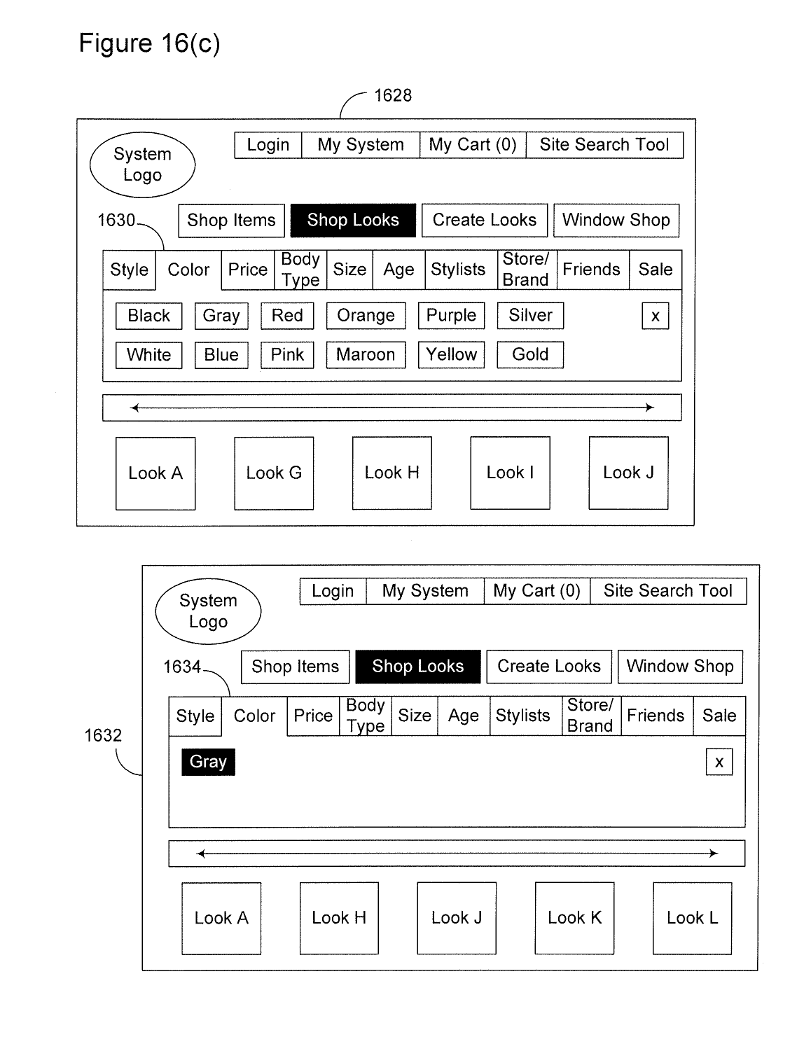

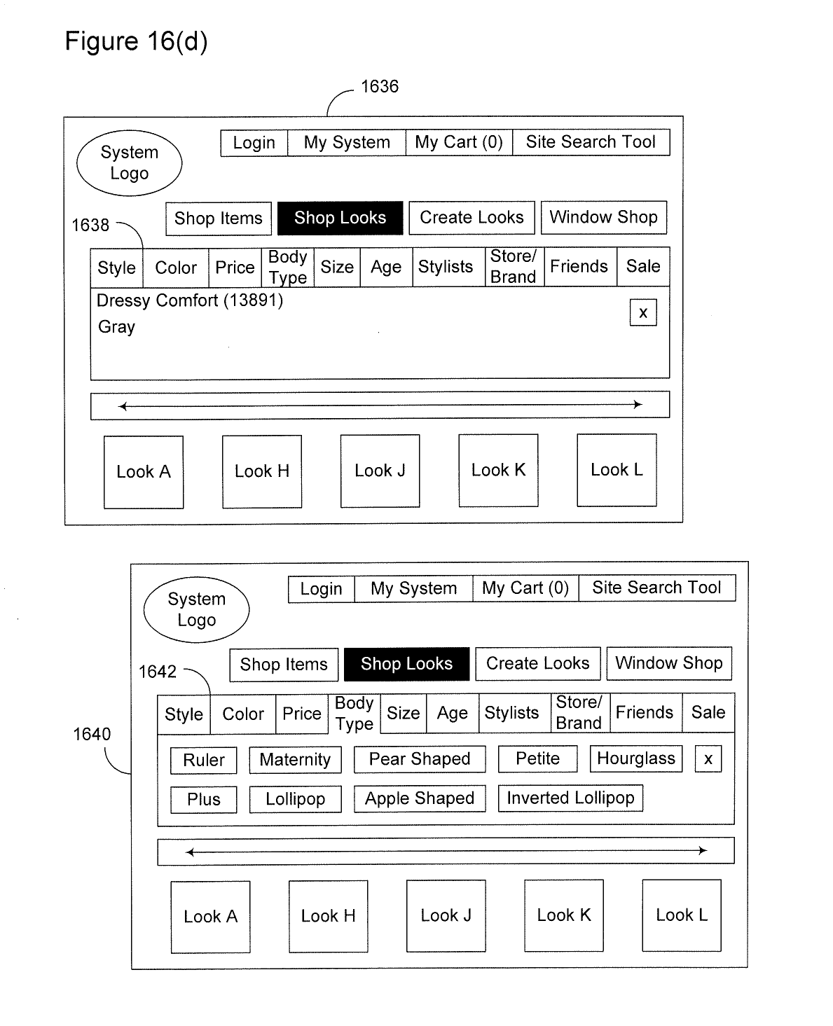

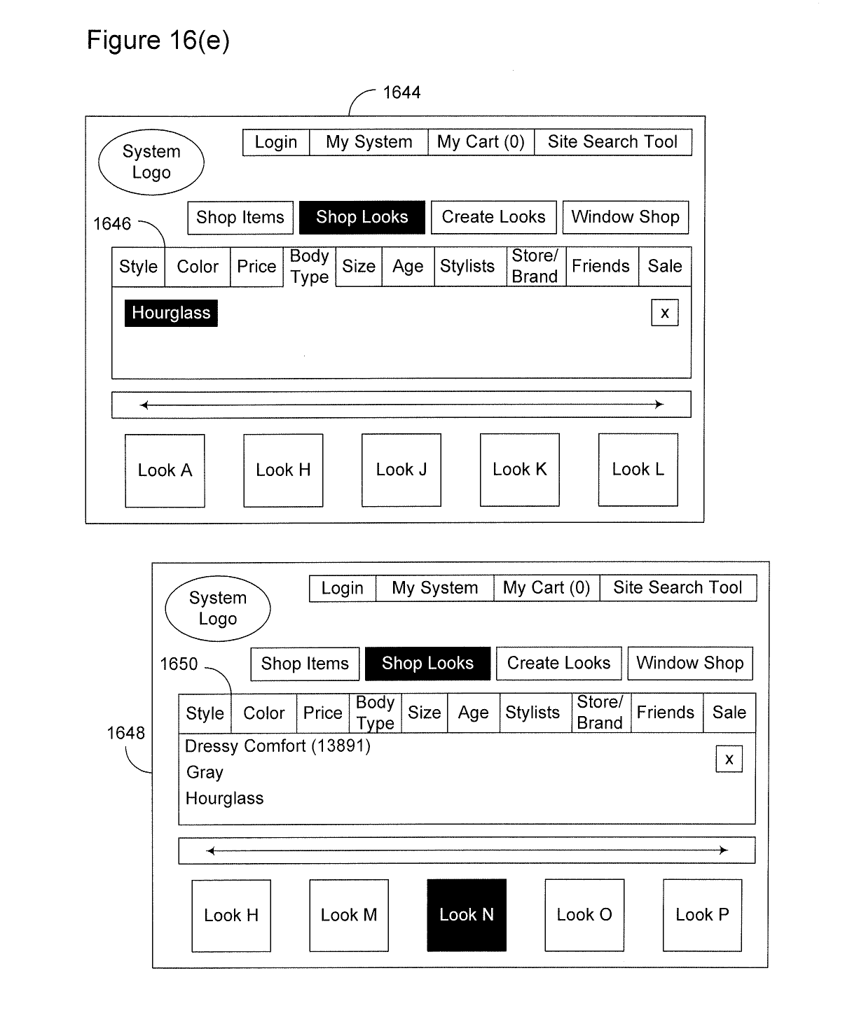

FIG. 15 shows a flow chart outlining the steps of one implementation of the system's Simultaneous Multivariate Grouped Items Search (Group Searching) and Remixing process as performed on the front-end of the system. The system presents the “Shop Looks” page view in response to the user selecting “Shop Looks” from the four choices offered on the homepage (step 1500) as shown in FIG. 16: Shop Items 1602, Shop Looks 1604, Create Looks 1606, and Window Shop 1608. The user then selects an initial Shop Looks Group Search filter, either directly from the homepage scrolling over one of the four top level options (or however many are decided upon by the system owner) displayed in FIG. 16—“Shop Items,” “Shop Looks,” “Create Looks,” or “Window Shop;” or from the top-level suggested options displayed in the Drop Down Menus 1614 of FIG. 16 and subsequently filtering the looks.

In one implementation, the user may click through to the Browse Looks top level page, which displays all the looks on the system. In other implementations, the user may apply a filter from the system homepage. In either case, the system receives the query to deliver looks results within the browse template. Next, the user may select a primary filter for group searching from among the top level filters offered by the System to begin refining their search results (step 1502), for example as shown in FIG. 16(b). This initial filtering triggers the system to run the process on the system back-end which returns results based on the matches between the category tags for looks or groups and the item tags for items and the selected filter options. If the user is signed in, then the system may also weigh their Style DNA into the results.

Next, the user may browse the results (step 1504), which results are the newly refined selection of looks presented on the browsing page based on application of the primary filter to the system looks and the system performing the process to match look tags to the primary filter applied. An example of this may also be seen in FIG. 16(b).

The next step in the Group Searching and Remixing process is to apply additional filters (step 1506). This step is performed when the user decides to further refine the group search results returned by applying additional filter(s), for example as shown in FIG. 16(c)-(e). The further filtering of the results via group search filtering re-runs the back-end process which returned the initial results, once again matching the various look tags to the filters applied. In one implementation, the number of results displayed decreases as further filters are applied because the number of looks matching the full set of filters diminishes from the initial set of looks viewed.

In one implementation, the user may apply additional filters as many times as they wish. The next step is for the user to select a look and go to the Look Main Page (step 1508). In one implementation, there may be a preview functionality layered on the browse results, allowing the user to briefly view look details, for example by scrolling over the look thumbnail, before clicking to view the Look Main Page, thereby navigating away from the browse view and to the look main page, for example as shown in FIG. 17.

Once the user selects a look and goes to the Look Main Page, they may modify, add, or remove filters (step 1510). This may prompt the system to re-run the algorithm and remix the look within the current look main page. Additionally, in one implementation the user may click Back to Browse Looks 1706 as shown in FIG. 17 and then browse the new set of looks that correspond to the new set of filters.

After selecting a look and going to the Look Main Page, the user may also perform a remix with the remix pulldown menu and button (step 1512), as described in relation to FIG. 14 and FIGS. 17(c)-(e). In response, the system runs the back-end process again, dynamically remixing the featured look to correspond with the new filters. The system's front-end display matches the new items in overall size, positioning, and layer, such as foreground or background, to simultaneously display the new items within the large look visual, corresponding as closely as possible to the previous visual layout. Additionally, any related thumbnails, pricing, logos or other item indicia are swapped out, as is the look total price. These processes may happen dynamically as the result of application of a new filter or remixing.

After adjusting the applied filters and/or remixing looks, the user may add item(s) or the look to the universal shopping cart (step 1514), either by clicking each individual item and selecting the appropriate item criteria, such as size and color, as described in relation to FIG. 17(g), or by selecting the check boxes corresponding to the item view for each item they wish to purchase, as shown in FIG. 17(c), and then clicking Add Selected Items to Cart 1724 of FIG. 17, where they can select their options (size, color, quantity, etc.) for each item within the Cart. In the former option, one implementation may allow the user to view item criteria within one scrolling page for quicker criteria selection before the user adds the look to their universal shopping cart within the system front-end functionality. In one implementation the system simultaneously communicates with each of the retailers or affiliates listing one of the items to be purchased via the APIs to ensure item details, for example availability of inventory and pricing. With regard to the latter option, in one implementation the system then prompts the user to select the various item criteria within the universal shopping cart front-end checkout process.

Finally, after adding item(s) and/or look(s) to their universal shopping cart, the user may checkout (step 1516). The user must enter their final front-end universal shopping cart requirements, for example shipping method and payment method. Throughout checkout, the retailers and/or affiliates listing items being purchased may constantly stream data to the system, ensuring that the order is being processed and that the retailer or affiliate can fulfill said order. Once the complete order is processed, the APIs continue the live data exchange between the system and the aforementioned retailers and affiliates for processing and fulfillment of the user's complete order.

FIG. 16 represents one implementation of an exemplary Homepage 1600 in which said homepage is simplified into four main options: Shop Items 1602, Shop Looks 1604, Create Looks 1606, and Window Shop 1608. These four options represent exemplary tasks available on the system. Shop Items 1602 allows a user to find a specific item by browsing, searching, or any other system means, and then utilize the system to manipulate the item, for example to buy the item, add it to their My Closet, or build looks around it. Shop Looks 1604 allows a user to browse the existing looks on the system or apply filters to refine the looks and streamline browsing. Create Looks 1606 allows a user to build their own looks from the various system items. Window Shop 1608 allows users to browse for example ideas, trends, licensed brand shops, featured Lookbooks, and featured Social Shops. Window Shop 1608 allows a user to engage in more general browsing of the various system tools and various browsing categories/methods, before proceeding further. When the user selects one of these four main options by scrolling their cursor over the desired selection, the screen view may change as shown by Page View 1610. In this example, the user has scrolled over Shop Looks 1604, and one implementation of the sub-menu is shown in Shop Looks 1612. The choices shown in this implementation of the sub-menu are offered by way of example. It should be understood that more, fewer, and/or different sub-menu options may be offered in other implementations.

FIG. 16(a) represents a demonstration of one implementation of the continuation of system use. Page View 1614 shows the Sub-Navigation Menu 1616 that drops down when the user mouses over Shop Looks 1604. It should be understood that in one implementation, sub-navigation filter menus are also attached to Shop Items 1602, Create Looks 1606, and Window Shop 1608. These sub-navigation filter menus may have the same or different options as Sub-Navigation Menu 1616, which is merely an example and is not intended to limit it or other sub-navigation filter menus to the options presented therein. Sub-Navigation Filter Menu 1616 and other sub-navigation filter menus allow the user to navigate to many other areas of the website, regardless of where in the website their browsing session has led them at that moment. Page View 1618 shows an example of the system website view resulting from the user mousing over. Shop Looks 1604 and selecting “Style” from Sub-Navigation Filter Menu 1616.

FIG. 16(b) represents an exemplary web page of one implementation of the continuation of system use. Page View 1620 shows the Sub-Navigation Menu 1622 which drops down when a user selects “Style” from the Sub-Navigation menu 1616 of FIG. 16(a). Sub-Navigation Menu 1622 contains a series of links corresponding to the various style tags applied to looks on the system, each of which gives the number of looks corresponding to that tag in the parenthetical. Page View 1624 shows a representation of the page view that occurs when a user selects the “Dressy Comfort” style tag from the Sub-Navigation Menu 1622. Sub-Navigation Menu 1626 shows the selected style tag, and the system automatically filters the displayed looks in Page View 1620, returning only looks in Page View 1624 that match the selected style tag, which may be weighted against the user's Style DNA. It should be noted that some or all of the looks shown in Page View 1620 may remain in Page View 1624, or the looks in Page View 1624 may be entirely different from those in Page View 1620.

FIG. 16(c) represents an exemplary webpage of one implementation of the continuation of system use. Page View 1628 shows the Sub-Navigation Filter Menu 1630 which drops down when a user selects “Color” from the Sub-Navigation Filter menu 1622 of FIG. 16(b). Sub-Navigation Filter Menu 1630 contains a series of links corresponding to the various color tags applied to looks on the system. Page View 1632 shows a representation of the page view that occurs when a user selects the “Gray” color tag from the Sub-Navigation Filter Menu 1630. Sub-Navigation Filter Menu 1634 shows only the selected color link, and the system automatically filters the displayed looks to match the selected color link. It should be noted that some or all of the looks shown in Page View 1628 may remain in Page View 1632, or the looks in Page View 1632 may be entirely different from those in Page View 1628. In one implementation, the looks shown in Page View 1632 are arranged from left to right, in descending order of the number of gray items in each look, so that the looks containing the highest number of gray items are to the far left of the screen and appear in Page View 1632 first. The user may then scroll right, in this implementation, in Page View 1632 to browse looks with decreasing numbers of gray items.

FIG. 16(d) represents an exemplary web page of one implementation of the continuation of System use. Page View 1636 shows the Sub-Navigation Filter Menu 1638 which appears after the user selects the “Gray” color filter from the Sub-Navigation Filter Menu 1630 of FIG. 16(c). Sub-Navigation Filter Menu 1638 shows a series of links corresponding to the various filters the user has already applied to pare down the number of looks returned in this session. Page View 1640 shows a representation of the page view that occurs when a user selects the “Body Type” filter tag from the Sub-Navigation Menu 1642. Sub-Navigation Filter Menu 1642 shows examples of possible various body type filters the user may apply. It should be noted that the list of body type filters shown in Sub-Navigation Filter Menu 1642 is provided by way of example and is not intended to be limited to those body type filter choices shown.

FIG. 16(e) represents an exemplary web page of one implementation of the continuation of System use. Page View 1644 shows the Sub-Navigation Filter Menu 1646 as it appears after a user selects “Hourglass” from the Sub-Navigation Filter Menu 1642 of FIG. 16(d). Page View 1648 includes Sub-Navigation Menu 1650, which shows a series of links corresponding to the various filters the user has already applied to pare down the number of looks browsed in this session. It should be noted that some or all of the looks shown in Page View 1644 may remain in Page View 1648, or the looks in Page View 1648 may be entirely different from those in Page View 1644. Also in Page View 1648, the “Look N” is shaded, or highlighted in some manner, to denote that the user has moused over and clicked on this look in order to inspect it individually in a “look main page.”

FIG. 17 represents an exemplary web page of one implementation of the continuation of System use following on from FIG. 16. Page View 1700 represents one implementation of the look main page that appears when a user selects a look for individual inspection. Sub-Navigation menu 1702 shows a series of links corresponding to the various filters the user has applied to pare down the number of looks to match their specific criteria for this session. Look Main Page Options 1704 contains a series of options available to the user in relation to the selected look. In one implementation, the “Look Main” option is the default menu option which shows in conjunction with the look main page. In one implementation, “Look Main” provides the user with the sub-options of “Save Look,” which allows the user to save the look to their own system account, “Save Item(s),” which allows the user to save any of the individual items within the look to their system account, “Manually Remix,” which allows the user to manually swap out any of the individual item(s) within the look in view, “Add to Wish list,” which allows the user to add the look or any of the individual items within the look to their system wish list, and “Share,” which allows the user to share the look via any of their system, social networking and/or media accounts which are interfaced with the system. In one implementation, Look Main Page Options 1704 may contain other menu options including: “More Look Views,” which allows the user to view alternate images of the Look provided by the Look creator, for example images of the look being worn by models with different body types; “More Item Views,” which allows the user to browse multiple views of the look and/or the items within it, for example views of the items from multiple angles or close up views of the items to show details; “User Photos,” which allows the user to browse photos of the look uploaded by any system user wearing items from the look, providing an opportunity for the user to easily find other users to add to their Style Tribe; “Comments/Ratings,” which allows a user to view system users' comments and ratings for the overall look and/or the individual items within the look, which for example may include ratings for overall quality, value, materials, details, or any other objective or subjective criteria; “Look Created By,” which allows the user to view information about the user who created the look being viewed, which provides a further opportunity for the browsing user to find others to add to their Style Tribe; and “Shops Containing This Look,” which allows the user to view the Affiliate Shops and Social Shops which contain the look being viewed. Back to Browse Looks 1706 allows the user to quickly navigate back to the browse view of the looks matching their filter criteria, as shown in Page View 1648 of FIG. 16(e).

Look View 1708 shows images of the items comprising the selected look. Finally, Page View 1700 contains a “thumbnail” Item View and corresponding information for each item contained in Look View 1708. In the implementation denoted in FIG. 17, Details and Price 1710 is accompanied by Item View 1712, which in one implementation shows a thumbnail image of an item from the selected look, Retailer Logo 1714, and Checkbox 1716, or other item selection indicator, which in one implementation may be clicked on and thereby lock in the corresponding item so it will not be swapped out if the look is remixed, or may be clicked to select the item to be moved into the user's universal shopping cart. Select Remix Options 1718 is a drop-down menu containing the various remixing options. Clicking Remix 1720 causes the system to perform whatever option is selected in the Select Remix Options 1718 menu with whatever items are locked in, or in another instance, not locked in. Look Total Price 1722 shows the total price of the items contained in the selected look. Add Selected Items to Cart 1724 allows the user to move items for which they have marked the corresponding checkbox into their universal shopping cart.

FIG. 17(a) represents an exemplary web page of one implementation of the continuation of System use following on from FIG. 16. Page View 1726 represents one implementation of the look main page as it appears when the user clicks on the price tab from Sub-Navigation Filter Menu 1702. Sub-Navigation Filter Menu 1728 contains filters allowing the user to dictate the price of individual items within the look, or the total price of the look itself. Using these filters, the user is able to adjust Look Price 1730, which in turn dynamically modifies the look, replacing the items that exceed, or fall outside of the newly selected parameters.

FIG. 17(b) represents an exemplary web page of one implementation of the continuation of system use following on from FIG. 16. Page View 1732 represents one implementation of the look main page as it appears after the user selects “Looks Under $300” from Sub-Navigation Filter Menu 1728 of FIG. 17(a) and then the system modifies, or remixes the look. Sub-Navigation Filter Menu 1734 contains the filters which apply to the look highlighted in this look main page and shown in Look View 1736. In one implementation, Look Price 1738 will now be less than $300, to match the price filter applied. Additionally, Item View 1740, 1742, 1744 or 1746 may be changed from the corresponding items viewed in Page View 1726, and may now represent lower priced items, which are swapped in during the remixing process in order to match the newly applied price filter, as well as the previous item filters, tags, and the user's Style DNA. In one implementation, if locked in items aggregate to a price higher than the price filter chosen, the system will not swap out those items, but instead highlight them and display a message, for example indicating that their price exceeds the chosen price filter.

FIG. 17(c) represents an exemplary web page of one implementation of the continuation of System use following on from FIG. 16. Page View 1748 represents the first step in another way that exemplary embodiments allow a user to remix a look. The user has locked in Item View 1750 and Item View 1752. In the implementation represented here, this is done by clicking on the check box that corresponds to the desired item under the Select Item 1754 column. Item View 1756 and Item View 1758 are not locked in. Additionally, the user has highlighted New Looks from Item(s) 1660, one of the choices offered in Select Remix Options 1718. When the user then clicks on Remix 1720, a search process is activated, applying, in one implementation, the selected filters and new remix criteria, along with the user's Style DNA, which yields a search results page displaying new looks which match the filters, remix criteria, look and item tags and relevance to the user's Style DNA. Remix pulldown options can be run with or without any filters being applied, for example, if the user arrived at a look page via a manual, text-based search.

FIG. 17(d) represents an exemplary web page of one implementation of the continuation of system use following on from FIG. 16. Page View 1762 represents the looks browsing page which the user is directed to, delivering the results, after remixing as described in connection with FIG. 17(c) above. In one implementation, Item 1750 and Item 1752, which were locked in by the user prior to remixing as described in connection with FIG. 17(c), are components of each look in Page View 1762. In other implementations, the looks in Page View 1762 may not contain the exact items locked in prior to remixing, but may instead contain similar items with similar tags as the locked in items.

FIG. 17(e) represents an exemplary web page of one implementation of the continuation of System use following on from FIG. 16. Page View 1764 represents the look main page that would result from the user clicking on one of the looks displayed in Page View 1762 of FIG. 17(d). In this look main page, Sub-Navigation Menu 1766 displays the filters previously applied in this look shopping session. Look View 1768 contains the items in this look, including the items which were locked in prior to remixing. Item View 1750 and Item View 1752 represent those items which were locked in prior to remixing, and in one implementation, they remain locked in until the user manually “de-selects” them by clicking their associated checkboxes. Item View 1770 and Item View 1772 represent the items which were substituted into the look by the system during the remixing process. In one implementation, Look Price 1774 should be less than $300, to match the filter applied during remixing.

For example, if a user finds a look they are interested in comprising 5 items—a top, pants, boots, a cuff, and earrings, the user may decide to “lock in” 3 of the items, for example the top, pants and cuff. Then, the user may select “New Looks From Items” in Select Remix Options 1718 and click Remix 1720 to activate a remix search. In one implementation, the system may generate new groups using the 3 items the user “locked in.” In first level ranked results, the two swapped out items in the original group may be replaced by items from designers the user has previously purchased from, saved to My Closet or My Lookbook, or that match the other defined style choices within the user's Style Profile, such as style, average amount spent on a look, preferred fit, or any other Style Profile selection, which comprise the first level influencers. In second level ranked results, the two swapped out items in the original group may be replaced by items from Affiliates with similar company profiles to Affiliates the user has previously purchased or saved items from and that match the user's Style Profile on a determined number of variables, for example a majority. These items may also include items from Affiliates, retailers, or brands that the user's Style Tribe regularly purchases. In one implementation the resulting groups may be arranged in descending order beginning with top ranked variable matches, so that the user may view lesser matching results by scrolling from the first page of results to the last.

The displayed results of dynamically generated groups, in one implementation, may rank as follows: 1) Style Profile matches, 2) User purchases and saved items history, 3) Style Tribe matches based on users with the most common Style Profile traits and purchased or saved Affiliates or brands to the primary user, 4) Items that are similar in descriptive item tags to items that the primary user has purchased or saved, items from Affiliates or brands that the primary user has purchased or saved from, and/or items similar to those Affiliates or brands. Further variables may be considered until variables are exhausted to the least relevant proximity. In one implementation, these primary ranked, weighted influencers can be overridden by the user applying filters and/or a remix option that precludes certain variables. For example, the user may apply the filter “items under $50,” which may make it impossible for a group to be generated from the user's favorite Affiliates and retailers and/or from the Affiliates and/or retailers of the user's purchased or saved items because these Affiliates and retailers do not offer any items for less than $50. In that instance, the remaining highest ranked variables may be weighted, but the system may retrieve items from Affiliates that meet the other criteria as well as offering items at or below the selected price point variable. These alternate Affiliates or retailers may be selected from a user in the primary user's Style Tribe who also has Affiliates or retailers within their profile and/or has purchased or saved items whose price point meets the price criteria.

FIG. 17(f) represents an exemplary web page of one implementation of the continuation of system use following on from FIG. 16. Page View 1778 represents the page view that would appear in one implementation if the user clicked on the “User Photos” link in Sub-Navigation Menu 1776 of FIG. 17(e). In one implementation, the resulting Page View 1778 includes User Look Photograph 1780, a photograph associated with the current look, uploaded to the system by the user. For example, the user may upload a photograph of themselves (or a model) wearing the look. User Avatar and Name 1782 are the system avatar and user name of the user responsible for uploading User Look Photograph 1780. User Comments on Photograph 1784 includes any comments the uploading user wishes to make about User Look Photograph 1780. In one implementation, the uploading user may leave User Comments on Photograph 1784 blank. Additionally, in one implementation, Page View 1778 includes multiple options for the browsing user to interact with the uploading user. Some examples of these options are shown, including View my Comments/Ratings 1786 (for the items I own and/or am wearing within the photo), Send me a Private Message 1788, Add Me to Your Style Tribe 1790, and View My Social Shops 1792. It should be understood that these options are shown in FIG. 17(f) by way of example and are not meant to limit the technology to these options. Finally, if the user selects Back to Browse Looks 1706, the system navigates back to Page View 1762 of FIG. 17(d).

FIG. 17(g) represents an exemplary web page of one implementation of the continuation of system use following on from FIG. 16. Page View 1794 represents the page view that appears in one implementation if the user clicks on the icon or Item View for an individual item in a look main page. Look View 1796 remains the same as in the look main page. Clicking on the item icon or Item View creates a Layered Panel 1798, or modal, within the same browser window, wherein the user can view various product details, for example the listing retailer, the item name, and the item price. In one implementation, the user may also view various photographs of the item such as Main Item View 1799 and Alternate Item Views 1797 and 1795. Additional alternate item views may be viewed by scrolling through the alternate item views using Click Arrow 1793 and Click Arrow 1791. Additionally, one implementation of Layered Panel 1798, or modal, affords the user many options for manipulating the item within the system, for example saving the item to their profile, adding the item to their wish list, sharing the item via social networks and/or media and/or email, viewing larger item photographs, building a look from the item, viewing more looks containing the item, or viewing more item details. Additionally, in one implementation, Layered Panel 1798, or modal, allows the user the option to select a size and/or color for the item viewed and put that size and color item into their universal shopping cart by clicking Add to Cart 1789. In one implementation, when a user clicks on Size Dropdown Menu 1787 to select the item size, the system will display a size chart which the user may use to accurately assess the appropriate size they wish to work with. Finally, the user may close Layered Panel 1798, or modal, by clicking the “X” in the upper right corner or some other indicator to close the modal. The Layered Panel is not limited to the example of functionality given, but rather, this serves as one implementation.

FIG. 17(h) represents an exemplary web page of one implementation of the continuation of System use following on from FIG. 16. Page View 1785 represents the page view that appears in one implementation if the user clicks on the X to close Layered Panel 1798 of FIG. 17(g). Closing Layered Panel 1798, or modal, returns the user to the look main page they were viewing in FIG. 17(f). In one implementation, Item View 1783, which corresponds to the item added to the universal shopping cart in FIG. 17(g), now indicates the size and color of this item the user has moved into their universal shopping cart. In one implementation, Item View 1783 could also indicate that the item was in the user's universal shopping cart, for example by displaying an icon that read “In Cart.” Additionally, My Cart 1781 at the top of the page now indicates that there is one item in the universal shopping cart.

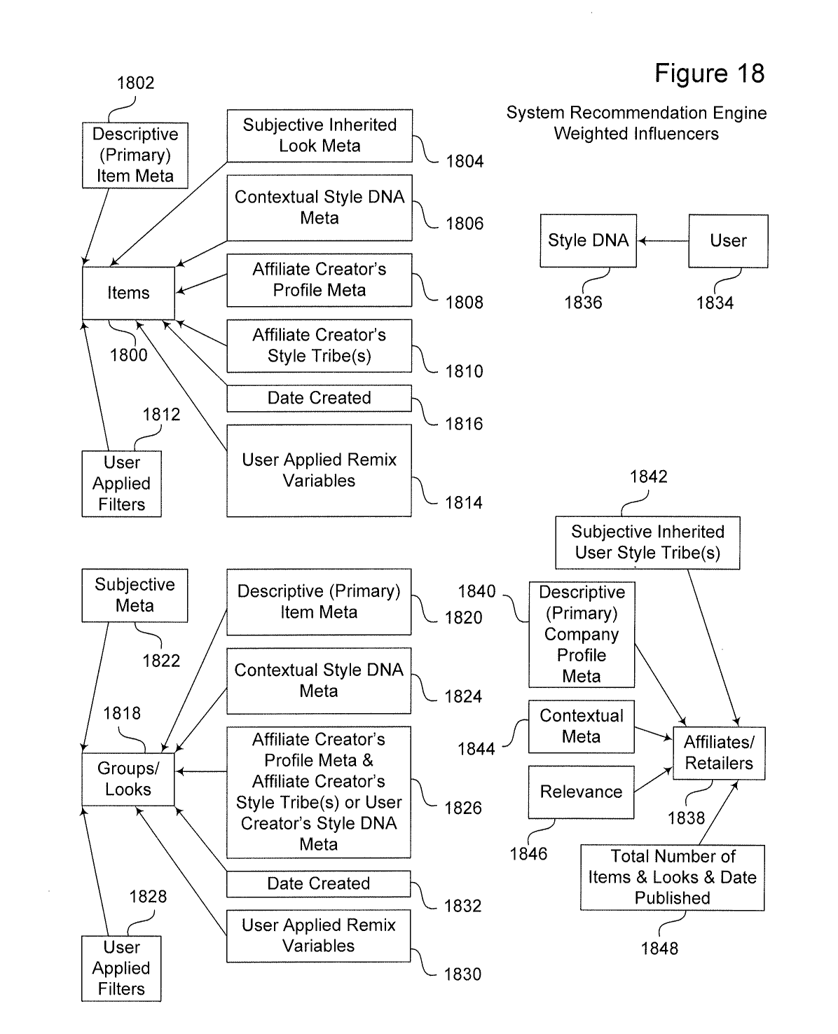

FIG. 18 represents exemplary primary objects contained within the system: Items, Groups/Looks, Users, and Affiliates/Retailers; and the weighted rank influencers that the system uses when processing queries via the targeted recommendation engine. Items 1800 comprises Descriptive (Primary) Item Meta 1802, which represents the meta attributed to an item in the item upload and tagging process, Subjective Inherited Look Meta 1804, which represents tags inherited from the Looks that the item appears in for each system identified Style Tribe, Contextual Style DNA Meta 1806, which represents the Style DNA meta of the user, Affiliate Creator's Profile Meta 1808, Affiliate Creator's Style Tribe(s) 1810, User Applied Filters 1812, which represents filters applied by the user in searching the system, User Applied Remix Variables 1814, and Date Created 1816 to ensure the maximum number of current, active or purchasable items are represented.

Groups/Looks 1818 comprises Descriptive (Primary) Item Meta 1820, which contains meta for the various items in a look, Subjective Meta 1822, which represents meta for the look category tags assigned to the look during look creation by the Affiliate, Contextual Style DNA Meta 1824, which represents Style DNA meta of the user shopping or performing queries, Affiliate Creator's Profile Meta & Affiliate Creator's Style Tribe(s) or User Creator's Style DNA Meta 1826, User Applied Filters 1828, which represents filters applied by the user during searching on the system, User Applied Remix Variables 1830, and Date Created 1832, representing the date the items and looks were created.

The meta of User 1834 comprises the user's Style DNA 1836, described above in relation to FIG. 12.

Affiliates/Retailers 1838 comprises Descriptive (Primary) Company Profile Meta 1840, which is assembled from account setup, items uploaded and looks created, or relevance ranked activity on the system, Subjective Inherited User Style Tribe(s) 1842, representing meta from inherited User Style Tribe(s) assigned by the system based on the tribes that most often match, for example via purchase, saving or sharing, or through items and looks, Contextual Meta 1844, which is assembled from similar companies' profile meta or from Affiliate Tribe(s), Relevance 1846, which is based on the number of items and looks which are purchased, saved, shared and/or remixed by users, and Total Number of Items and Looks and Dates Published, assembled from the items and looks that are current, or recently published, in the system. This mapping of system objects and their influencers represents a system that delivers contextually and subjectively relevant results based on a mapping of system variables. This system delivers results that are relevant for the user displayed within the desired context or group, rather than being based on which user happened to purchase two items simultaneously, for example on sites like Amazon, or based on one item looking like another, for example as on www.like.com. The system displays graphically visual groups of subjectively and contextually related items that are delivered via a relevance ranking recommendation engine mapping to a user profile, and/or Style DNA.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for searching for groups of items, comprising:
receiving a request for a search;
searching for the groups of items representing one or more of (1) products and (2) services, based on the request; and
returning the groups of items based on group tags associated with the groups of items and item tags associated with the items.

2. The method of claim 1, further comprising returning a plurality of groups of items based on group tags associated with the plurality of groups of items.

3. The method of claim 1, further comprising:
selecting the groups of items for purchase; and
purchasing the selected groups of items through an electronic shopping cart.

4. The method of claim 1, further comprising:
selecting an item from the groups of items for purchase; and
purchasing the selected item through an electronic shopping cart.

5. The method of claim 1, wherein the items represent clothes.

6. A method in a data processing system for searching for groups of items, comprising:
receiving a request for a search;
searching for the groups of items representing one or more of (1) products and (2) services, based on the request; and
returning the groups of items based on item tags associated with the items.

7. The method of claim 6, further comprising returning a plurality of groups of items based on group tags associated with the plurality of groups of items.

8. The method of claim 6, further comprising:
selecting the groups of items for purchase; and
purchasing the selected groups of items through an electronic shopping cart.

9. The method of claim 6, further comprising:
selecting an item from the groups of items for purchase; and
purchasing the selected item through an electronic shopping cart.

10. The method of claim 6, wherein the items represent clothes.

11. A method in a data processing system for searching for groups of items, comprising:
receiving a user profile indicating information associated with a user;
searching for the groups of items representing one or more of (1) products and (2) services; and
returning the groups of items based on the user profile.

12. The method of claim 11, further comprising returning a plurality of groups of items based on group tags associated with the plurality of groups of items.

13. The method of claim 11, further comprising:
selecting the groups of items for purchase; and
purchasing the selected groups of items through an electronic shopping cart.

14. The method of claim 11, further comprising:
selecting an item from the groups of items for purchase; and
purchasing the selected item through an electronic shopping cart.

15. The method of claim 11, wherein the items represent clothes.

16. A method in a data processing system for searching for groups of items, comprising:
receiving, from retailers, tags associated with the groups of items representing one or more of (1) products and (2) services, wherein the received tags are included in a single set of tags stored in a data source shared by the retailers;
searching for the groups of items; and
returning the groups of items based on group tags associated with groups of items and item tags associated with the items.

17. The method of claim 16, further comprising returning a plurality of groups of items based on group tags associated with the plurality of groups of items.

18. The method of claim 16, further comprising:
selecting the groups of items for purchase; and
purchasing the selected groups of items through an electronic shopping cart.

19. The method of claim 16, further comprising:
selecting an item from the groups of items for purchase; and
purchasing the selected item through an electronic shopping cart.

20. The method of claim 16, wherein the items represent clothes.

21. A method in a data processing system for searching for groups of items, comprising:
receiving a request for a search;
searching for groups of items representing one or more of (1) products and (2) services;
returning the groups of items based on the request;
receiving a change in search criteria regarding the returned group of items;
changing the returned groups of items based on group tags associated with the groups of items and item tags associated with the items; and
displaying the changed returned groups of items.

22. The method of claim 21, wherein receiving a change in search criteria further comprises:
selecting an item to lock in before changing the returned group of items; and
wherein the changed returned groups of items includes the item selected to be locked in.

23. The method of claim 21, further comprising selecting one of a group tag and an item tag, and wherein the changed returned group of items includes the selected one of the group tag and the item tag.

24. The method of claim 21, further comprising replacing one or more of the groups of items based on the change in selection criteria.

25. The method of claim 21, wherein the items represent clothes.

26. The method of claim 21, further comprising returning a plurality of groups of items based on group tags associated with the plurality of groups of items.

27. The method of claim 21, further comprising:
selecting the groups of items for purchase; and
purchasing the selected groups of items through an electronic shopping cart.

28. The method of claim 21, further comprising:
selecting an item from the groups of items for purchase; and
purchasing the selected item through an electronic shopping cart.

29. A data processing system for searching for groups of items, comprising:
a memory configured to store instructions to cause a processor to:
receive a request for a search;
search for the groups of items representing one or more of (1) products and (2) services, based on the request; and
return the groups of items based on group tags associated with the groups of items and item tags associated with the items; and
the processor configured to execute the stored instructions.

30. The data processing system of claim 29, wherein the stored instructions further comprise:
selecting the groups of items for purchase; and
purchasing the selected groups of items through an electronic shopping cart.

31. The data processing system of claim 29, wherein the stored instructions further comprise:
selecting an item from the groups of items for purchase; and
purchasing the selected item through an electronic shopping cart.

32. The data processing system of claim 29, wherein the items represent clothes.

33. A data processing system for searching for groups of items, comprising:
a memory configured to store instructions to cause a processor to:
receive a request for a search;
search for the groups of items representing one or more of (1) products and (2) services, based on the request; and
return the groups of items based on item tags associated with the items; and
the processor configured to execute the stored instructions.

34. The data processing system of claim 33, wherein the stored instructions further comprise returning a plurality of groups of items based on group tags associated with the plurality of groups of items.

35. The data processing system of claim 33, wherein the stored instructions further comprise:
selecting the groups of items for purchase; and
purchasing the selected groups of items through an electronic shopping cart.

36. The data processing system of claim 33, wherein the stored instructions further comprise:
selecting an item from the groups of items for purchase; and
purchasing the selected item through an electronic shopping cart.

37. The data processing system of claim 33, wherein the items represent clothes.

38. A data processing system for searching for groups of items, comprising:
a memory configured to store instructions to cause a processor to:
receive a user profile indicating information associated with a user;
search for the groups of items representing one or more of (1) products and (2) services; and
return the groups of items based on the user profile; and
the processor configured to execute the stored instructions.

39. The data processing system of claim 38, further comprising returning a plurality of groups of items based on group tags associated with the plurality of groups of items.

40. The data processing system of claim 38, wherein the stored instructions further comprise:
selecting the groups of items for purchase; and
purchasing the selected groups of items through an electronic shopping cart.

41. The data processing system of claim 38, wherein the stored instructions further comprise:
selecting an item from the groups of items for purchase; and
purchasing the selected item through an electronic shopping cart.

42. The data processing system of claim 38, wherein the items represent clothes.

43. A data processing system for searching for groups of items, comprising:
a memory configured to store instructions to cause a processor to:
receive, from retailers, tags associated with the groups of items representing one or more of (1) products and (2) services, wherein the received tags are included in a single set of tags stored in a data source shared by the retailers;
search for the groups of items; and
return the groups of items based on group tags associated with groups of items and item tags associated with the items; and
the processor configured to execute the stored instructions.

44. The data processing system of claim 43, wherein the stored instructions further comprise returning a plurality of groups of items based on group tags associated with the plurality of groups of items.

45. The data processing system of claim 43, wherein the stored instructions further comprise:
selecting the groups of items for purchase; and
purchasing the selected groups of items through an electronic shopping cart.

46. The data processing system of claim 43, wherein the stored instructions further comprise:
selecting an item from the groups of items for purchase; and
purchasing the selected item through an electronic shopping cart.

47. The method of claim 43, wherein the items represent clothes.

48. A data processing system for searching for groups of items, comprising:
a memory configured to store instructions to cause a processor to:
receive a request for a search;
search for groups of items representing one or more of (1) products and (2) services;
return the groups of items based on the request;
receive a change in search criteria regarding the returned group of items; and
change the returned groups of items based on group tags associated with the groups of items and item tags associated with the items; and
display the changed returned groups of items; and
the processor configured to execute the stored instructions.

49. The data processing system of claim 48, wherein receiving a change in search criteria further comprises:
selecting an item to lock in before changing the returned group of items; and
wherein the changed returned groups of items includes the item selected to be locked in.

50. The data processing system of claim 48, wherein the stored instructions further comprise selecting one of a group tag and an item tag, and wherein the changed returned group of items includes the selected one of the group tag and the item tag.

51. The data processing system of claim 48, wherein the stored instructions further comprise replacing one or more of the groups of items based on the change in selection criteria.

52. The data processing system of claim 48, wherein the items represent clothes.

53. The data processing system of claim 48, wherein the stored instructions further comprise returning a plurality of groups of items based on group tags associated with the plurality of groups of items.

54. The data processing system of claim 48, wherein the stored instructions further comprise:
selecting the groups of items for purchase; and
purchasing the selected groups of items through an electronic shopping cart.

55. The data processing system of claim 48, wherein the stored instructions further comprise:
selecting an item from the groups of items for purchase; and
purchasing the selected item through an electronic shopping cart.

56. A method in a data processing system for searching for groups of items based on information related to a user, comprising:
receiving a user profile associated with the user comprising (1) profile information regarding the user, (2) information regarding the user's previous shopping actions, and (3) information regarding one or more other users related to the user;
searching for the groups of items representing one or more of (1) products and (2) services; and
returning the groups of items based on the user profile.

57. The method of claim 56, wherein the previous shopping actions include one or more of (1) viewing an item, (2) saving an item, and (3) purchasing an item.

58. The method of claim 56, wherein returning groups of items based on the user profile further includes:
returning the groups of items based on group tags associated with groups of items and item tags associated with the items.

59. The method of claim 56, further comprising displaying recommended groups of items based on the user profile.

60. The method of claim 56, further including determining other users related to the user based on the user profile.

61. The method of claim 56, wherein the one or more other users related to the user are chosen by the user.

62. A method in a data processing system for creating a user profile of information related to a user for shopping, comprising:
sending questions to a user about the user;
receiving user information from a user in response to questions about the user;
sending questions to the user about the user's preferences;
receiving user preference information from the user in response to the user preference questions;
displaying products to the user and sending questions to the user regarding the displayed products;
receiving responses from the user regarding the displayed products in response to the questions regarding the displayed products;
creating a user profile associated with the user comprising the user information, the user preference information, and the responses regarding the displayed products;
searching for groups of items representing one or more of (1) products and (2) services; and
returning the groups of items based on the user profile.

63. A data processing system for searching for groups of items based on information related to a user, comprising:
a memory configured to store instructions to cause a processor to:
receive a user profile associated with the user comprising (1) profile information regarding the user, (2) information regarding the user's previous shopping actions, and (3) information regarding one or more other users related to the user;
search for the groups of items representing one or more of (1) products and (2) services; and
return the groups of items based on the user profile; and
the processor configured to execute the stored instructions.

64. The data processing of claim 56, wherein the previous shopping actions include one or more of: (1) viewing an item, (2) saving an item, and (3) purchasing an item.

65. The data processing of claim 56, wherein returning groups of items based on the user profile further includes:
returning the groups of items based on group tags associated with groups of items and item tags associated with the items.

66. The data processing of claim 56, wherein the stored instructions further comprise displaying recommended groups of items based on the user profile.

67. The data processing of claim 56, wherein the stored instructions further comprise determining other users related to the user based on the user profile.

68. The data processing of claim 56, wherein the one or more other users related to the user are chosen by the user.

69. A data processing system for searching for groups of items based on information related to a user, comprising:
a memory configured to store instructions to cause a processor to:
send questions to a user about the user;
receive user information from a user in response to questions about the user;
send questions to the user about the user's preferences;
receive user preference information from the user in response to the user preference questions;
display products to the user and sending questions to the user regarding the displayed products;
receive responses from the user regarding the displayed products in response to the questions regarding the displayed products;
create a user profile associated with the user comprising the user information, the user preference information, and the responses regarding the displayed products;
search for groups of items representing one or more of (1) products and (2) services; and
return the groups of items based on the user profile; and
the processor configured to execute the stored instructions.

70. A method in a data processing system for social promotion of products for online shopping, comprising:
receiving indication, from a user, of a group of items representing products, wherein the user is not an owner of the represented products;
displaying the group of items to one or more other users;
receiving actions performed by the one or more other users comprising one or more of: (1) viewing the group of items, (2) buying an item of the group of items, and (3) saving an item of the group of products; and
sending points to the user based on the received actions performed by the one or more other users.

71. The method of claim 70, wherein the group of items are viewable only to the one or more other users.

72. The method of claim 70, wherein the one or more other users are selected by the user.

73. The method of claim 70, wherein the one or more other users are suggested by the data processing system.

74. The method of claim 70, further comprising receiving indication of more than one group of items, and displaying the more than one group of items to one or more other users.

75. A data processing system for social promotion of products for online shopping, comprising:
a memory configured to store instructions to cause a processor to:
receive indication, from a user, of a group of items representing products, wherein the user is not an owner of the represented products;
display the group of items to one or more other users;
receive actions performed by the one or more other users comprising one or more of: (1) viewing the group of items, (2) buying an item of the group of items, and (3) saving an item of the group of products; and
send points to the user based on the received actions performed by the one or more other users; and
the processor configured to execute the stored instructions.

76. The data processing system of claim 75, wherein the group of items are viewable only to the one or more other users.

77. The data processing system of claim 75, wherein the one or more other users are selected by the user.

78. The data processing system of claim 75, wherein the one or more other users are suggested by the data processing system.

79. The data processing system of claim 75, wherein the stored instruction further comprise receiving indication of more than one group of items, and displaying the more than one group of items to one or more other users.

80. A method in a data processing system for tagging groups of items with a standard set of tags, comprising:
receiving, from users, indications of groups of items representing products;
providing, to the users, a single set of tags to be associated with groups of items;
receiving, from the users, indications of tags associated with groups of items, wherein the tags are comprised in the provided single set of tags.

81. The method of claim 80, further comprising providing the single set of tags from a data source shared by the users.

82. The method of claim 80, further comprising receiving indications of items and descriptions regarding the items.

83. The method of claim 80, further comprising uploading the groups of items.

84. The method of claim 80, further comprising searching for the groups of items having the tags from the single set.

85. The method of claim 80, wherein the users are retailers.

86. A data processing system for tagging groups of items with a standard set of tags, comprising:
a memory configured to store instructions to cause a processor to:
receive, from users, indications of groups of items representing products;
provide, to the users, a single set of tags to be associated with groups of items;
receive, from the users, indications of tags associated with groups of items, wherein the tags are comprised in the provided single set of tags; and
a memory configured to store instructions to cause a processor to:

87. The data processing system of claim 86, wherein the stored instructions further comprise providing the single set of tags from a data source shared by the users.

88. The data processing system of claim 86, wherein the stored instructions further comprise receiving indications of items and descriptions regarding the items.

89. The data processing system of claim 86, wherein the stored instructions further comprise uploading the groups of items.

90. The data processing system of claim 86, wherein the stored instructions further comprise searching for the groups of items having the tags from the single set.

91. The data processing system of claim 86, wherein the users are retailers.
